(19) United States
(12) Patent Application Publication
(10) Pub. No.: US 2013/0066677 A1
(43) Pub. Date: Mar. 14, 2013

(54) SYSTEM AND METHOD FOR MEDIA AND COMMERCE MANAGEMENT

(71) Applicant: Scott William Killoh, Pride's Crossing, MA (US)

(72) Inventor: Scott William Killoh, Pride's Crossing, MA (US)

(21) Appl. No.: 13/609,461

(22) Filed: Sep. 11, 2012

Related U.S. Application Data
(60) Provisional application No. 61/533,547, filed on Sep. 12, 2011.

(51) Int. Cl. G06Q 30/02

(52) U.S. Cl. 705/7.29

(57) ABSTRACT

A system and method for media and commerce management is disclosed herein. The system includes a user interface, a customer overview module accessible through the user interface and configured to allow a user to manage customers, a search module accessible through the user interface and configured to allow the user to search for one or more of orders, customers, contacts, activities, leads campaigns, and opportunities, an activities module accessible through the user interface and configured to allow the user to manage tasks, an opportunities module accessible through the user interface and configured to allow the user to track potential opportunities for sales, a campaign module accessible through the user interface and configured to allow the user to create and manage plans to generate sales, and a leads module accessible through the user interface and configured to allow the user to manage potential customers.

### CROSS-REFERENCE TO RELATED APPLICATIONS

This application claims priority to U.S. Provisional Application No. 61/533,547, filed on Sep. 12, 2011, which is incorporated herein by reference in its entirety.

### BACKGROUND

1. Field

The present disclosure relates to advertisement management.

2. Background Information

The expanding online market has made various forms of commerce, content, and media available to users across the world through, for example, Internet websites. This online market can present media and commerce companies with substantial opportunities for dramatic revenue growth. However, it can also present significant challenges that may require media and commerce companies to transform their advertising and other operations in order to capture the full revenue potential.

A challenge facing all companies on the Web is the need to provide an intimate and elegant experience to interact with their customers. This is especially true in the world of advertising. It is difficult for advertisers to find the appropriate mix of advertising with all the choices available to them. For example, in local markets that were once the sole domain of traditional print media, advertisers have found that dealing with Web companies through self-service models is much easier, faster, and far more elegant than dealing with traditional media.

Advertising is evolving from selling passive space in internally-owned media silos to selling relevant, cross-media attention and monitoring feedback from internally and externally owned advertising properties. Traditional media and commerce companies have faced serious challenges in the past several years with changes in advertising spending and new alternative media channels such as “apps,” online, mobile phones, and tablets. The challenges of providing media and commerce products have grown vastly with the number of mobile, web, and traditional outputs. For example, since the Apple® iPad® release, growth in mobile phones and tablet devices is increasing at a seemingly non-stop pace.

As the online market expands, it is fragmenting into an increasingly diverse array of digital categories, including for example mobile, display, video, social media, search, and more. Typically, each category features its own unique requirements for advertising formats, management, and delivery. This proliferation can make it difficult for advertisers to plan and coordinate campaigns across the full spectrum of online opportunities because there are simply too many advertising channels, contacts, and interfaces in too many different places.

Media and commerce companies have attempted to address the proliferation of advertising categories with separate operational divisions, including for example print, digital, mobile, and more. This can create significant inefficiencies for both advertisers and publishers as each division may include different contacts, logistics, invoices, and more.

Most companies and/or publishers have responded to the fragmented advertising market with separate divisions. Typically, print, web, and mobile advertising are split into separate, largely isolated, silos. As a result, the advertiser may be approached by different people selling different things, for example, “availability” in terms of print “space” or a volume of web “avails,” etc. To further complicate things, Sales is often split from Operations which is often split from Billing. These divisions can create inefficiencies for both the advertiser and the publisher, and present obstacles for advertising revenue growth.

As publishers look to improve advertising revenue, they often focus on optimizing these organizational silos by stringing together point solutions rather than approaching the challenge on an enterprise level. For example, publishers may deploy sales force automation tools to improve print sales; publishers may sell remnant inventory to advertising networks and improve tagging in an attempt to grow digital advertising revenue (usually banner ads and other display advertising); and publishers may create new sub-departments to handle new formats and platforms like video, mobile, and tablet advertising.

As a result, advertisers have to interact with separate divisions to reach audiences across different media. Consumers are presented with advertising messages fragmented by media type; a problem that may be compounded by mixed advertising messages across different channels. Further, the number of new devices and advertising types is growing rapidly, complicating the situation. While improving operational efficiencies in each division may realize a small amount of new growth it may not capture the full potential of the online market. For traditional companies it is critical to transform their operations to stay competitive, but most continue to operate with legacy systems that are expensive and cannot adapt to the new media channels and advertising models. Selling a range of advertising types should include coordination across multiple platforms, internal divisions, and third-party platforms.

### BRIEF SUMMARY OF THE DISCLOSURE

Generally, the systems, methods, and apparatuses disclosed herein include and may be implemented within a computer, computer system, and/or network of computer systems having one or more databases and other storage apparatuses, servers, and additional components, such as processors or microprocessors, modems, terminals and displays, non-transitory computer-readable media, algorithms, software, modules, platforms, and other computer-related components. The computer systems are especially configured and adapted to perform the functions and processes of the systems, methods, and apparatuses as disclosed herein. The functions and processes of the systems, methods, and apparatuses as disclosed herein may be embodied in a stand-alone platform or application, a web-based application or platform such as a Software-as-a-Service (SaaS) (http://searchcloudcomputing.techtarget.com/definition/Software-as-a-Service), or other type of application or platform, and may include one or more graphical user interfaces (GUIs) that can be accessed over a network such as the World Wide Web (W3) and/or the Internet and other types of networks including communications networks, Local area networks (LANs), Metropolitan area networks (MANs), Campus area networks (CANs), Wide area networks (WANs), wireless networks, and other networks of the type.

Communications between various components in the systems, methods, and apparatuses disclosed herein may be bidirectional electronic communication through a wired or wireless network. For example, one component may be networked directly, indirectly, through a third party intermediary, wirelessly, or otherwise with other components to enable communication between the components.

In an illustrative embodiment, the systems and methods disclosed herein provide an Enterprise Resource Planning (ERP) platform for commerce and media. The platform provides web services combined with an advanced data model. The platform may run in a fully mission-critical cloud, resulting in an automated media and commerce platform. Just as ERP systems eliminated hundreds of unrelated functions in the world of finance 30 years ago, the platform disclosed herein does the same for automating media and commerce in the mobile age. However, the platform disclosed herein allows startups and traditional companies alike to immediately turn on a fully-automated commerce and media factory without the associated time and expense.

In an illustrative embodiment, the platform includes advertising technologies that allow mobile and multi-channel media properties to sell, produce, distribute, and track “next-generation” advertising packages seamlessly. Furthermore, the substantial cost of installed technologies may be virtually eliminated through the implementation of these technologies within a Cloud Computing Platform. The platform may be composed of Oracle® Java Web-services running in a cloud. Thus, the Cloud Computing Platform is a mission-critical cloud computing platform and development/middle-ware environment. It covers the entire lifecycle from product inception through detailed customer targeting via rules-based analytics.

The platform covers all commerce and media functions for all media channels, replacing a plethora of point solution applications such as, but not limited to:
1. web, mobile, and print information management;
2. output of published material to mobile devices and apps, websites and print products of all types;
3. advertisement (ad) sales for web, mobile, and print products of all types;
4. real time inventory management;
5. rules and contract management;
6. reporting and analytics;
7. integrated customer relationship management and outbound marketing;
8. ad creation for digital, print, and mobile ads;
9. ad trafficking and management of workflows for digital, print, and mobile ads
10. archiving and search of information;
11. extensive system management and branding tools; and,
12. as well as many customer-facing applications such as self-service advertising portals, listing sites, custom advertising solutions, and more.
   The solution level may be a user experience layer only. This methodology eliminates the costly integration inefficiencies between functions, while also enabling significant revenue generation from new opportunities.

In an illustrative embodiment, the platform is a single code base, for example built on Java, across all customers globally and is exposed as a fully functional development and middleware platform for its ecosystem partners. Given the breadth, scalability, and extensibility of the platform, the platform is a technology that may be used by publishers, website operators, advertising agencies, ad networks, corporate marketing departments, and any other entity involved in the production and/or sale of ads and/or information through the multiple media channels.

The platform can provide major strategic advantages to companies, such as but not limited to:
1. Online and directory publishers who want to take advantage of the new mobile devices, and/or provide for more effective and efficient advertising, content management, and publishing capabilities;
2. Advertising agencies and any other entities involved in the sale and/or production of ads;
3. Ad networks who can leverage many aspects of the platform, such as ad production and/or ad sales, available to all of its customers and potential customers to encourage use of its ad network; and
4. Startups who can skip the step of building a company from scratch and just turn on the platform within weeks or simply overnight.

In an illustrative embodiment, the platform may be available as a multi-tenant Software-as-a-Service (SaaS) offering, or the user may elect to host the platform itself as an internal enterprise cloud. As a cloud-based solution, major roll-outs can be accomplished in weeks and months, as compared to years with client-server competitors.

The platform can consist of 100% web-based services allowing all functionality to be available via a browser to anyone, anywhere, and at any time. This enables effective transparency of activities across the enterprise, and as applicable with customers and partners.

In an illustrative embodiment, the platform has a highly configurable applications layer that provides both its own applications, while allowing as well for an unlimited number of third party applications and dashboards (Graphical User Interfaces). This supports a wide range of flexibility to meet a customer's particular needs and internal processes.

Because the platform is web services based and has a robust and fully integrated data model already exposed, the platform applications can be easily extended by customers or their partners. The comprehensive media data model that accompanies the web services is an advanced, comprehensive, and fully tested media data model.

In an illustrative embodiment, a media bridge layer acts as the central service bus and data normalization layer allowing for easy integration to a variety of third party applications and systems. For example, the platform can easily integrate with, and pass information to, any third-party financial system, for example Oracle®-brand Financials.

### BRIEF DESCRIPTION OF THE DRAWINGS

For the purpose of facilitating an understanding of the invention, there is illustrated in the accompanying drawings a preferred embodiment and alternative embodiments thereof, from an inspection of which, when considered in connection with the following description, the invention, its construction and operation, and many of its advantages, should be readily understood and appreciated.

FIG. 1 is an illustrative embodiment of a platform that uses Web-services to manage advertising, content, and publishing;

FIG. 2 and FIG. 3 are illustrative embodiments of a suite of applications of the Web-services shown in FIG. 1;

FIG. 4 is an illustrative embodiment of a Media Service Bus layer that provides full Web-services level integration to extend the platform;

FIG. 5 is an illustrative embodiment of components of the platform;

FIG. 6 through FIG. 15 are illustrative embodiments of the exemplary Mediaspectrum®-brand AdWatch™ content management system, components, solutions, options, templates, applications, and user interfaces for multichannel advertising;

FIG. 16 is a block workflow diagram of the exemplary Mediaspectrum®-brand Sales component (MS Sales) and its various modules;

FIG. 17 through FIG. 26 are illustrative embodiments of various options of the exemplary MS Sales component;

FIG. 27 through FIG. 33 are illustrative embodiments of the Drools Workflow for a Drolls interface application of the exemplary MS Sales component;

FIG. 34 through FIG. 39 are illustrative workflow diagrams of database structure and logical schemes of the components of the exemplary platform;

FIG. 40 through FIG. 41 are illustrative mockups of views of multiple approvals of the exemplary MS Sales component;

FIG. 42 through FIG. 48 are illustrative embodiments of various options of the exemplary platform;

FIG. 49 is illustrative of the business structure of components of the exemplary platform; and

FIG. 50 through FIG. 105 are illustrative embodiments of various options of the exemplary platform.

### DETAILED DESCRIPTION

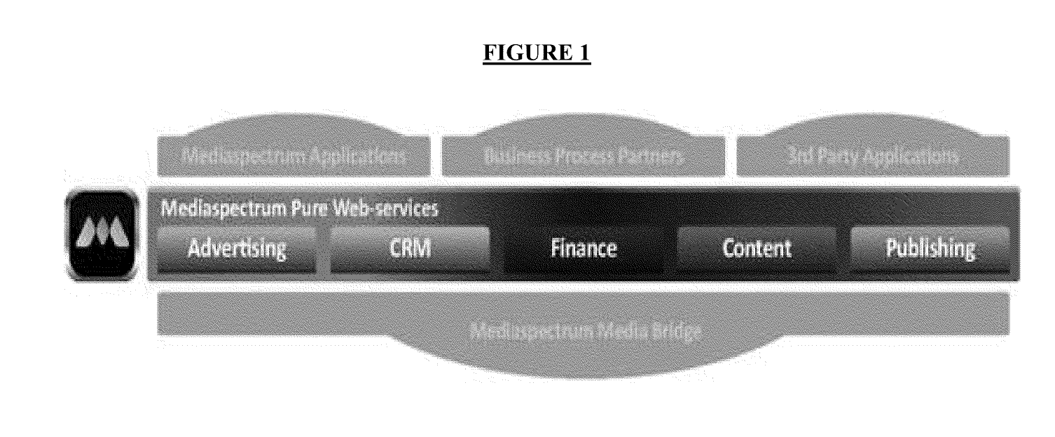

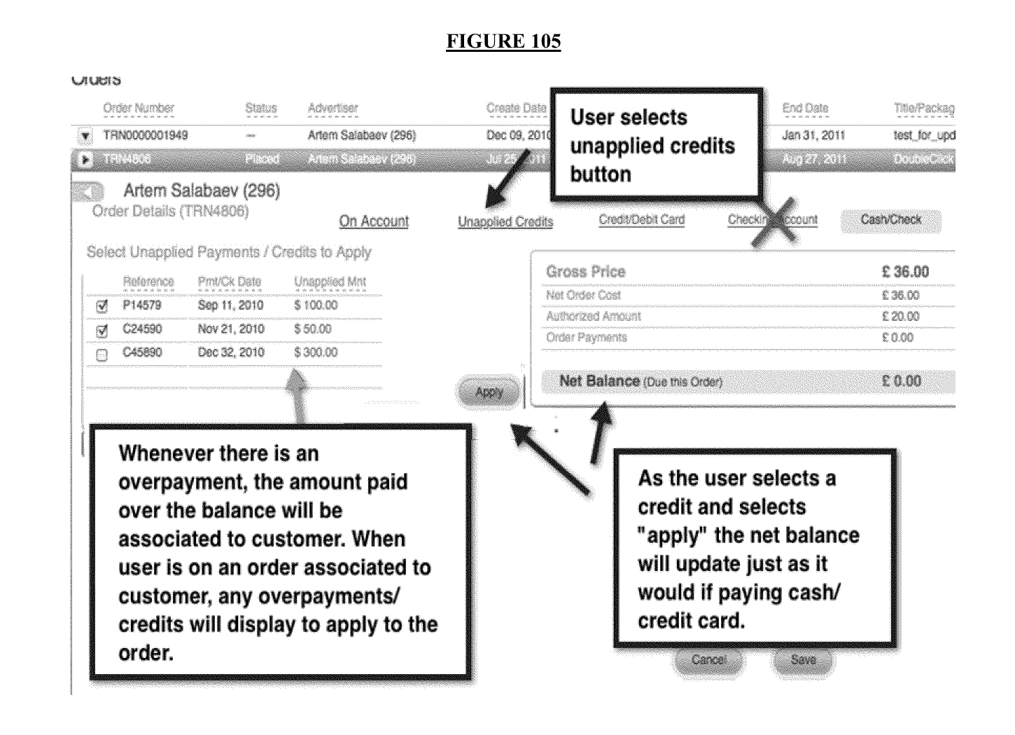

Detailed embodiments of systems, methods, and apparatuses are disclosed and illustrated herein in FIGS. 1 through 105, however, it is to be understood that those embodiments are merely exemplary of the systems, methods, and apparatuses which may be embodied in various forms. Therefore, specific functional details disclosed and illustrated herein are not to be interpreted as limiting, but merely as a basis for the claims and as a representative basis for teaching one skilled in the art to employ various versions, implementations, and/or applications of the disclosed systems, methods, and apparatuses.

Mobile and multi-channel media, especially advertising, have unique complexities as combined with the integrated processing of advertising orders/campaigns, ad content flows, money flows, and event processing, information and analytic flows against a backdrop of evolving media channels and ad types.

In an illustrative embodiment shown in FIG. 1, the platform uses 100% PURE Web-services and makes it easy to manage advertising, content, and publishing anywhere to anything. To take advantage of opportunities in the mobile space, publishers must have a platform that handles all functionality seamlessly. The mobile and multi-channel platform of pure Web-services technology and award-winning applications are the core of the world's most powerful mobile ecosystem. The platform shown in FIG. 1 ties together all participants in the mobile and multi-channel economy, including advertising specialists such as ad sales and production personnel, content creation and production personnel, customer relationship managers, financial specialists, and product creators for such devices as the iPad®, iPhone®, Web sites, and even print products.

The platform leverages existing workflows and knowledge workers into the new mobile medium. It also makes it easy to bring together enterprise class solutions, partners, and components to rapidly expand and scale its already world-leading breadth of functionality.

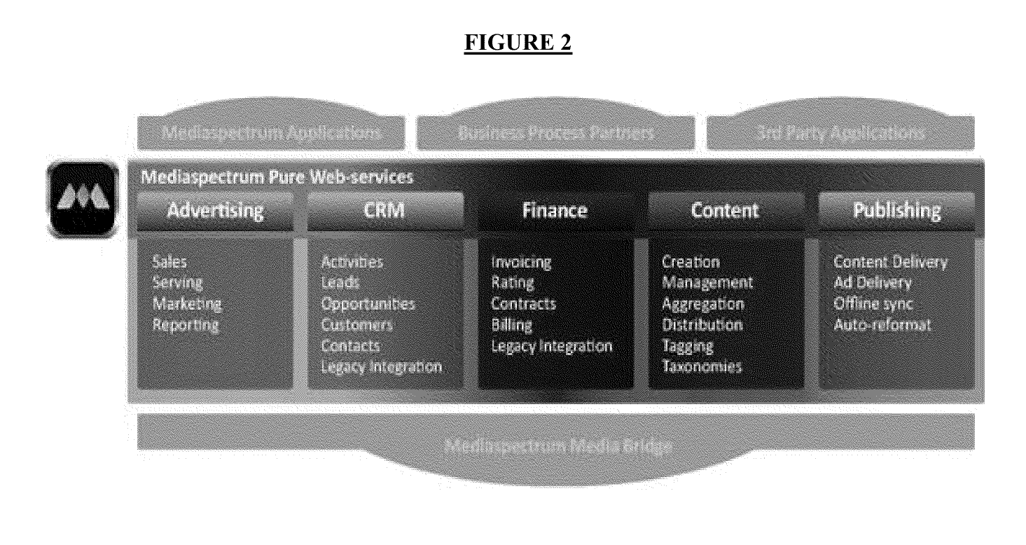

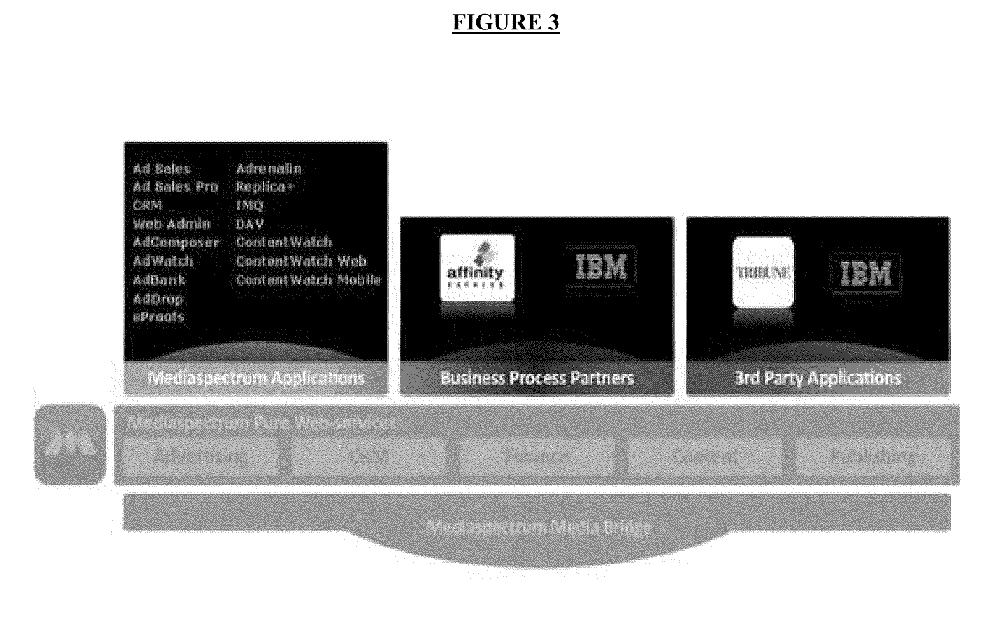

The heart of the platform of FIG. 1 is a pure Web-services layer of specific functions for the rich media needs of mobile and multichannel publishers. On top of the Web-services, a suite of applications shown in FIG. 2 can support all the participants in the mobile and multichannel ecosystem. These applications can cover advertising, content management, CRM, billing, and publishing for mobile and other media formats. Beyond that, third parties can create applications of their own utilizing the platform as shown in FIG. 3.

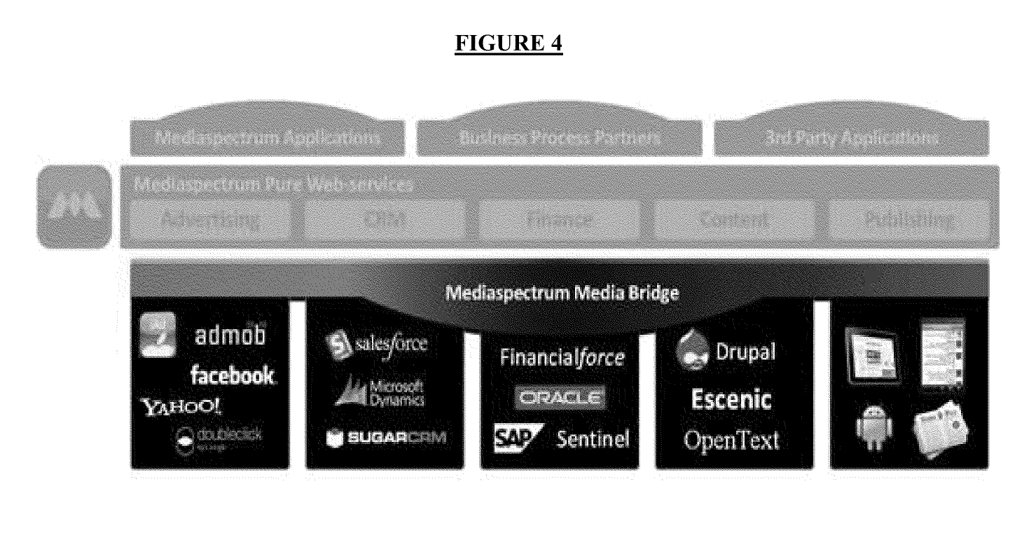

The Media Service Bus (MSB) layer provides full Web-services level integration to a plethora of existing partners and technology components that can also be used by business process partners and third party applications to infinitely extend the platform, as shown in FIG. 4.

The platform can run anywhere. Unlike proprietary environments, the entire cloud infrastructure can use world-class standards-based infrastructure components like Oracle®-brand databases and Websphere®-brand Portals. The options for running the platform are always up to the customer, meaning that whether one chooses the cloud environment of the invention or prefers to host it locally, the platform enables true business transformation.

In today's media landscape, all media companies and particularly publishers of multi-channel products need to drastically streamline their businesses while at the same time increasing sales. However, legacy technology vendors offer little in the way of cutting complexity out of the IT of the media companies. In fact, the vendors do the opposite. They still require huge server rooms, and endless office space jam-packed with servers that have expensive cooling and power needs. The media companies need to manage bandwidth, networks, storage, and a barrage of software stacks that include operating systems, databases, application servers, and portal servers. Worst of all, they typically consist of legacy applications that run on desktops with layers of proprietary “web” technology hard-coded to them. Then there is the people, endless people, often with out-of-date skills and completely de-centralized, requiring a team of experts to install, configure, and keep these systems running across multiple environments—the development environment leads to testing to staging to production to fail-over. All of this to just support a single business application, running a true multi-channel media organizations requires many more.

The invention provides a better way to run a business. The Cloud enables publishers to consolidate a myriad of legacy solutions into a single Web-based platform that facilitates significant new advertising and commerce opportunities. The platform seamlessly integrates both advertising and editorial content management, so media companies can literally ‘plug-into’ business transforming technology—immediately, with zero upfront IT and software expense. Thus, there are no servers, no storage, and no technical teams to keep it all running 100% of the platform functionality is available through a simple web browser. No legacy technology and massive, complicated Citrix®-brand farms. Users and advertisers can just open a web browser, log in from anywhere, and the system is immediately available.

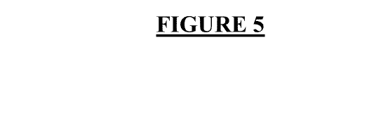

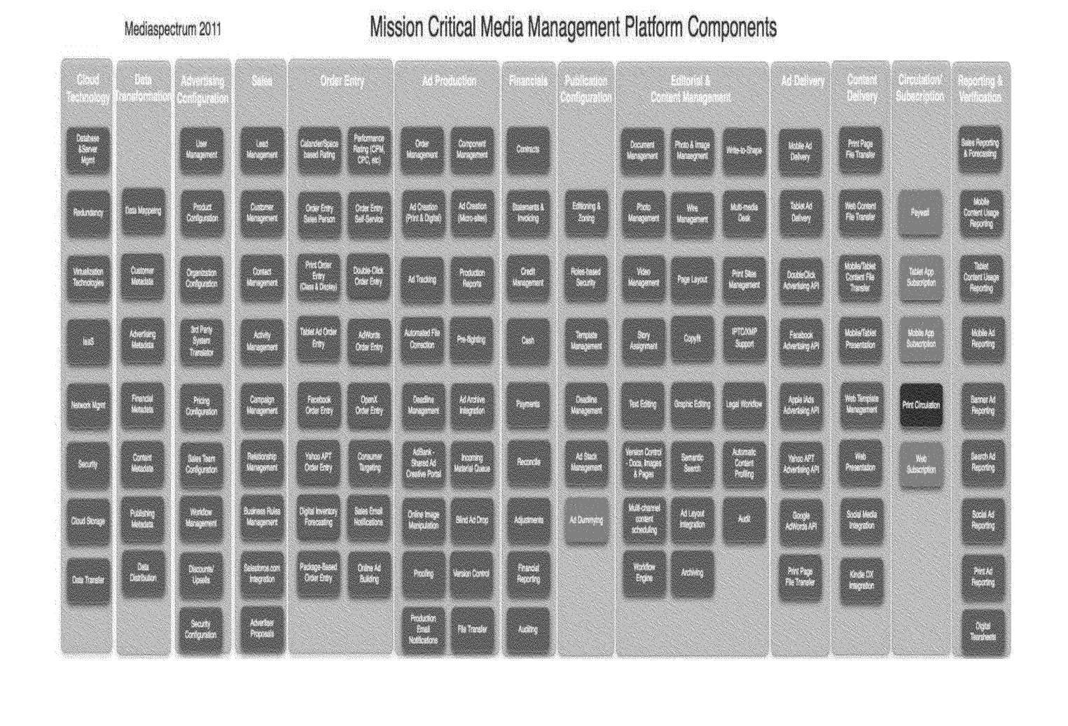

As illustrated in the FIG. 5, the platform may include one or more platform components, such as but not limited to:

1. a cloud technology component;

2. a data transformation component;

3. an advertising configuration component;

4. an advertisement (ad) sales component or sales component;

5. an order entry component;

6. an ad production component;

7. a financials component;

8. a publication configuration component;

9. an editorial and content management component;

10. an ad delivery component;

11. a content delivery component;

12. a circulation/subscription component; and

13. a reporting and verification component.

The cloud technology component may provide or include one or more functions or tools, including but not limited to database and server management, redundancy, virtualization technologies, Infrastructure-as-a-Service (IaaS), network management, security, cloud storage, and data transfer. The data transformation component may provide or include one or more functions or tools, including but not limited to data mapping, customer metadata, advertising metadata, financial metadata, content metadata, publishing metadata, and data distribution. The advertising configuration component may provide or include one or more functions or tools, including but not limited to user management, product configuration, organization configuration, third party system translator, pricing configuration, sales team configuration, workflow management, discounts/upsells, and security configuration.

The sales component may provide or include one or more functions or tools, including but not limited to lead management, customer management, contact management, activity management, campaign management, relationship management, business rules management, salesforce management, and advertiser proposals. The order entry component may provide or include one or more functions or tools, including but not limited to calendar/space based rating, performance rating (for example CPM, CPC, etc.), order entry sales person, order entry self-service, print order entry (class and display), double-click order entry, tablet ad order entry, AdWords® order entry, Facebook® order entry, OpenX® order entry, Yahoo®-brand APT™ order entry, consumer targeting, digital inventory forecasting, sales email notifications, package-based order entry, and online ad building.

The ad production component may provide or include one or more functions or tools, including but not limited to order management, component management, ad creation (print and digital), ad creation (micro-sites), ad tracking, production reports, automated file correction, pre-flighting, deadline management, ad archive integration, Mediaspectrum®-brand AdBank®-shared as creative portal, incoming material queue, online image manipulation, blind ad drop, proofing, version control, production email notification, and file transfer.

The financials component may provide or include one or more functions or tools, including but not limited to contracts, statements and invoicing, credit management, cash, payments, reconcile, adjustments, financial reporting, and auditing. The publication configuration component may provide or include one or more functions or tools, including but not limited to editing and zoning, roles-based security, template management, deadline management, ad stack management, and ad dummying. The editorial and content management component may provide or include one or more functions or tools, including but not limited to document management, photo and image management, write-to shape, photo management, wire management, multi-media desk, video management, page layout, print sales management, story assignment, copyfit, IPTC/XMP embedded metadata support, text editing, graphic editing, legal workflow, version control (documents, images, and pages), semantic search, automatic content profiling, multi-channel content scheduling, ad layout integration, audit, workflow engine, and archiving.

The ad delivery component may provide or include one or more functions or tools, including but not limited to mobile ad delivery, tablet ad delivery, double-click advertising application program interface (API), Facebook®-brand API, Apple®-brand iAds® Advertising API, Yahoo®-brand APT™ Advertising API, Google®-brand AdWords® API, and print page file transfer. The content delivery component may provide or include one or more functions or tools, including but not limited to print page file transfer, web content file transfer, mobile/tablet content file transfer, mobile/tablet presentation, web template management, web presentation, social media integration, and Kindle™-brand DX™ integration. The circulation/subscription component may provide or include one or more functions or tools, including but not limited to paywall, tablet ad subscription, mobile ad subscription, print circulation, and web subscription. The reporting and verification component may provide or include one or more functions or tools, including but not limited to sales reporting and forecasting, mobile content usage reporting, tablet content usage reporting, mobile ad reporting, banner ad reporting, search ad reporting, social ad reporting, print ad reporting, and digital tearsheets.

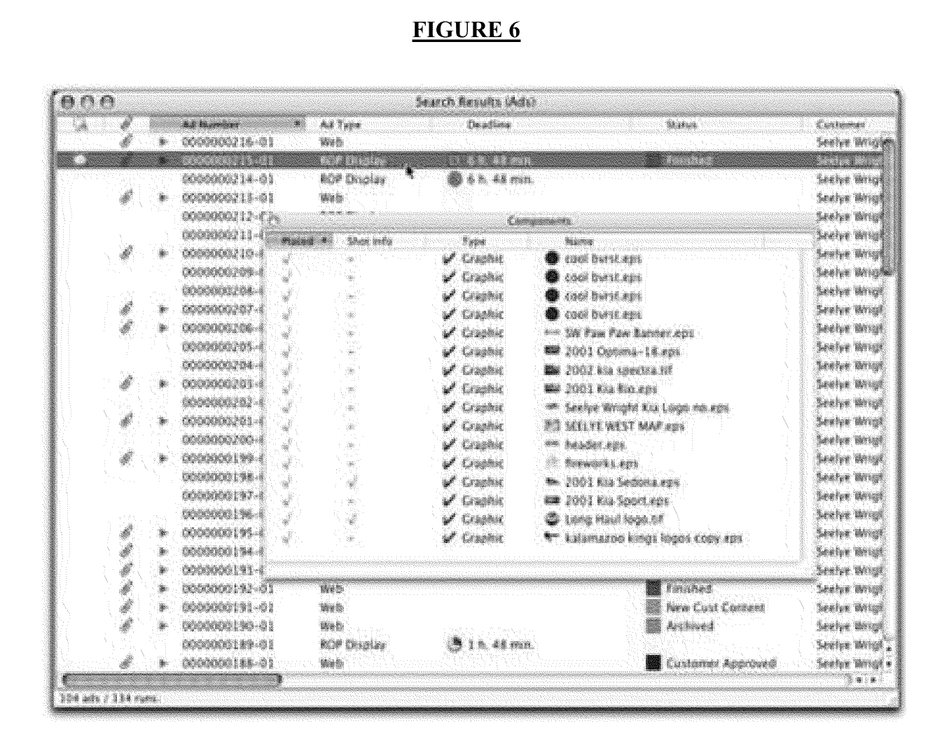

In an illustrative embodiment in FIG. 6, the ad production component can include a Web-based system such as Mediaspectrum®-brand AdWatch™ (http://www.mediaspectrum.net/index.php?page=adwatch). AdWatch is a complete content management solution for advertising and is believed the only system on the market that is truly Web-based. With the ability to track virtually any type of ad element, including text, photos, graphics, and .pdf files, AdWatch gives production and creation personnel the ability to create, find, and edit ads and their components. By offering the ability to access and work on ads at the component level, production departments can quickly and effectively implement digital workflows, and reduce the time, cost, and complexity associated with the ad production process. AdWatch gives users the ability to search for ads and ad components, make ad assignments, preview ads, and monitor the production process. AdWatch integrates with leading ad creation tools like QuarkXPress™, Adobe® InDesign®, MultiAd Creator™, Adobe® Illustrator®, and others so creative personnel can manage ads and content without leaving the application, as shown in part in FIG. 6. AdWatch Component Management searching, tagging, and tracking functions are one of the most powerful benefits of the AdWatch system.

All the solutions disclosed herein are available as thin-client solutions accessible via Web browser. For example, Mediaspectrum®-brand AdWatch™EX™, an ad tracking and content management solution, is a browser-based version of the popular desktop client and is a feature-for-feature match. For e-proofing and electronic ad upload, Mediaspectrum®-brand AdWatch™eProofs™ leverages a browser for all functions—from searching for proofs and content to uploading files, making comments, and adding sticky notes to e-proofs.

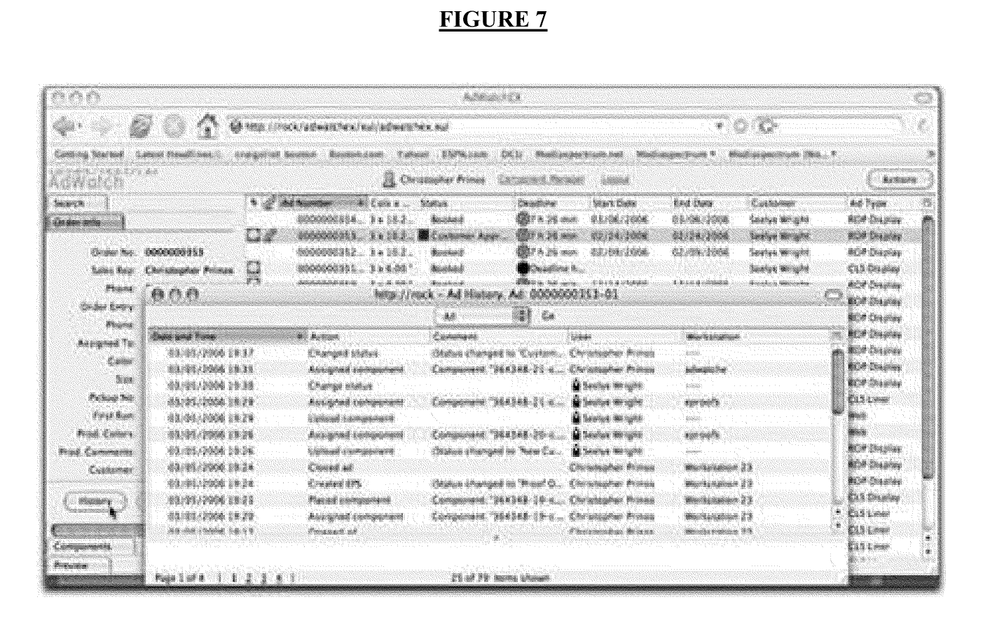

In an illustrative embodiment disclosed herein, the exemplary Mediaspectrum®-brand AdWatch™ system is integrated with one of the world's leading preflight solution OneVision® Asura® of OneVision Software AG (http://onevision.com/). The integration can be configured to auto preflight in a hot folder push-pull environment (casual integration) or at the XML level (industrial strength preflight automation), giving the ability to trigger Asura-brand functions on the fly. In the illustrative embodiment disclosed herein in FIG. 7, the exemplary Mediaspectrum®-brand AdWatch™ system is a true content management system for multichannel advertising that has no limits to the type of content that can be stored and tracked in the system. AdWatch allows users to track Banner and skyscraper advertising and even track audio clips such as MP3, WAV, VBR, 64 Kbps M3U, AIFF's or other. Digital video file formats could include MPEG, AVI, WMV, SWF, FLA, QT, MOV, M4V, M4E, and DIR.

The exemplary Mediaspectrum®-brand AdWatch™ system tracks all ads at the component-level. AdWatch links all ad elements (art, photos, text) with individual ad orders. AdWatch components' pane is available in the ad creation application (for example QuarkXPress™, Adobe®-brand InDesign®, and MultiAd Creator™) as well as from AdWatch's Search Results pane. AdWatch Component Management searching, tagging, and tracking functions are one of the most powerful benefits of the system. With the exemplary Mediaspectrum®-brand AdWatch™ system, ads that are approved by advertisers or pass preflight (i.e., have no issues or problems) can be automatically advanced in the workflow as actions are performed (preflight, file upload, etc.). In short, pristine camera-ready files never have to be touched by anyone in ad operations.

AdWatch™ integrates tightly with many popular ad delivery services including AP®-brand AdSend™, AP®-brand AdTransit™, DGFastChannel™, and more. AdWatch takes integration to these services to the next level with the ability to parse the log files that travel along with ads sent via these services. With the ability to parse the log file AdWatch automates the association of files to ad records and can also take log information and append it as part of each ad's history within AdWatch. AdWatch™ has one of the most accurate time-tracking methodology on the market. AdWatch tracks the amount of time spent in the ad layout application (i.e., QuarkXPress™, Adobe®-brand InDesign®). AdWatch integration with Adobe®-brands Photoshop® and Illustrator® take it one step further with the ability to track the amount of time spent on art and component creation as well. Tracking the amount of time it takes to build and assemble not only the ad but the components as well means a user has one of the most accurate time calculations possible.

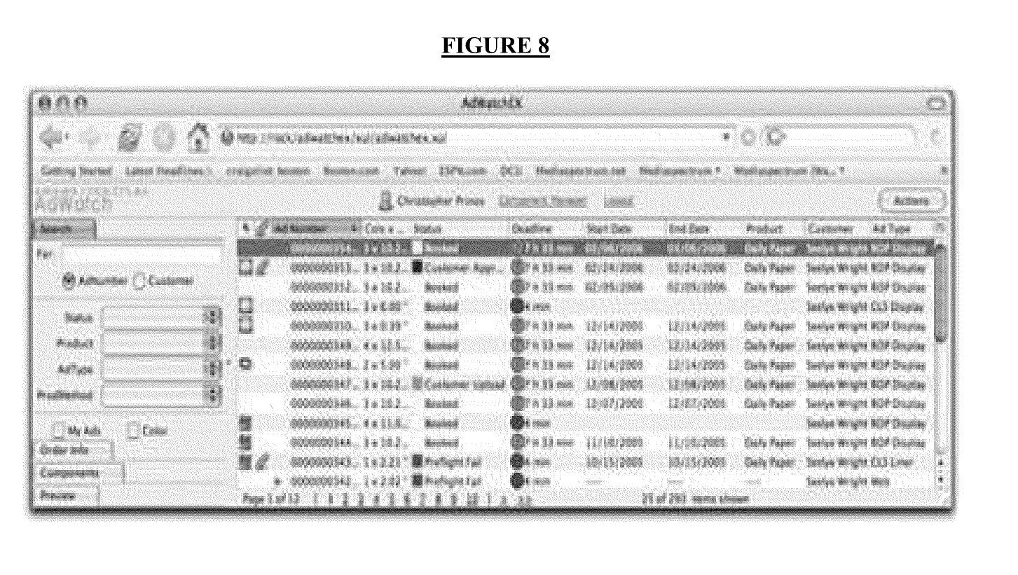

AdWatch™ supports a number of report options within its search interface and gives a user the ability to output and/or save these reports in file formats (i.e. CSV, HTML, etc.). For more advanced reports, AdWatch works with SAP®-brand Crystal Reports™ and has a number of sample reports that come packaged with AdWatch. AdWatch™ has a number of tables defined for tracking deadlines that include deadlines for “booking” (defined by the order entry system), “production” (defined by production; algorithm defined by the user), and “proofing” (also defined by production; algorithm defined by the user). These deadlines are readily tracked and displayed in AdWatch so one always knows where one is on deadline, such as illustrated in FIG. 8.

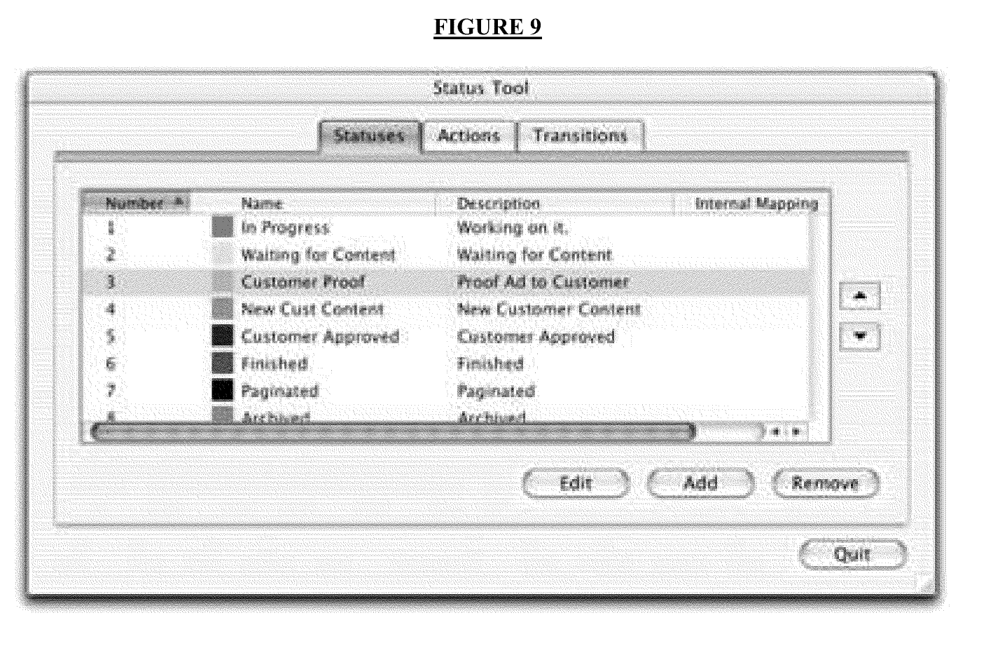

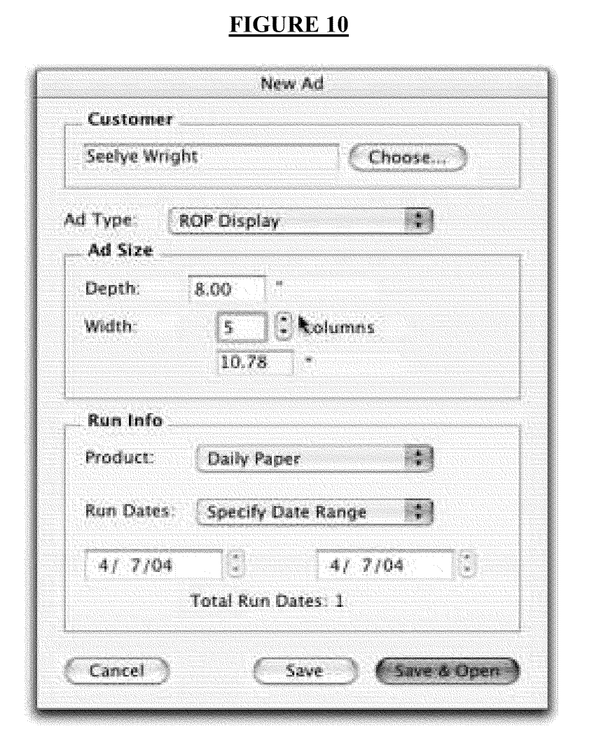

AdWatch's “statuses” are completely customizable and defined by the user with the “Ad Status” tool. The statuses are used as triggers and can invoke certain actions or workflows as needed. One can set up as many production statuses as one likes and even map statuses to actions to automate manual tasks, such as “Create PDF” or “Send proof” for example, as shown in FIG. 9. AdWatch is so powerful that it even gives the ability to book an ad right from the production interface. The “new ad order” option lets users select a customer, enter ad geometry, and other relevant information. From here, information can be relayed to the front-end booking system and an order generated in the background so nothing falls through the cracks, as illustrated in FIG. 10. Ads that have been archived are still shown in the system and can be retrieved at any time. AdWatch can integrate with the drivers for popular storage devices to track ads that have been moved to near line storage. With this integration restoring content or bringing content back in to the system is as simple as double clicking on the ad itself and selecting the “store” option.

Mediaspectrum®-brand eProofs™ is a Web-based electronic proofing solution that helps media companies, ad agencies, and Web engines dramatically reduce the time, cost, and manual processes associated with the ad approval process. With eProofs, print, mail, and courier expenses are a thing of the past. Both advertisers and publishers benefit from a real-time connection that improves communication and dramatically reduces the amount of time spent on the review process. eProofs streamlines the proofing process and keeps sales, production, and the customer on the same page. Tight integration with EngineBridge™ Ad Production Services means eProofs can offer proofing at the component level. With eProofs, advertisers can view, edit, upload, and approve not only the ad itself but the files that make up the ad as well. All changes and actions are tracked and recorded making it easy to generate productivity reports and identify the most profitable advertising jobs. In addition, customer actions can trigger specific production events, for example, an online approval can change the ad status to “finished” and automatically create an .eps file that's ready for print.

Support for multiple ad types makes it possible to sell ad packages for all mediums. Traditionally a limitation of disparate systems, Media 2.0 Ad Commerce and Production Services working together make it easy to offer potential advertisers packages that include a mix of print and Web advertising. Without a way to sell, produce, and approve print and Web ads with a single system packaged ad sales, and the incremental revenue that follows, is simply impossible. AdWatch is a true content management system for multichannel advertising. There are no limits to the type of content that can be stored and tracked in the system. Customers tracking Banner and skyscraper advertising with AdWatch and the system can even track audio clips as MP3, WAV, VBR, 64 Kbps M3U, AIFF's or other. Digital video file formats could include MPEG, AVI, WMV, SWF, FLA, QT, MOV, M4V, M4E, and DIR.

Built entirely as Java-based Web-services, eProofs can be configured in a variety of ways to solve the unique requirements of each customer. In addition, the services-based architecture means new features can be added as they become available with little to no administration overhead. Part of Mediaspectrum®-brand AdCenter, AdDrop makes offers a one-click answer to uploading finished “digital ready” ads and material with a portal that is easy to use and automation that is effective. More specifically, Mediaspectrum developed an ultimate customer service portal for advertisers. Dubbed “AdCenter,” the solution was made up of three Mediaspectrum products—AdDrop, AdBank, and AdComposer. With AdCenter, newspapers are able to offer an ad and content upload portal across the organization so all customers can submit materials with “AdDrop,” a branded Web portal that is easy to use and can be hosted in single data center. In addition to AdDrop, AdCenter offers an online ad sharing portal called “AdBank,” along with editing and formatting tools provided by Mediaspectrum AdComposer. The end result is a three-part solution that improves customer service, streamlines the production process, and enhances revenue opportunities.

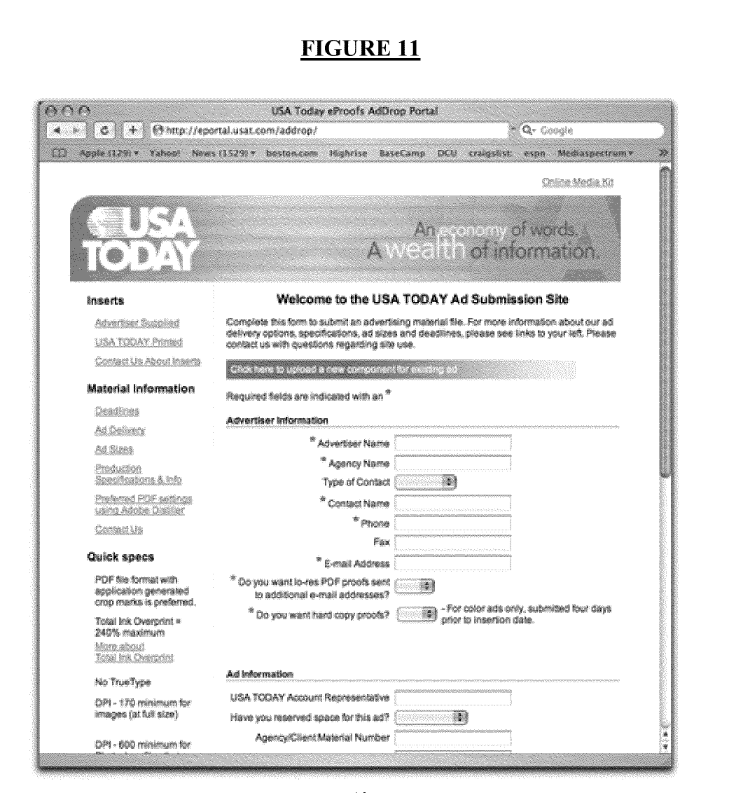

Proof-of-concept for AdCenter led to AdDrop 2.5, an online portal where customers can go to upload ads, photos, and related content, and information about the material being “dropped” off. The solution is a tool for customers to leverage automation at every turn. AdDrop saves newspaper properties time, cost, and headaches associated with traditional manual ad submission processes. A snapshot of the features and benefits of the AdDrop 2.5 solution is shown in FIG. 11. With this AdDrop 2.5 solution, ads coming from major ad delivery services (AdSend, Ad Transit, FastChannel, WAMNet, etc.) are all funneled to a single location. AdDrop organizes the files, makes matches to records when possible, and tracks a complete history of when content was received and how it arrived. AdDrop gives a single view into all files coming from the major delivery channels like AdSend, Ad Transit and FastChannel. In the event a link to a record cannot be made, AdDrop stores files in a “park” queue where content can be linked up at a later time. If an automated match cannot be made AdDrop offers an easy to use a screen to quickly make matches of “orphan” material.

A preflight workflow was built around AdDrop so files are checked for quality as soon as they are sent. AdDrop performs simple diagnostic tests against files and the information provided by the customer (or booking feed) and will pass or fail content based on defined rules. If a file fails, AdDrop sends the customer an email immediately to tell the problem and ask for another file. Production managers can get alerts as well and, of course, files that pass never need to be touched and move right into the tracking environment. With files submitted, preflighted, and ready to go, AdDrop moves ads to the ad tracking system where they are automatically linked with records and placed in the associated file system. History is passed along with the files, along with build material (if submitted), and log files from the delivery services. With AdDrop, all ads flow into the target ad tracking system eliminating a myriad of manual processes, mistakes, and quality control issues.

Mediaspectrum® AdBank® is the ultimate online ad sharing portal. AdBank makes it easy for distributed media groups to share creatively within the organization over the Web. Users can easily find what they are looking for, upload and download files, and quickly generate new ads from material that already exists in the organization. AdBank dramatically reduces the time it takes to build spec ads and supports new ad sales with the ability to run alongside Mediaspectrum AdComposer. With AdBank and AdComposer working together newspapers can combine content with campaigns to deliver branded creative to targeted customers. Once the attention of customers is obtained, one can build ads online with just a few clicks to leverage assets and generate new revenue fast.

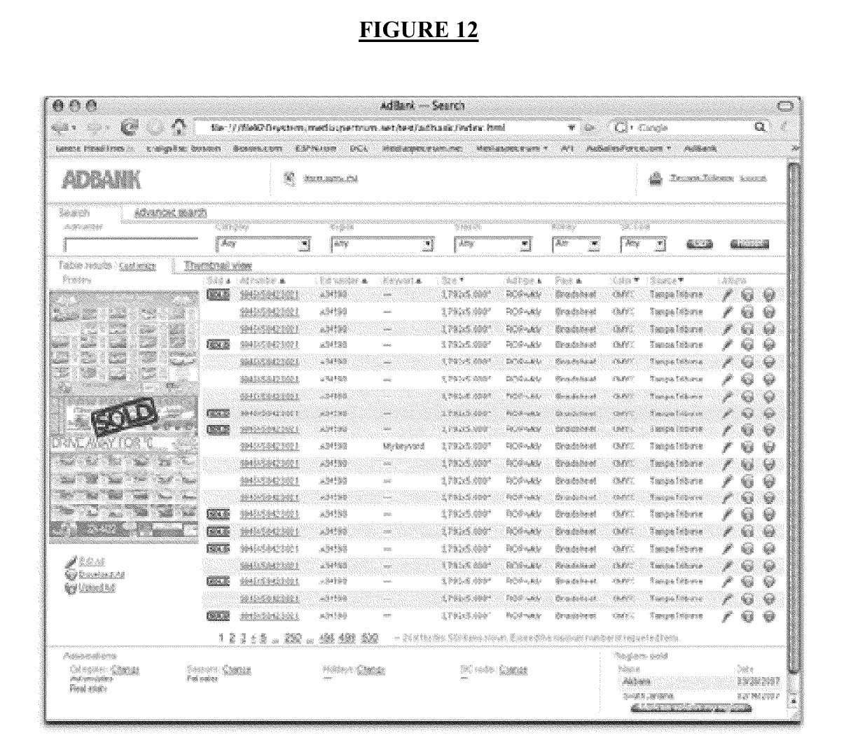

One of the most powerful benefits of AdBank is the fact that it is literally “outsourcing ready.” With AdBank, newspapers can store content centrally and let all types of partners access sample ad files, spec ads, and other material. With a powerful search engine running behind the scenes, AdBank makes it easy for popular outsourcing firms to access files and build new ads and create with speed. Together with a host of outsourcing partners, Mediaspectrum and AdBank can help streamline creative processes and leverage new revenue models to sell more ads and reduce the time it takes to build spec ads and be creative, as illustrated in FIG. 12. AdBank's portal-based interface is ideal for large, distributed organizations that have content “silos” scattered across individual properties. With AdBank, content silos are a thing of the past, and users all over the world can begin to share files immediately. Even better, AdBank was engineered with file-sharing in mind. Users can easily record which ads have sold in a particular market so they cannot be used again in a particular region. For example, an ad that sold in New York might not be available for use in Boston, but the same ad could be made available for users in Phoenix or Los Angeles. AdBank is intelligent and can be configured to support one's business rules. AdBank also gets over the issue of finding and retrieving content with the ability to tag content with all kinds of metadata. Users can easily reference information about an ad's color, size, classification, even the application that was used to build it. Ads can be tagged as customer specific (only available to that particular customer) and users can enter custom keywords as needed to make content even easier to find. With the ability to find content and govern how it is used, the distributed enterprise can leverage AdBank as a true “portal.” AdWatch is a true content management system for multichannel advertising. There are few if any limits to the type of content that can be stored and tracked in the system, which allows customers to track Banner and skyscraper advertising and can even track audio clips as MP3, WAV, VBR, 64 Kbps M3U, AIFF's or others. Digital video file formats could include MPEG, AVI, WMV, SWF, FLA, QT, MOV, M4V, M4E, and DIR.

Perhaps the most compelling benefit of the AdCenter suite is the fact that all solutions were designed to work together. AdBank was designed to take full advantage of the AdCenter Suite by working closely with Mediaspectrum AdComposer—an online ad building and editing environment. With AdBank and AdComposer working together AdCenter fuels new ad sales opportunities by serving up spec ads to advertisers as part of targeted campaigns. AdComposer can be used to customize canned spec ads with an advertiser's information and content while AdBank provides the creativity. Customers can view specs as part of an email campaign or online and use AdComposer's editing tools to edit and tweak the file to their liking. From there, a simple check-out can get the ad into production and close the sale. The AdComposer solution is an effective way to quickly generate targeted display ad campaigns to existing customers and prospects alike. Even better, the engine runs itself, without the need for manual intervention, file preparation, or customization. Everything is driven by AdCenter with the help of the content and information already in-house.

Over the past few years a number of online ad building tools have popped up in the newspaper software marketplace. Primarily first generation solutions, the tools offered a few popular features—like editing text and adding photos, but without tight integration to booking and production environments they were basically islands of features that required a lot of customization and serious integration work to have any value. Mediaspectrum AdComposer was engineered as part of its advertising platform, and a key part of the product strategy. With all the tools already in place to support online ad building (including ad tracking and production integration, integration with ad order entry systems, and the ability to work with AdBank, etc.), AdComposer offers a powerful return on investment out of the box along with unlimited ad sales opportunities.

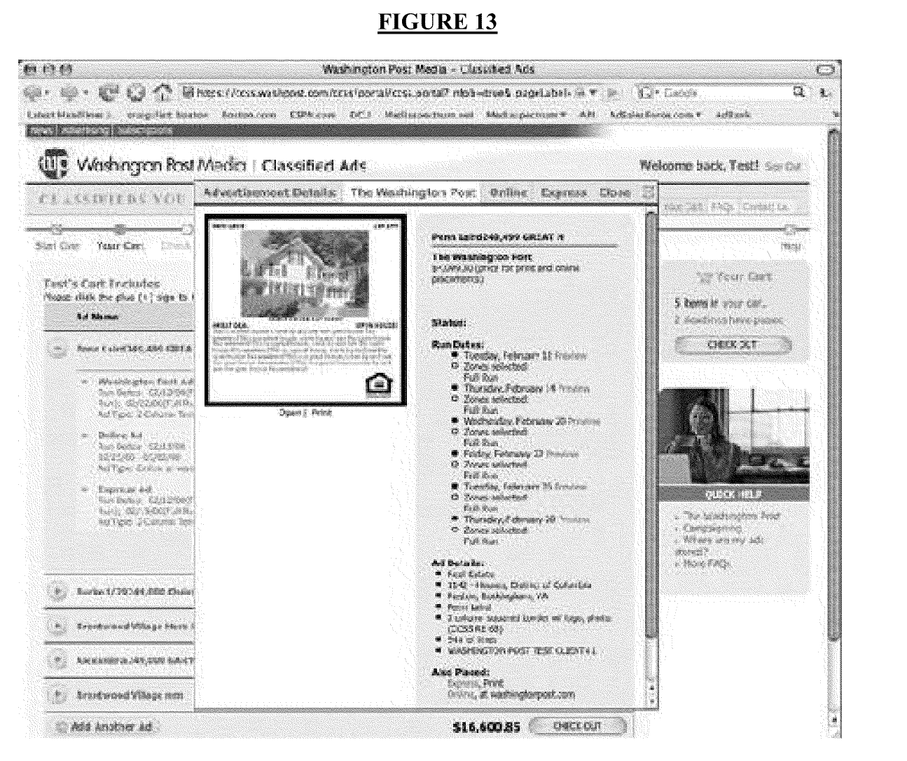

AdComposer can essentially be deployed in two different forms. First, it can be used to automatically build and format ads based on XML or a data feed that is provided. In addition, AdComposer can also be used to expose all of the formatting and design options that are available in Adobe InDesign. The first solution is ideal for churning out high volumes of ads with little to no work whatsoever. The latter is ideal for giving customers the ability to build and create their own ads online. One process is more creative, the other is designed to help automate the myriad of ads that can really be built with pre-defined templates. Both options provide powerful tools to automate ad production and create new revenue streams. AdComposer begins with templates. Sites can setup and define all kinds of ad templates and use the system to apply templates to data feeds or present templates online for live editing. AdComposer leverages Adobe InDesign server as its native ad creation engine. Templates are built in InDesign, tagged, and then imported into AdComposer for use. Once templates are setup and stored in the system AdComposer is ready to go, as exemplified in FIG. 13.

AdComposer has been successfully deployed to handle reverse publishing to take data from a number of different services, including Homescape, Cars.com, and Apartments.com. Information is provided by these services in the form of a data feed, parsed, and then imported into the Mediaspectrum database. From there, data are matched up to templates and ads are populated on the fly. AdComposer's reverse publishing makes it easy for advertisers to simply select inventory items—like a vehicle or home listing, and immediately see a display ad that is ready to go. The solution saves time while providing a valuable service that even non-technical customers can use with a few simple clicks. Reverse publishing can be deployed to build individual ads, a batch of ads, or complex campaigns—complete with a number of different ad types for different print products. In addition to building ads from data sources, AdComposer can be used to edit and build ads right on screen. Users can find a template they like and begin editing the file with some easy-to-use Web functions. All of the style and formatting options are available to users and they get as creative as they like. In this model, AdComposer is ideal for self-service ad creation, allowing newspapers to deploy online ad building portals to help drive new revenue and get new customers. And, since all ads are built online, companies can experiment with new rating models to try to reach a different part of the market that would not typically purchase retail advertising. With the ability to pull data into templates to build ads, AdComposer immediately becomes a powerful marketing tool. Groups can setup campaigns to send advertisers and prospects personalized creative. With a simple email, customers can see a personalized ad—complete with their information—and dive right into editing and making changes with a few clicks.

Mediaspectrum's Financials platform is browser-based, robust, rating, contract management and billing solution—written in java web services on the J2EE platform. It can scale from a single server processing a handful of ad customers, to a cluster of servers dealing with millions of ad customers. Mediaspectrum Billing supports anything from simple to the following complex rating, contact, and billing requirements:
Fully automated invoice generation and payment processing;
Send invoices as emails, PDF attachments, or paper;
Accept partial and advance payments;
Use bundles, packages, plans, and promotions;
Process advertising events (i.e., click-throughs) with the mediation module;
Rate events and items with complex pricing rules;
Create and update business rules with a Business Rules Management System (BRMS)—using a BRMS non-technical client personnel can add or change business rules easily to create bundles, plans, packages, promotions, and other products that include many items and special pricing; and
Multiple language, currency and localization support.
   Clients can alter how the system behaves by developing an ad ‘class’ that implements an interface and changing the system configuration to get the new class called. There are many key areas of the system with ‘hooks’ to business rules plug-ins. That is why Mediaspectrum Billing can run in different countries with different tax rules without modifying the core system.

The publishing world is becoming more complex by the day as content platforms proliferate into an ever wider array of mobile, tablet, and online devices. At the same time, publishers must create, produce, and distribute content across these channels using fewer and fewer resources. Mediaspectrum's ContentWatch is the solution, one of the most advanced, cost-effective content management platform in the world. Its feature-rich environment incorporates tools like integrated search and text mining dashboards, an advanced creation workflow engine, and the ability to mine and automate the production of new published products based upon demographic or individual preference. Built over the past decade as a pure web services platform, Mediaspectrum's technology provides full content management support for all media types. ContentWatch enables publishers to publish to any channel—including the iPad, web, social media, and even print—from a single consolidated platform that can be accessed anywhere, anytime, from any connected device.

Publishers need a solution that allows them to manage the entire content process organization-wide, one platform that powerfully and elegantly handles all outputs and helps them to reach their audience across every property and on every device. Mediaspectrum ContentWatch is that solution, empowering publishers to manage content for every mobile device, tablet, Web site, and even printed publications. Stories are developed, assembled, and edited in packages and folder structures independent of output. Editors, writers, sources, and activity assignments can then be linked to—and work collaboratively within—these folders. This content can be assigned to multiple packages or folders simultaneously, which might represent different story angles, output destinations, or umbrella stories. Once complete, ContentWatch automatically configures them for output to multiple channels based on rule-based work-flow actions. Further, ContentWatch incorporates rich, extensible meta-data fields for SEO, rights management, semantic tagging, micro-payments, audience usage, and the like. These meta-data fields are configurable, search-enabled, and can be used by content routers to trigger specific actions. Thus, ContentWatch features a single, Web-based management console that allows non-IT users to manage a central database of master data, including titles, print products, digital outputs, work-flow, user access privileges, meta-data definitions, and automated publishing.

Mediaspectrum®-brand Deals™ is the first complete solution for media companies looking to expand into the rapidly growing deals market. Mediaspectrum's powerful cloud-based technology offers a radically different approach to the “daily deal” business model established by industry giants and a host of other competitors. It is a better, smarter approach built on the backbone of one of the most powerful advertising technology for today's new media age. Its key features include the following:
Self-service portal that enables customers to create and manage their deal listings directly,
Dramatically reduces the cost of entering the deals market;
Deep integration with the Mediaspectrum Sales platform to support every ad type—Web, mobile, deals, and even print—all on a single, unified solution; and
Full CRM capabilities to better manage advertisers and effectively reach consumers.
   With Mediaspectrum Deals, the entire deal process is fully automated from start to finish, including scheduling, billing, design, and placement. Businesses are empowered to create and manage their own deal listings, which consumers buy online and redeem via purchased vouchers at the participating business. Mediaspectrum Deals further handles the entire consumer payment process, automatically splitting the revenue generated according to the terms set by the media company.

The Mediaspectrum self-service portal dramatically reduces costs by enabling local businesses to directly schedule, create, and manage deal listings via its automated technology. There is no need to create an expensive sales force or elaborate internal workflows to sell and manage deal listings—the self-service portal handles all of these requirements. And it is not just customers that benefit from Mediaspectrum's cloud-based technology. Internal staff has access to the entire deals and advertising platform anywhere, anytime, on any connected device, radically increasing efficiency across the organization. The Mediaspectrum advertising platform supports almost every ad type and output across every device. Mediaspectrum Deals integrates seamlessly with this powerful advertising engine, enabling customers to create comprehensive campaigns across all platforms and ad types, including deal listings. It is one-stop shopping at its best, a single destination for advertisers to create a complete campaign. Major deal sites like Groupon® do not offer businesses the opportunity to extend their marketing reach to other ad types, including the full range of possible ads for Web, print, mobile, social media, and tablet platforms. With Mediaspectrum, local advertisers can choose whatever combination of advertisement they want, enabling media companies to sell—and upsell—their entire range of offerings.

Mediaspectrum technology automatically tracks the advertisers and consumers that interact with the deals platform, enabling both media companies and listing businesses to craft effective outreach programs through coordinated email campaigns and other marketing efforts. The system records the full purchase history of every deal subscriber and enables local businesses to directly manage their customer contacts. Internal sales processes are simplified with Mediaspectrum's automated activity management for sales teams, optimizing their efficiency, including the following key features of its advertising benefits:
Low pressure and user-friendly self-service environment to manage deal offerings;
Advertisers completely control their deals;
Reports show the advertiser who bought their deal and when; and
Many other benefits.
   Thus, Mediaspectrum provides technology that revolutionizes the way advertising and content is published in the mobile age by providing a unified, multi-channel platform that has one of the most sophisticated advertising and content management technology for unified, real-time publishing to any device, including print. Available on any internet enabled device by virtue of its ground up web-services foundation, the Mediaspectrum platform combines readily with new mobile devices, such as the iPad, to provide a truly transformational experience for publisher's operations, their partners, their customers, consumers, and advertisers alike. Whether taking the form of a mobile workforce, an outsourcing partner's dashboard, a published iPad app or print magazine, or a self-service portal for booking ads anywhere—the Mediaspectrum platform enables the future of publishing today.

Mediaspectrum®-brand Sales™ is the ultimate thin client ad order entry solution. Built entirely as Java Web-services, Mediaspectrum Sales centralizes booking, component management, customer information, and the rating process with a single elegant solution. Best of all, the system supports both traditional classified and retail ads, as well as new media ad types such as banner ads and skyscrapers. The end result is a solution that lets one book all types of ads-from virtually anywhere, and maintain control of the production and distribution of those ads. With AdSalesForce one can easily book orders across publications, Web properties, and specialty products with the ability to move ads between publications without rekeying or reformatting. The indexing and categorization engines automatically tag classified and retail ads through the use of customizable plug-ins. Once tagged, the composition engine can accurately replicate the H&J and text-flow functions of all front-end systems in use. Ads entered via the Web or client-server application can be freely edited and passed through systems without the need to rekey, reflow, reformat, or convert the ad from one format to another. Price quotes, styling, line-endings, and hyphenation for print ads booked online always match those of ads booked in-house. Built into Mediaspectrum's AdSalesForce for classified and retail ad copy entry, the composition engine offers the only WYSIWYG text editor that reconciles variable rates on the back end. Commands follow easy to use conventions and support complex formatting and design requirements for the most demanding publishing environments.

AdSalesForce also gives the ability to support multichannel packages for a single ad order. Complete with customizable sales prompts, upsell tools, and cross-sell options, the system makes it easy to repurpose ads for a variety of different mediums and quickly gain new revenue from previously untapped sales channels. With AdSalesForce print ads can move to the Web and other publications while Web ads can be reverse-published to print publications with little to no extra effort. AdSalesForce's ad packages are customizable and can encompass a wide range of publication, category, zone, and scheduling combinations. Pricing for all ad packages is dynamic and sales prompts lead the user toward the most attractive ad packages. The end result is a solution that helps increase ad revenue for all channels-print, Web, and beyond. AdSalesForce also boasts one of the first template-based solutions for online ad building. Customers can access a bank of frequently-used layouts and formats and use these as templates to create new ads. Formatting and style features are easy to use and follow standard design conventions so even customers with little to no experience can build striking ads quickly. Built entirely as Java Web-services, AdSalesForce is a truly modular application which means all of its features and functions can be repurposed to build unique products as needed. Order entry portals can be set up for transient ad sales. Commercial accounts can access portals to view ads and book ad reservations for multimedia packages. Sales representatives can access standard order entry and ad tracking features from Pocket PCs in the form of a wireless portal. With AdSalesForce, the possibilities are practically endless.

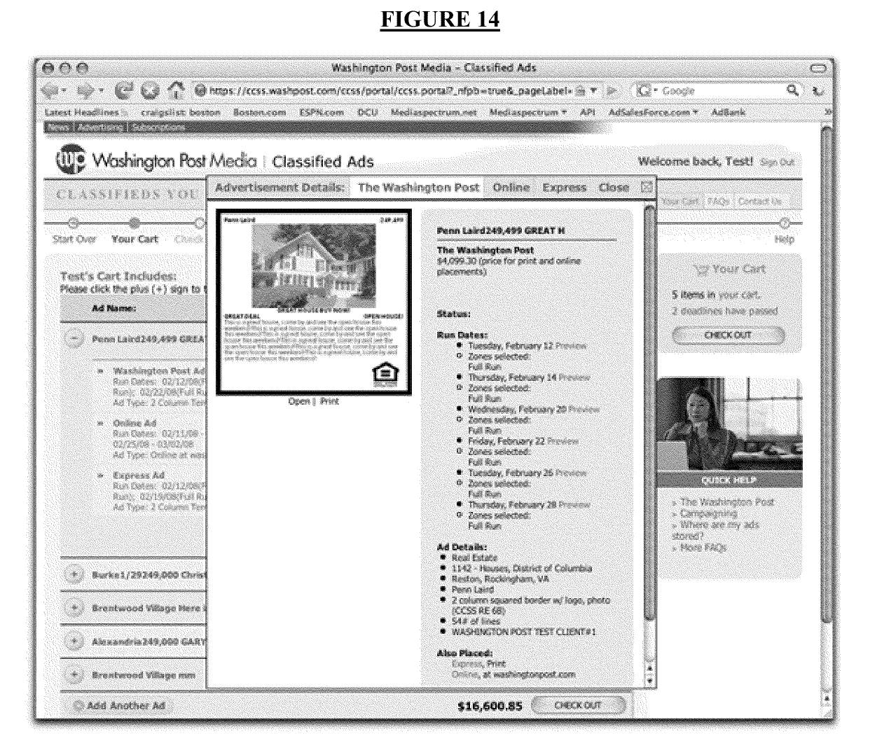

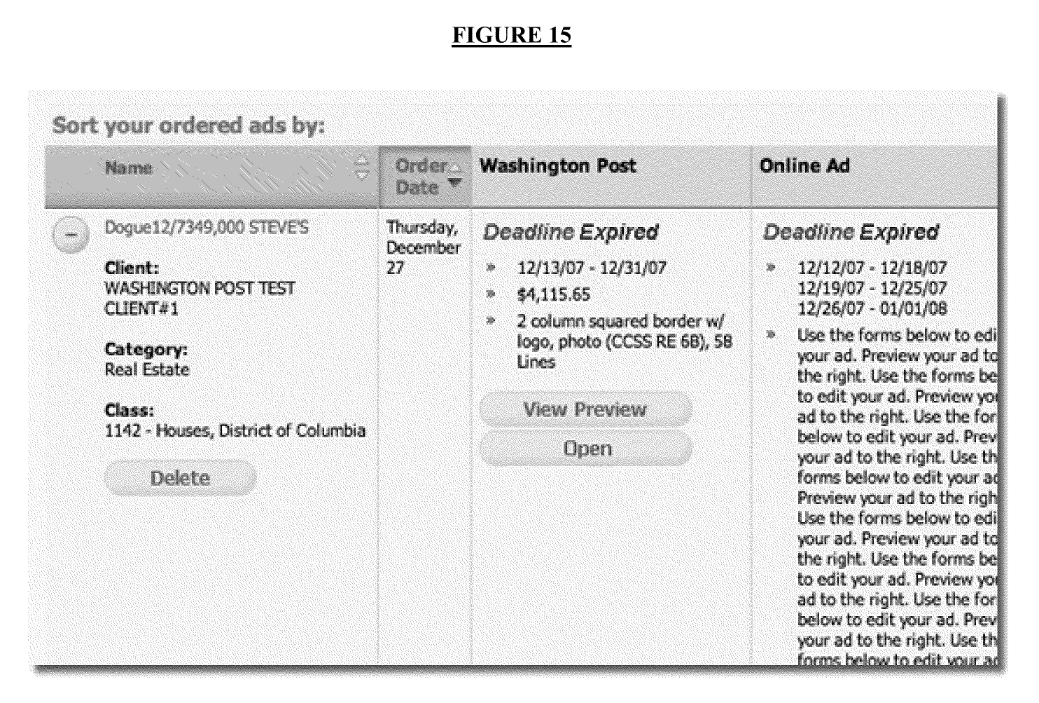

It is believed that customer-centric, self-service advertising sales portals are the future of advertising because, as with the resounding successes of EBay®, Yahoo®, and Google®, they provide customers with an easy-to-use, low-pressure environment to place and purchase an advertisement by simply logging onto a Web site. Mediaspectrum Sales: Self Service contains the most common ad features available to users so they can set up multi-channel run schedules, define where the ads are going to run, and build the actual ad itself. By compiling groups of services and setting up ad sales portals, it is believed that the exemplary system disclosed and described herein has eliminated the need to maintain large call centers necessary to support the ad taking process. From an IT perspective, Mediaspectrum Sales allows traditional media companies to migrate away from client-server applications and move quickly into the world of Web-services employing server-based client applications, such as shown in FIG. 14, allowing customers to place ads for any channel via a simple-to-use form-based entry. Pricing, all the way through output, happens without the customer speaking to anyone. As advertising increasingly spans a variety of different media types, it is becoming more difficult to service national advertisers and corporate accounts. It is believed that Media 2.0™ provides the tools and the capabilities to set up Web portals and extranets for advertisers. By compiling a number of different Ad Commerce Services, commercial accounts can be provided with one-stop shopping in order to search for, view, and edit ads of all types so customers can manage everything about their ads and campaigns in a simple, elegant user interface, as exemplified in FIG. 15.

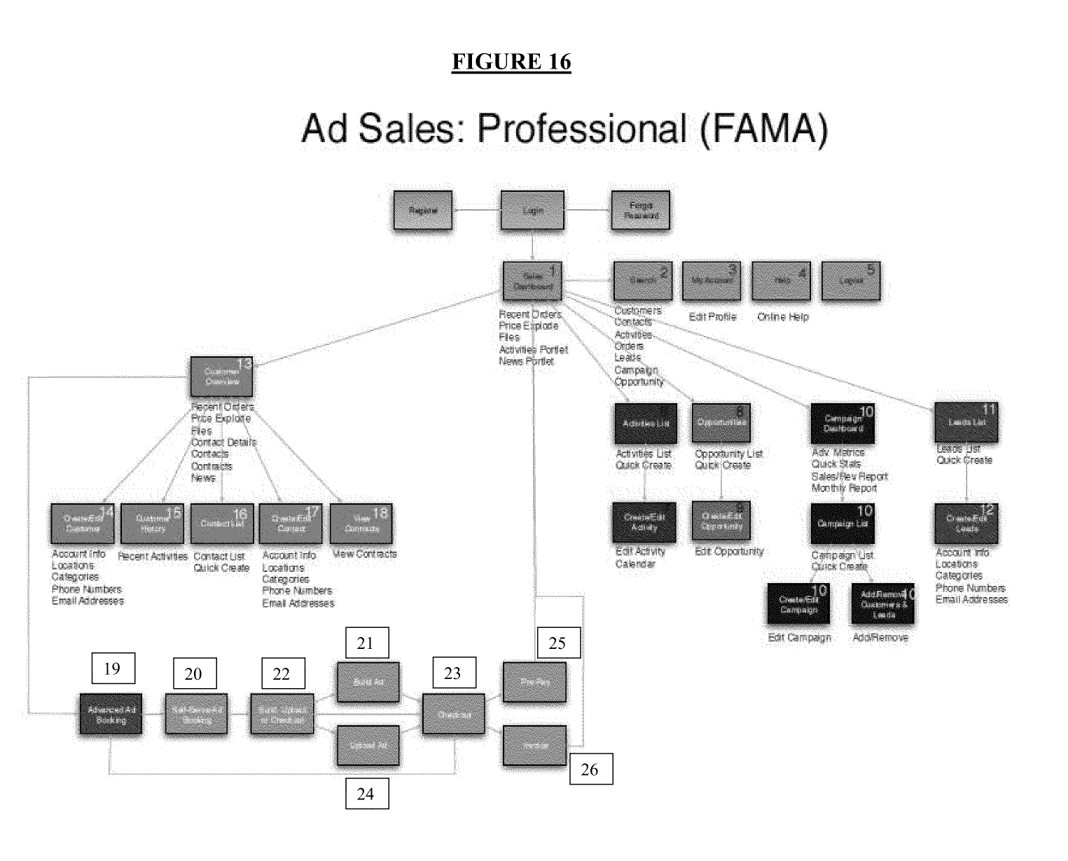

The Mediaspectrum®-brand Ad Pricing Engine™ is a breakthrough in how ads will be sold and rated in the future. Ad rating for multi-channel media has always been the most difficult part of transformation for media companies. How to offer different pricing models without cannibalizing existing revenues, how to model new rates on the fly, how to implement new ideas in real time. Now, for the first time, the Mediaspectrum Ad Pricing Engine provides the framework for advertising rating of the future by using the exemplary technology and process described herein that allows companies to massively consolidate legacy rating schemes while at the same time allowing a plethora of new and unique rating approaches for the future. More particularly, a block workflow diagram of the Mediaspectrum Sales component (MS Sales), including various modules according to an illustrative embodiment, is described with reference to FIG. 16. My Account (3) in FIG. 16 provides the manner in which users can control user name, password, and any additional specifications. Logout (5) allows a user to log out of MS Sales. Help (4) allows a user to obtain online help for use and navigation of MS Sales, if necessary. The Sales Dashboard (1) is the main navigation tool in MS Sales. For example, when the user first logs into the Dashboard, the user can choose which area of MS Sales the user wishes to navigate via the Dashboard. Search (2) provides a variety of methods for a user to search for orders. For example, orders can be searched based on the order run/creation date, the order contents, customer details, etc. When the user searches, all matches will display on the Dashboard. Activities are a way for sales users to manage their tasks in order to complete sales. Activities list (6) generally allows the user to search for existing activities based on the activity's associated customer, deadline, dates, etc. Create/Edit Activity (7) allows the user to associate a task, for example “Call x customer regarding x opportunity,” and schedule the task so as not to lose site of it. The user can also keep track of activities results through the edit activity fields, for example “Was the activity successful?”

Opportunities (8) are areas to track potential opportunities for sales. Opportunity generally allows users to describe what the opportunity is, for example “Sell x amount of x product to x advertiser,” and the likelihood of completing that opportunity. Create/Edit Opportunity (9) generally allows a user to create a new opportunity when the user feels there is a chance for a sale. The user may tie the opportunity to a chosen customer and describe the expected close date. Opportunities (8) can also be tied with activities (“Call x advertiser in order to close x opportunity”). The user can edit an opportunity if it is complete or needs to be modified. Campaigns (10) are organized plans to generate sales. Campaign allows the user to create and manage campaigns. Campaigns (10) can be aimed at specified customers or leads, for example “If you place X orders through us, we'll give you X discount.” Activities (6) can be associated to each campaign, for example “Contact X advertiser to inform him of X campaign.” The users can also run reports to see whether the campaign was successful, for example “What % of customers/leads created an order due to the campaign.”

Leads are potential customers. These are generally businesses/individuals a sales person will keep track of to potentially convert into a customer. On the Leads List (11), the user can search for leads based on contact information, lead status, creation date, etc. Create/Edit Lead (12) allows the user to create and edit leads. Leads will generally contain similar information as customers, but the profile will not be as complete. Leads profile may generally contain customer contact information, associated campaigns, business category (what type of business is the lead in), etc. Customer Overview (13) allows the user to view a listing of all customers from the customer overview. The user may search for customers based on creation date, order details, customer contact details, etc. Create/Edit Customer (14) allows users to create and edit customers. Customers can be created from a blank profile or converted as leads. If a lead is converted to a customer, all lead profile data will transfer to the customer profile data. In addition to contact information, customer profiles generally indicate customer status, whether the customer is an agency/business/individual, team/individual assigned to customer, category (type of business the customer is in), etc. If the customer has an agency, the user has the ability to search and assign a particular agency to the customer. See Use Case 22 for further detail.

Customer History (15) allows the user to view all history relating to the customer, including exactly what data was entered, when it was entered, and by whom. Contact List (16), each customer can have a contact list, for example “Your customer may be X Automobile company, but your contact would be Jane Joe and John Doe.” Create/Edit Contact (17) allows users to create and edit contacts. Generally, each contact will contain methods in which to contact the person, for example “The contact's birthday (if the salesperson wishes to send a card), title etc.” Contacts (16) allows a salesperson to understand that, for example “When he needs to contact X Automobile company for Y data he will contact Jane, but when it's in relation to Z data, he will contact John.” View Contracts (18) allows users to view contracts. Contracts are agreements with advertisers, for example “If they sell x amount of y product, then they will receive z discount.” Contracts can be specific to one advertiser or apply to many. Users will be able to report on how close the contract is to fulfillment.

Advanced Ad Booking (19) is the most robust feature of MS Sales. Through advanced ad booking, a user can place a print classified, print display, or digital order. The user may book a package of products that would have an associated discount. The user may also apply a discount to the order (based on his user role and capabilities). See Use Cases 10, 11, 21, 23, 24, 25, and 28 for further detail. Self Service Ad Booking (20) is the tool advertisers would use to book orders on their own, without assistance, for example “If an advertiser calls his sales rep with a question about the process, the sales rep can link to self service so the user may view which fields/screens the advertiser has questions about.” Build Ad (21) allows users to create an internal production ad through the order entry screen. Based on category and publication, MS Sales will display one or more templates to enter the appropriate fields, for example “Car ad will have one group of fields while a House ad will have another.” Users may upsell the ad by customizing text, including a picture, etc. Completed ad may be sent to AdWatch or AdWatchex via Build, Upload (22). See Use Cases 6, 10, 11, 21, 23, 24, 25, and 28 for further detail. Upload Ad (24) is generally used when the ad is not entered by the salesperson. The salesperson reserves the “space” (dates, position, publication, etc.), who can upload the content via the Order Entry Screen (work in progress) or the Dashboard. Completed Ad (23) is sent to AdWatch or AdWatchex/Eproofs. See Use Cases 6, 11, 13, 14, 17, 18, 21, 23, 24, 25, and 28 for further detail.

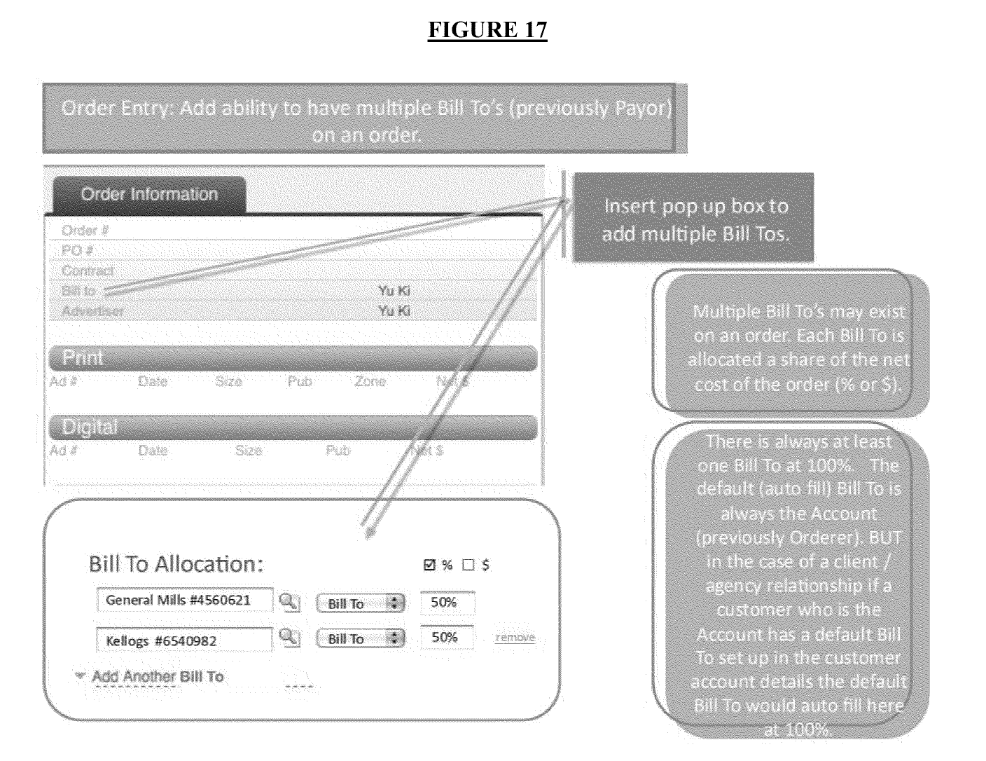

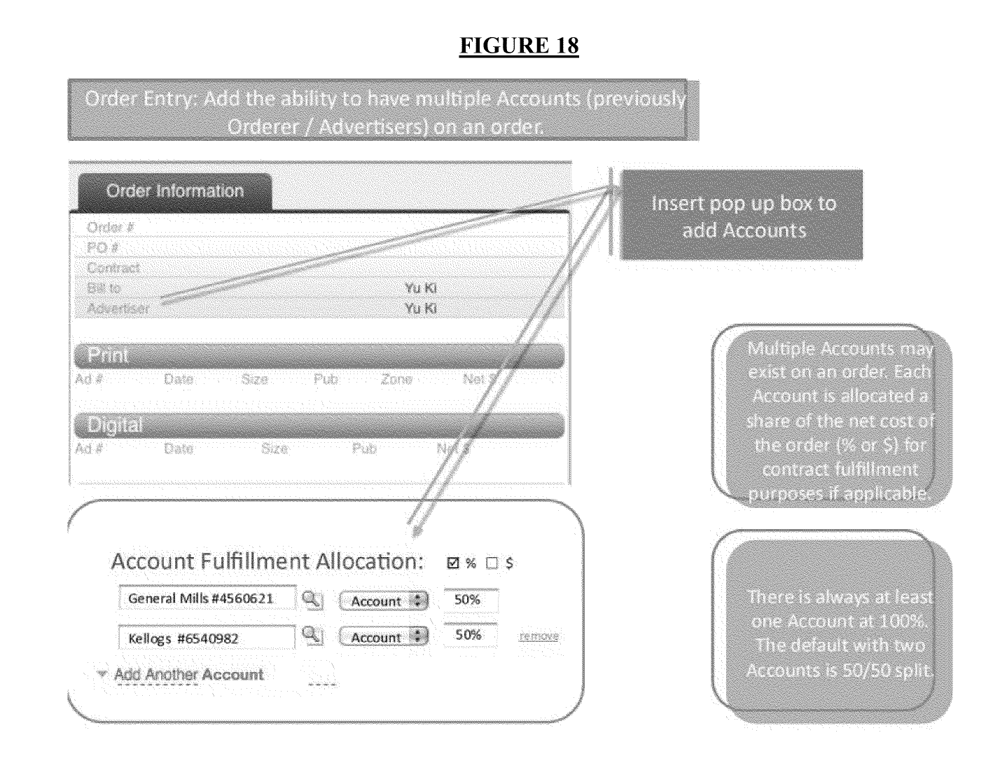

When the user places an order, the user has the option to Pre-Pay (25) or Place On Account. Based on the customer's profile, some may be required to Pre-Pay (25) only. User will be taken to the payment screen to enter method of payment. Upon placing payment, MS Sales will communicate payment with external finance system. If a customer can place an order on account, MS Sales allows the user to place the order on account without pre-paying or pre-pay for a portion of the order. MS Sales can communicate with the finance system for credit limit, etc. See Use Case 31 for further detail. Further, when the user places an order, the user may have the ability to bill the order via an Invoice (26) to multiple persons/entities, as illustrated in FIGS. 17 and 18.

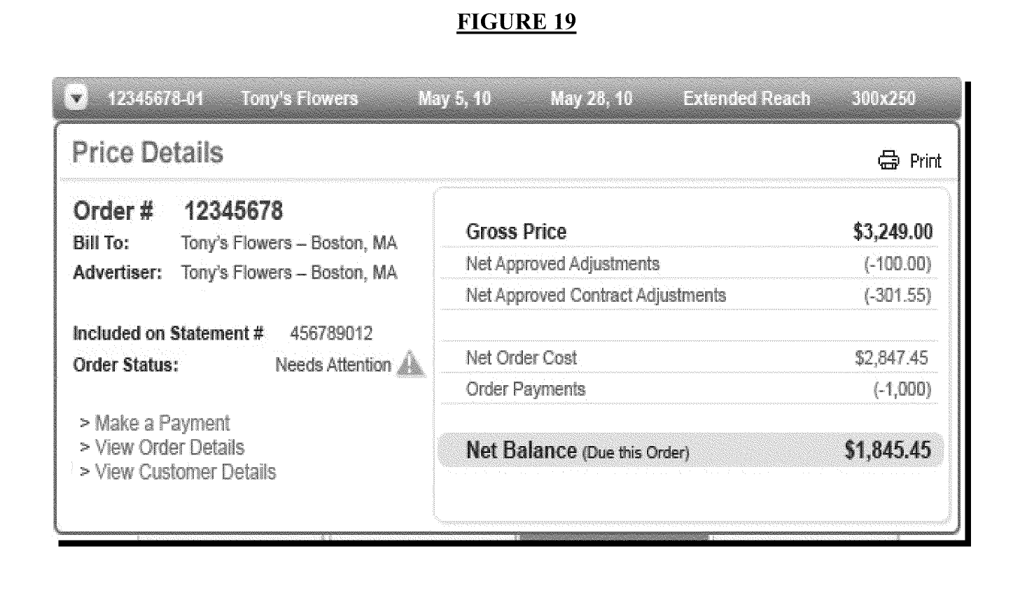

In an illustrative embodiment, the user may make payments to orders using a credit or debit card, and/or a checking account, as illustrated in FIGS. 19 through 25.

The following describes how users can make Payments to orders:
Click “Make a Payment” from Price Details tab on the Sales Dashboard, as illustrated in FIG. 19.

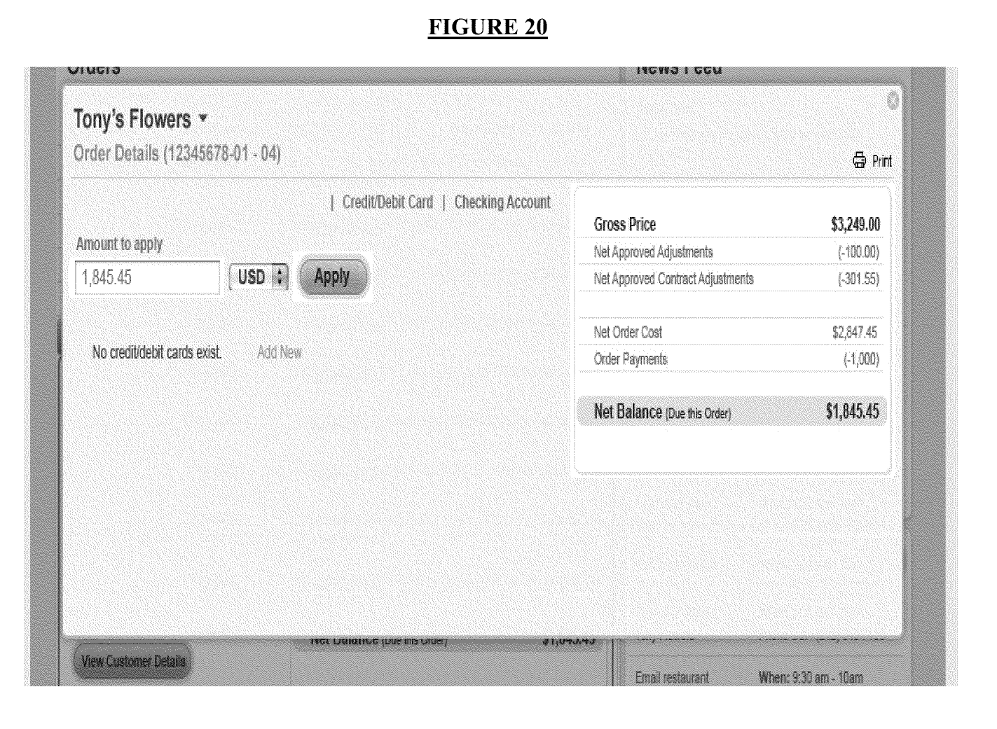

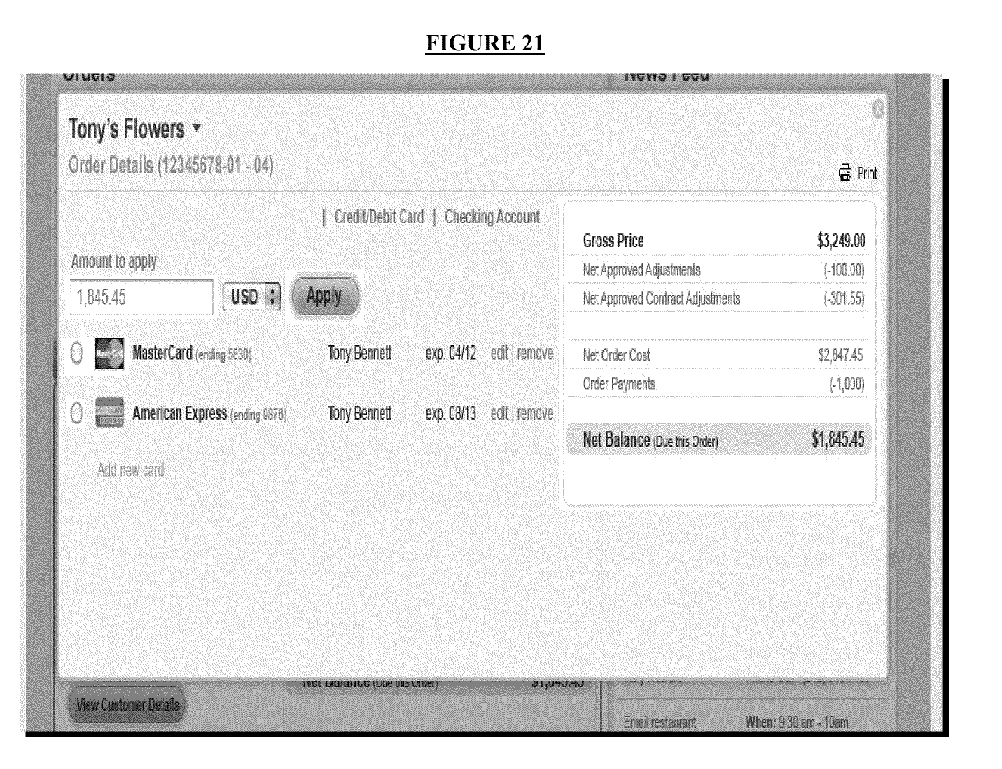

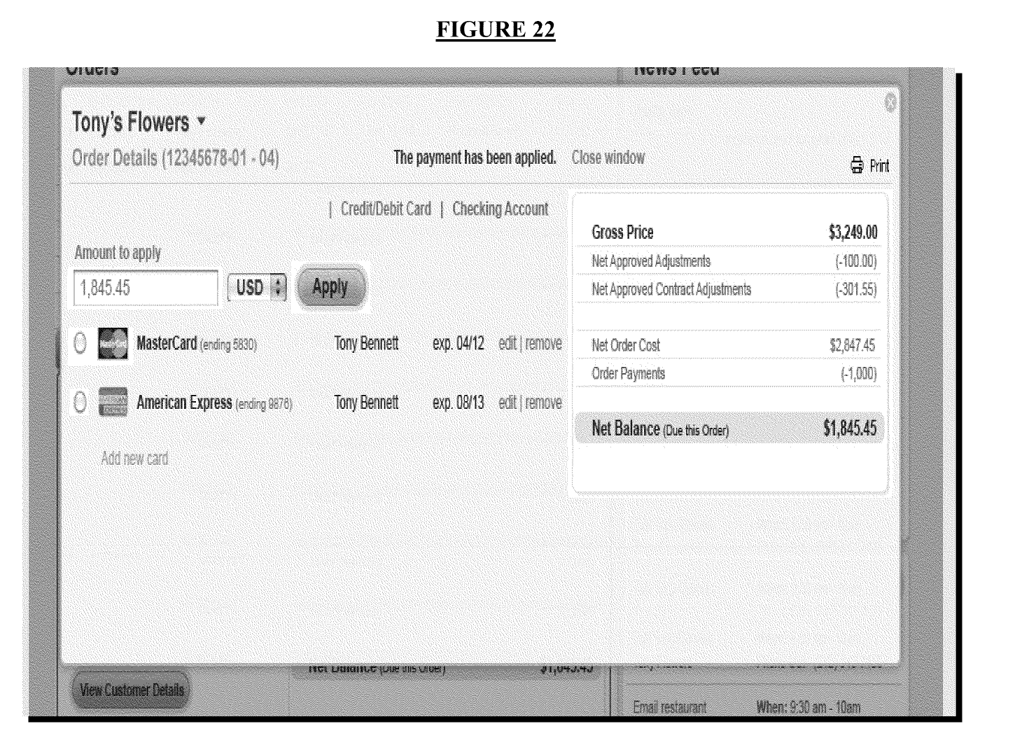

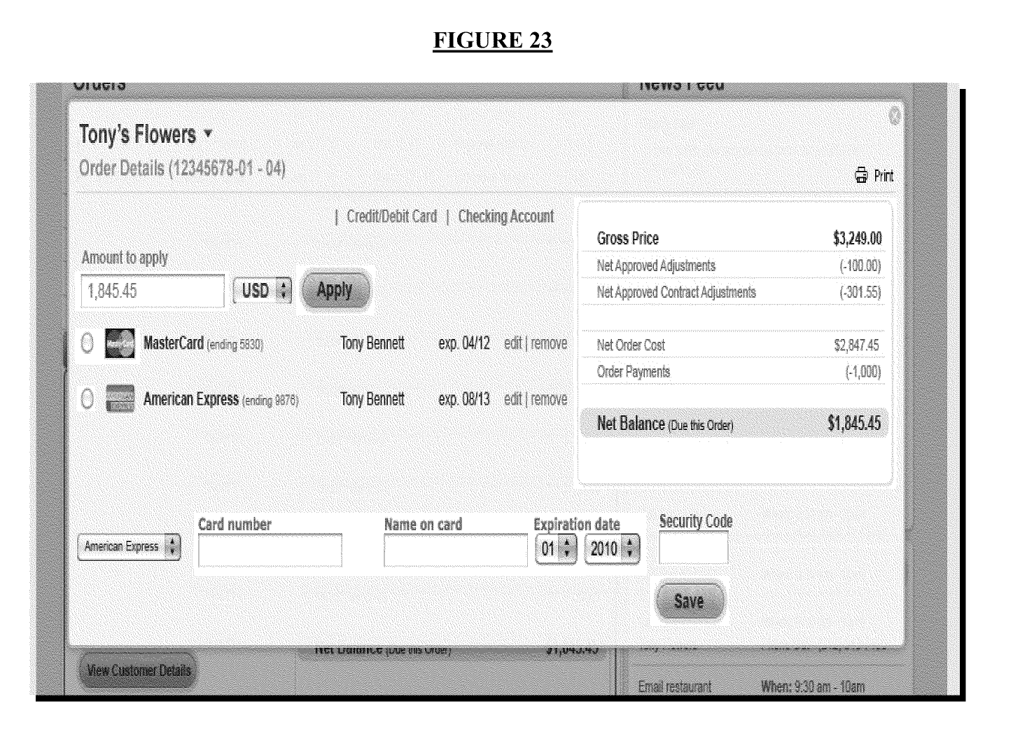

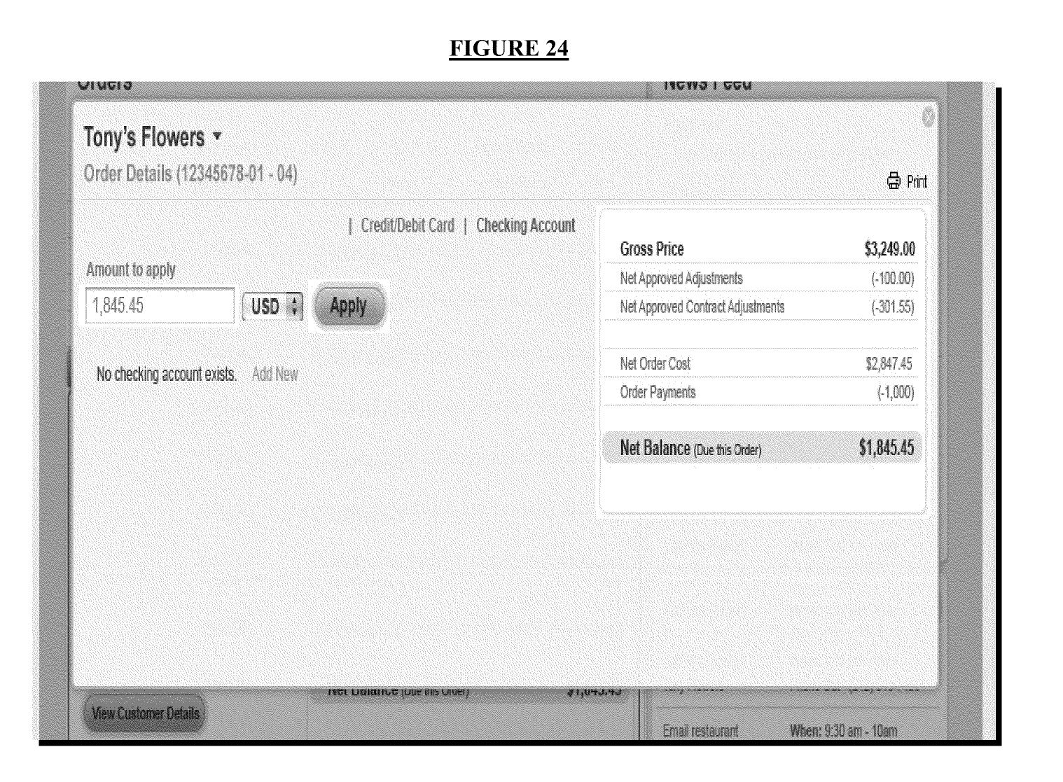

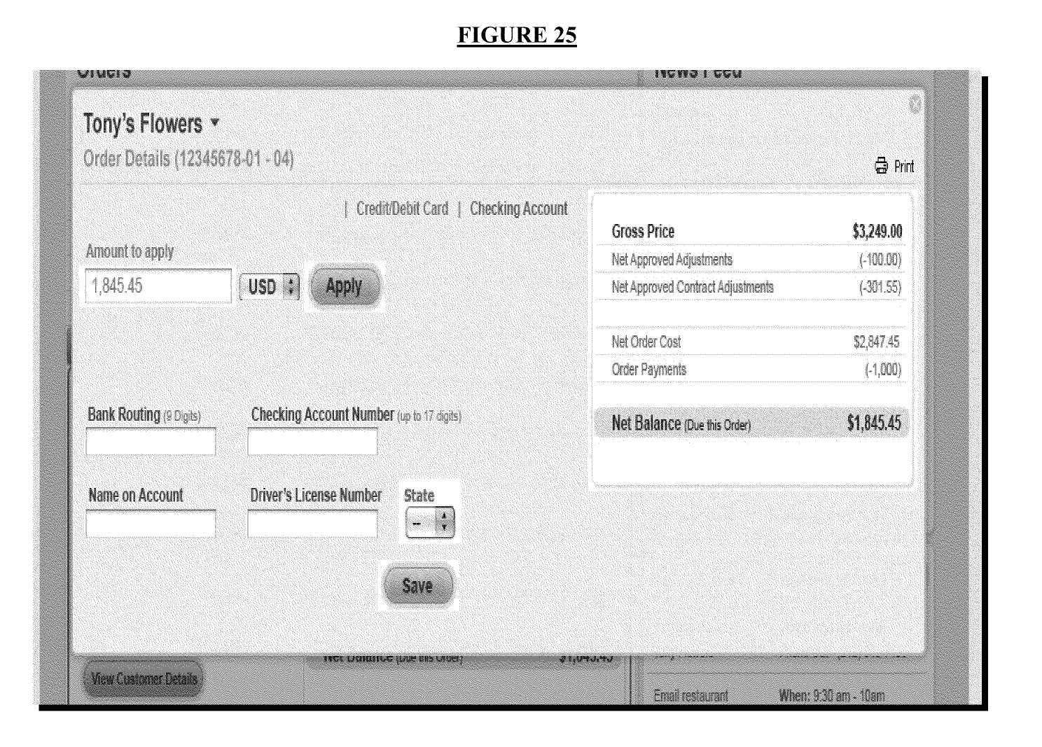

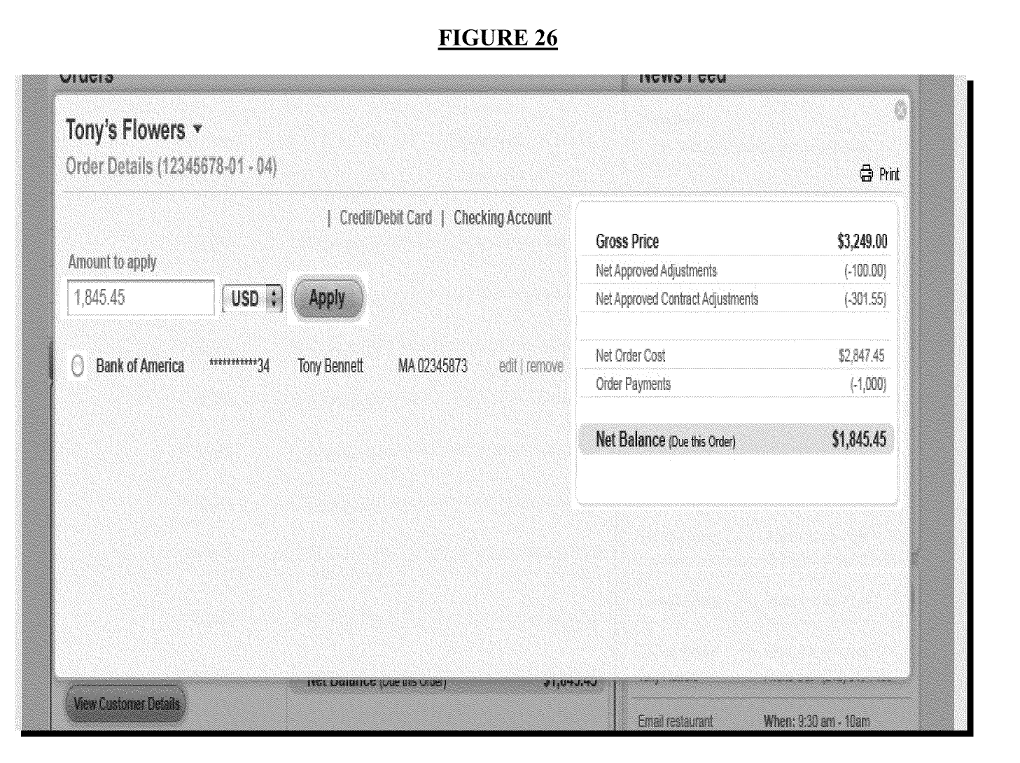

Paying By Credit/Debit
Option for paying by Credit/Debit is loaded by default when page loads;
By default, the <net balance> populates in the <amount to apply> box. This can be edited if the user wants to edit the payment amount;
If the user clicks “Apply” before a card is selected, a message may appear in the message box (see message box details below)—Message: “Please select a credit card to apply the payment;”
The user clicks “Add New” link and new card forms appear, as illustrated in FIG. 20;
If multiple cards exist, the user selects the appropriate card;
   Expired cards should have the radio button disabled, for example, row should be visible but may be a softer grey to look unavailable, as illustrated in FIG. 21;
Once a payment is “Applied” a message is displayed in the message box—Message: “The payment has been applied;”
The user can close the window or apply another payment, as illustrated in FIG. 22;
A form illustrated in FIG. 23 can be used to create new or edit existing credit/debit cards; and
Once a card is “saved” it is validated;
   If a card fails validation;
      A message appears in a message box—Message: “Card details failed validation. Please try again;” and
      The form remains visible with the entered data;
   If a card passes validation;
   It appears in the list as shown;
      A Message appears in a message box—Message: “Card has been added;” and
      The form disappears. Paying by Checking Account
By default, the <net balance> populates in the <amount to apply> box, which can be edited if the user wants to edit the payment amount;
If the user clicks “Apply” before an account is selected, a message appears in the message box (see message box details below)—Message: “Please select a checking account to apply the payment;”
The user clicks “Add New” link and new checking account forms appear, as illustrated in FIG. 24; Once “Add New” is selected, the form appears.
All data are required;
Then the user clicks “Save” (which may include validation), as illustrated in FIG. 25; and Then a checking account appears, as illustrated in FIG. 26. In an illustrative embodiment illustrated in FIG. 16, when an order is about to be priced MS Sales checks whether a customer is a contract customer. If it is a contract customer, then the current booking needs to be checked with the contracts qualification rules to find the matching contracts of a runschedule or an order level. If no conflicts are found, then the contracts should be assigned silently and the price should be applied against the contracts. If there is a conflict, then the user must make a decision on which contract to apply. For contract customers MS Sales makes asynchronous calls to eBridge™ and provides the same data as is sent for pricing for contracts qualification before the call to a pricing engine is made. A notification should be shown to a user about conflict in the contracts and about the exact match. The user may need to confirm a contract selected. A call to a pricing engine should be done with the selected/assigned contracts.

Qualify Rule Use Case:

1) User starts a new order;

2) With every change an ajax call is made to pricing services to find the applicable contracts and their prices;
pricing services find assigned customer contracts for the current orderer, payor (ContractCustomers);
for every contract find the qualification rule packages URLS and match execute them;
for every matched set of contracts price the order; and
return matched contract names/ids with the runschedules or an order that they match and the pricing;

3a) If only one contracts set is found, then consider it assigned;

3b) If there are conflicts (more than one contract set is returned), then display the choice to the user, and the choice is organized so that the user picks a preferred set of contracts; and

4) User places an order, considered contracts are assigned in the database with the proper orderid and runscheduleids.

Fulfillment Rule Use Case:

1) User creates an order;

2) The system validates whether the order fulfills any of the active contracts by executing the ContractFulfill rule against each of the contract;

3) If more than one contract qualifies for fulfillment by this order, then the user is presented with an option to select the contracts to place the orders; and

4) The system calculates the units (SQL functions are used) and saves the information to the CoFulfillmentRec table.

Tables Documentation:

BRMSPackages

Table stores all the references of the drools packages. It is a replacement for the ShAppSettings storage of drools URLs:
RULETYPE—a type of a package, that can be one of ‘Pricing’—a rule for rating an order; ‘ContractQualify’—a rule for matching an order to a contract, whether the order can be discounted or re-rated with the contract; ‘ContractFulfill’—a rule for matching an order to a contract, whether the order fulfills the contract; or ‘Localization’—a rule for l10n of UI apps.

ContractTemplate

The contracts templates master table:
DURATIONTYPE—A duration of the contract for the first fulfillment variable, that can be one of the ‘days,’ ‘weeks,’ ‘months,’ or ‘years;’
DURATIONTYPE2—A duration of the contract for the second fulfillment variable, that can be one of the ‘days,’ ‘weeks,’ ‘months,’ or ‘years;’
CONTRACTLEVEL—The default level CONTRACTTYPE, that defines whether the contract is a discount or a rate contract. Discount contracts receive discounts on orders; rate contracts re-price the orders with the separate rules, that can be either ‘Discount’ or ‘Rate;’

ContractDiscountLevel

The table completes the contract template definition with a set of levels allowed in this contract. Each level defines minimum and maximum required fulfillment values and the discount for that level (For ‘Discount’ contract types). For ‘Rate’ contract types this tables defines the definitions of the levels only. The rating definition itself is in the Drools packages:
DISCOUNT—For ‘Discount’ contract types, with the discount value (0 to 1) for the level; and
USEOPENRATE—If ‘1’ then the regular ‘Pricing’ BRMS packages should be used for pricing without any contract data.

ContractFulfillmentVar

The table stores the definition of the possible fulfillment variables. There is no restriction currently on what can be a fulfillment variable. For every fulfillment variable there may be a SQL function that calculates the fulfillment against the variable to keep the model as flexible as possible initially.

ContractInstance

When a customer or a pair of customers are assigned a contract template and a contract instance is registered in this table:
CURRENTLEVEL—a number defining the level, that is not the ID of a level, but is the level itself. This field corresponds to the ContractDiscountLevel.

ContractInstanceStatus

The list of possible contracts statuses that is Hardcoded.

| CODE | DESCRIPTION |
|---|---|
| ARCHIVED | Deleted, not valid anymore |
| DRAFT | Contract instance being worked out |
| PENDING | Waiting for approval |
| RUNNING | Approved, currently working |
| COMPLETED | Completed |

ContractCustomers

The table defines the assignment to a customer or a pair of customers. A contract can be assigned to either orderer or payor, or both at the same time, which means the contract is not applicable to orders of the same orderer but a different payor, for example

ContractStatistics

The table stores daily dumps of the contract fulfillment for reporting purposes:
PROJECTION—Can be ‘On level,’ ‘Below level,’ or ‘Above level.’

ContractOrder

The list of orders or Runschedules that were affected by the contract (for example, received a discount or a special rate):
ADORDERID—a link to an order that received a contract price. Must be filled even for Runschedule Level contracts;
RUNSCHEDULEID—a link to a Runschedule if it is a runschedule contract;
RULENAMES—a comma separated the list of drools rules names used for qualifying an order;
ORDERAMOUNT—an amount that was generated by this contract; and
DISCOUNT—a discount that was received by this contract (may by for ‘Discount’ contract types only).

CoFulfillmentRec

The list of records that affected the contract fulfillment that can be orders or runschedules or Credit/Debit operations:
VAR1FULFILLMENT—a number of the fulfillment varl values contributed into this contract;
SOURCETYPE—not used now;
REFADORDER—a link to an ad order that contributed to the contract;
REFADRUNSCHEDULE—a link to AoAdRunschedule that contributed to the contract;
EFFECTIVEDATE—to which date the event should be applied for contract fulfillment calculations; and
CREDITDEBITID—a reference to a transaction (if it is not an order or runscshedule fulfillment, e.g., a manual adjustment or a special payment for keeping up with the contract terms without actual order booked).

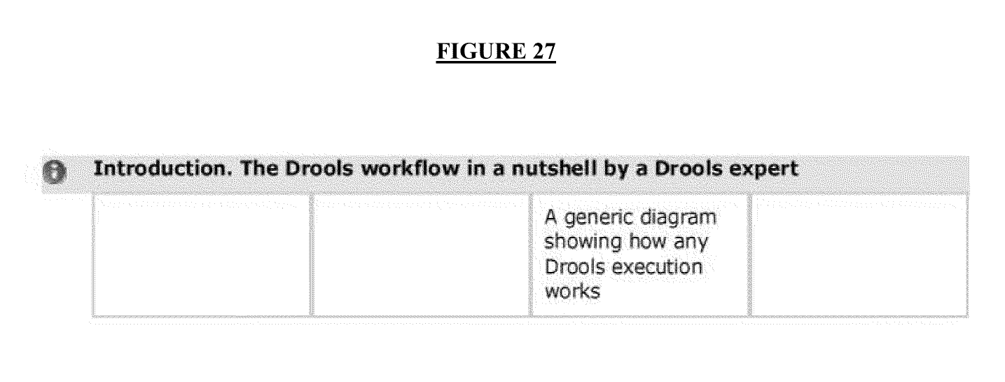

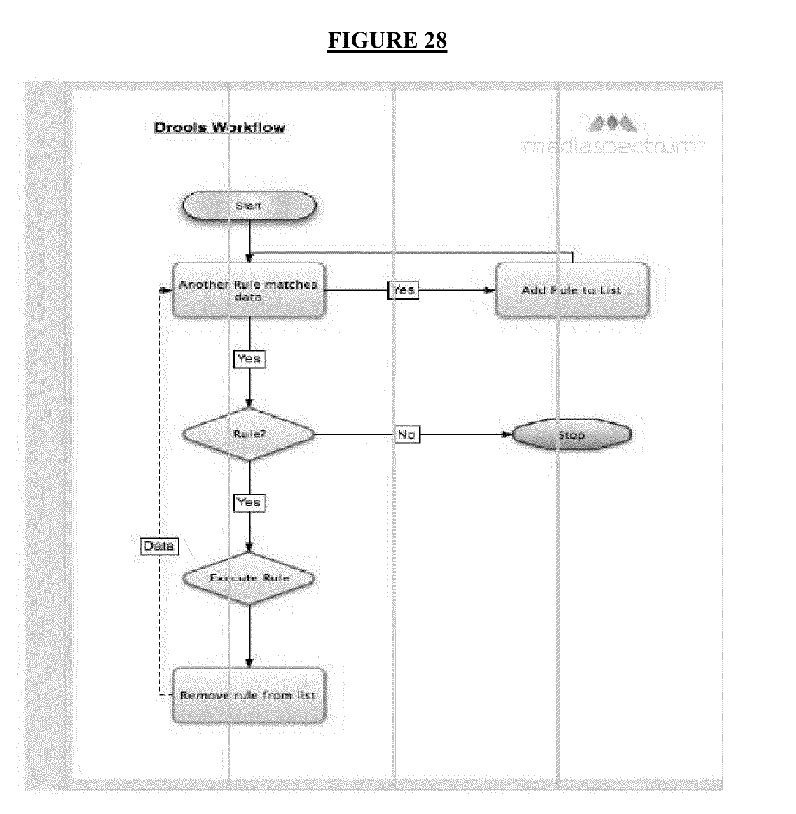

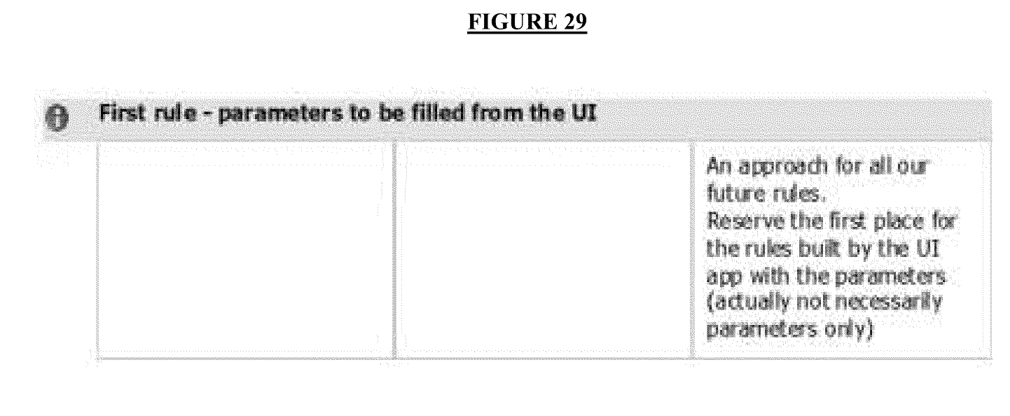

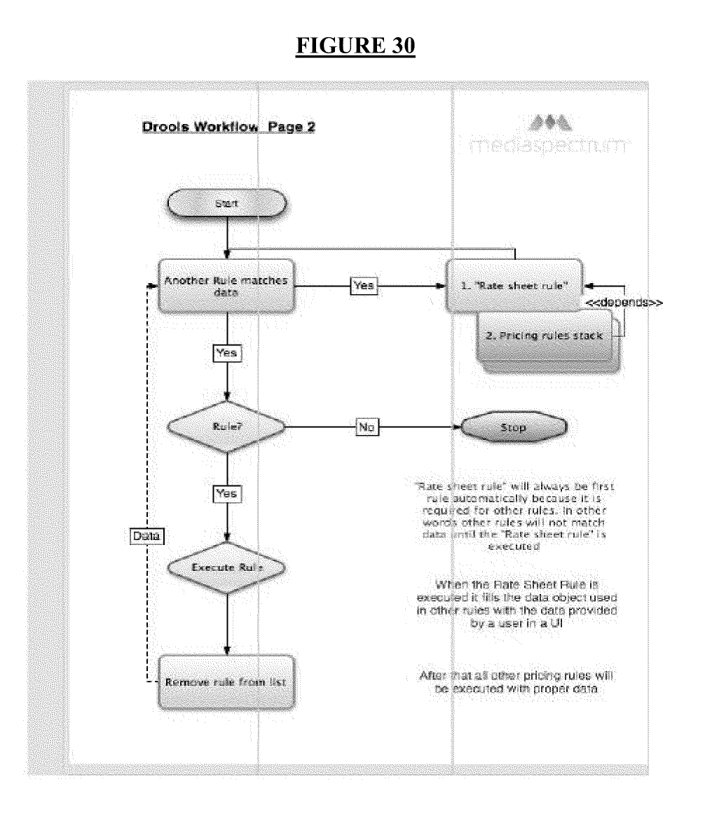

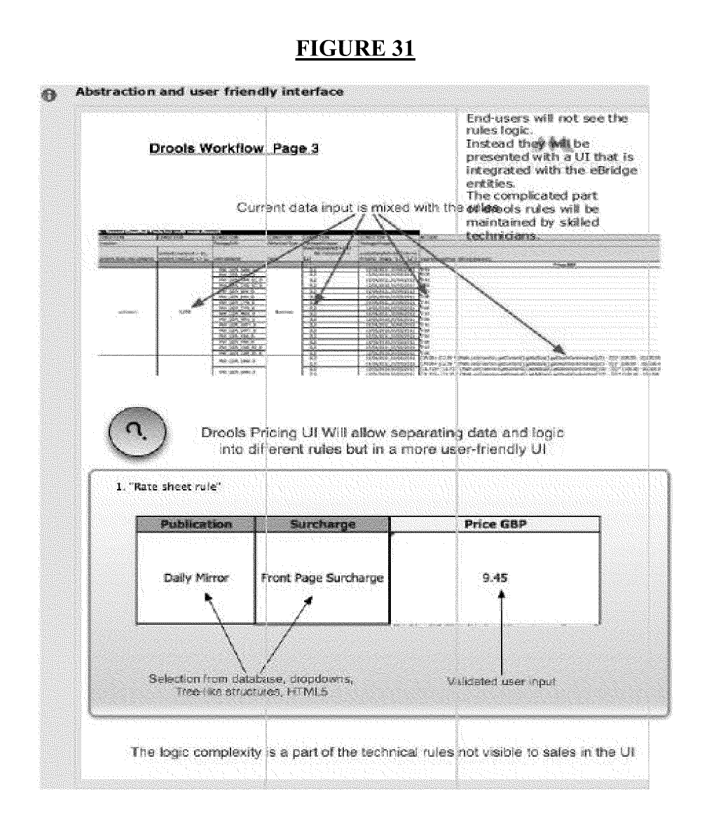

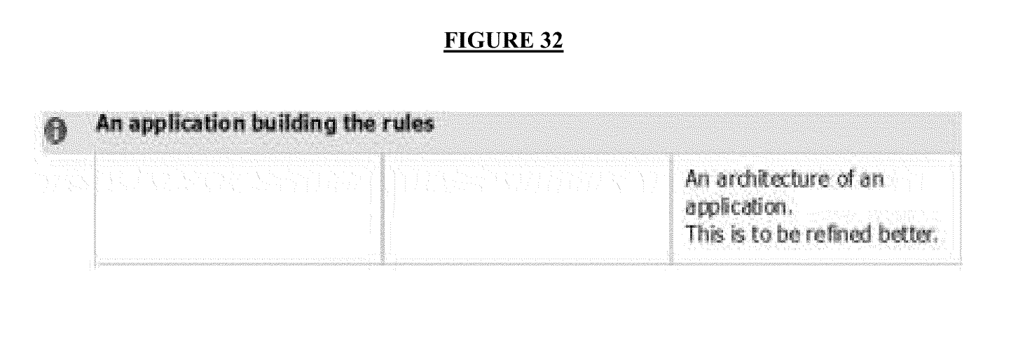

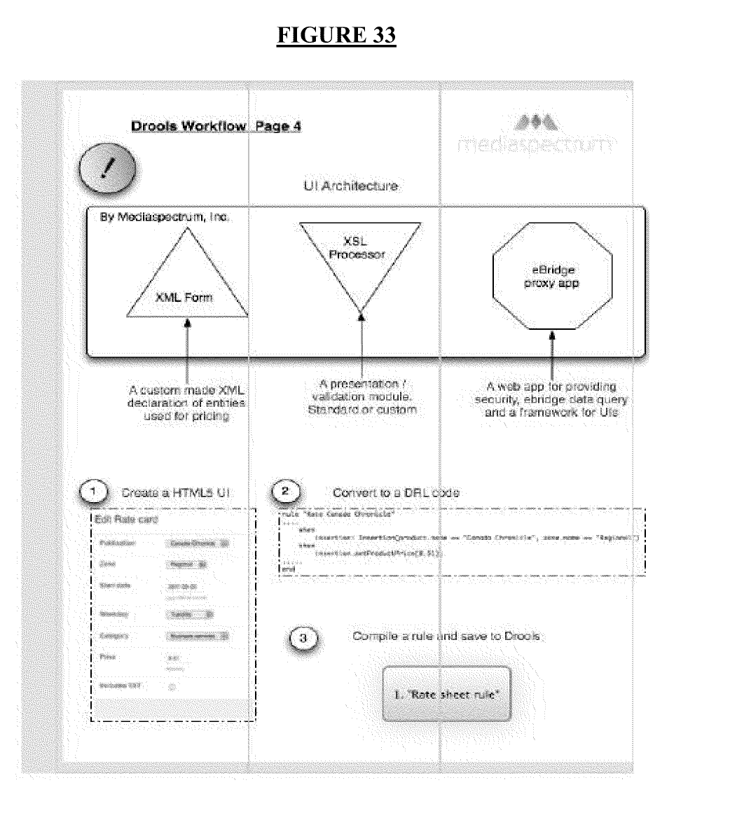

In an illustrative embodiment, instead of a “Rate Sheet” rule, parameters for rules are saved in a database. An exemplary Drools Workflow for a Drools pricing user interface application is illustrated in FIG. 27 through FIG. 33.

Example of Advertising Pricing and Packing

In an illustrative embodiment, presentation of the booking valuation is based on a number of requirements, employing preconfigured prerequisites, namely Publications, Packages and Rate Cards, etc., to create available Discounts and associated Surcharges.

Pricing

In an illustrative embodiment, all orders, both Print and Digital, are based on Rate card, or Contract rate; however, they may attract system, or user, generated surcharges or discounts, which may be either percentage or value-based, and applied at either the order or insertion level. Where a discount is applied it should be applied proportionately across all insertions unless an insertion has been rate protected (for example, by association to a product). In this instance the discount should be proportioned across the remaining non-protected insertions.

Rates
Basic Rate card rates can be set against one or more of the following:
Publication/Product;
Publication Edition/Zone (Regional or timed editions);
Publication/Product Date/Date Range;
Day of week (daily publications may have different rates for different days of the week);
Category;
Sub-Category; and
Individual Classification (Product-Date-Day of week-Category-Sub Category-Classification should be hierarchical, with the rate set at the lowest level being used to calculate the price);
Rate multipliers may be possible in one or more of the following methods:
Per Single Column Centimeter (display or semi-display advertising);
Per Line or per Word (lineage adverts);
Fixed price applicable to either display or lineage adverts;
Fixed values triggered in steps of advert size, greater than SCC;
Multipliers of a set amount (e.g., Digital/Web sales—cost-per-click, set value at £10 per 1000 clicks); and
Tiered based on set elements within a display booking, typically used in recruitment where the booking may contain multiple jobs being advertised;
Rates may have active dates (start and end dates) and these dates can be used in tandem with Rate Protection rules;
Rates can be defined against Customer Types, i.e., Agencies, Trade, etc.; and
Rates can be set as Rate Protected, in which case the rate will maintain its value irrespective of any applied discounts (see below for more detail).

### Example 1

### Order Ratecard Value=£600—Fixed Value Discount of £100

| | Rate Card | Protected from | Calculated | Value after |
|---|---|---|---|---|
| Product | Value | Discount (Y/N) | Discount | discount |
| A | £300 | N | £60 (£100 | £240 |
| | | | spread across | |
| | | | two insertions | |
| | | | totalling £500) | |
| B | £100 | Y | Protected, do | £100 |
| | | | not discount | |
| C | £200 | N | £40 (£100 | £160 |
| | | | spread across | |
| | | | two insertions | |
| | | | totalling £500) | |
| TOTAL | £600 | | £100 | £500 |

Discount applied proportionately across insertions allowing discount.

### Example 2

### Order Ratecard Value=£600—Discount of 25%

| | Rate Card | Protected from | Calculated | Value after |
|---|---|---|---|---|
| Product | Value | Discount (Y/N) | Discount | discount |
| A | £300 | N | £75 (proportion | £240 |
| | | | of 25% overall | |
| | | | discount) | |
| B | £100 | Y | Protected, do | £100 |
| | | | not discount | |
| C | £200 | N | £50 (proportion | £160 |
| | | | of 25% overall | |
| | | | discount) | |
| TOTAL | £600 | | £125 | £475 |

Discount applied proportionately across insertions allowing discount.

Rate Protection

In an illustrative embodiment, any bookings can be protected from a rate increase where the booking is entered before a rate increase is applied to the system, and it contains insertions that span the rate increase date, e.g., annual rate increase scheduled for January 1^{st}, a booking is made for a series of insertions with the 1^{st} insertion on December 20^{th} and last insertion on January 5^{th}.
1. It should be possible to Rate Protect a Customer Account, a Publication, or a Section within a publication;
2. Rate protection requires the pricing of a booking based on the rate at the time the ad was originally booked. Non rate protected bookings are priced using the rate at the time of publication;
3. A Booking as a whole can be Rate Protected—individual insertions may not be;
4. Manually priced orders may be rate protected during any period when a rate increase is applied, including bookings where a manual discount has been entered;
5. Once a booking has been saved, it may not be possible to add any insertions to a Rate Protected booking Existing insertions may be open to amendment or deletion, but no new insertions will be allowed—a new booking must be made in this case; and
6. There is no requirement to define a booking made after a rate review to use rates defined before the booking date. To accomplish this, a manual price or contract may be used.

Contracts

In an illustrative embodiment, contract rates are where a specific customer or group of customers have an agreed reduced rate. The contract for a customer should also be monitored and tracked, to enable reporting against the customer spend/volume within the contract. The contract volume/spend reporting will also be used to project performance against the contract, based on spend to date. Examples of specific contract details can include:
1. Contract templates should be allowed and then applied to one or many customers;
2. Each contract will have effective Start and End dates and the logic tree should include minimum and maximum advert size to trigger the contract;
3. A contract may have minimum and maximum value and volume set against it to make the contract rates valid;
4. Contract configuration should allow for a contract to be created against a customer, with the normal rating tree—i.e. Product-Date-Day of week-Category-Sub Category-Classification. Where a customer has a contract rate set up, that rate must be used when a booking is made that conforms to the configured contractual terms;
5. Contract rates may be configured in three ways:
   a. A discount off the default ratecard rate (or Package rate where applicable);
   b. An alternative SCC or Line rate; and
   c. A fixed price for the contract;
6. Contract Tracking;
   a. Should enable review of contract spend to date within the contract;
   b. Should enable projection of future performance, based on trend within the contract to date;
   c. Should enable re-rating of individual orders where an agreed minimum volume or value has not been achieved within the agreed period; and
   d. Where a shortfall in invoicing value has occurred as above, the system should provide functionality to invoice for the variance only, identifying that invoice as Contract Shortfall.

Pricing Method

In an illustrative embodiment, all surcharges may be applied non-cumulatively, against the rate price, then all discounts may be applied cumulatively in the following order—User, Series, Customer, and Agency:
1. Series and Contract discounts may be applied cumulatively against the Rate Price to calculate the Volume Price;
   a. Series discount, where a discount is offered based on a particular booking pattern, for example 5 insertions with 1 additional free insertion, set percentage discount for multiple publication/web package; and
   b. Contract discount, where a discount is applied to an account against all or selected publications or classifications, and based on customer spend or prior agreement (Note: The ability to configure Customer discounts is configurable at user level by system settings and privileges);
2. Any ‘discounted’ surcharge may then be calculated against the Volume Price to provide a User Value;
   a. Discounted percentage surcharges, typically Color and Position, are typically non-cumulative surcharges, and are calculated directly against the Volume price, to obtain the value for each surcharge;
3. Any ‘non-discounted’ surcharge may be calculated against the Rate Price and added to the User Value to provide the Insertion Value;
   a. Non-Discounted surcharges, typically PO Box charge, can be applied directly to the User Value. Where a percentage is used this is calculated against Rate Card. (Note: Non-Discounted surcharges are generally set as fixed value and not a percentage);
4. The user may apply a Manual discount against the Insertion Value, or against the total value of the order (if a Manual discount is applied then the system should reverse calculate the relative discounts and surcharges, using the above rules);
5. Agency, and Customer, discount may then be applied to the current running total to generate the net price for the Order; and
6. VAT is added to the net price to generate the Gross price for the Order

### Example 3

This scenario is for an insertion priced to rate card, where the rate card value for the insertion is £150, based on daily publication at £50, 2 weekly publications at £25 each, and a fixed digital upload at £50. The booking in this example has a color surcharge of 20%, a position surcharge of 10%, two 10% discounts (user/order and series), a Customer Discount of 15%, and an Agency Commission of 10%:

| Description | Amount | Total |
|---|---|---|
| Rate Price (1 daily, 2 weeklies & 1 digital upload) | £150 | £150 |
| Color Surcharge @ 20% | £30 | £180 |
| Position Surcharge @ 10% | £15 | £195 |
| Net price before discounts | | £195 |
| User/Order Discount @10% | £19.50 | £175.50 |
| Series Discount @ 10% | £17.55 | £157.95 |
| Customer Discount @ 15% | £23.69 | £134.26 |
| Agency Commission @ 10% | £13.43 | £120.83 |
| VAT @ 20.0% | £24.17 | £145.00 |
| Total Value | | £145.00 |

Discounts
1. Discounts can be applied at either total order value or individual insertions level;
2. Discounts can be configured as either percentage or set value;
3. Discount authority may be controlled by user/group security or permissions, and the system should provide multiple levels of user security/permissions; and
4. Discounted Orders/Insertions may be routed to delay queues.

Surcharges

In an illustrative embodiment, surcharges/additional charges may be applied for elements such as:
a. Bold words in an advert;
b. Adding a graphic (or more than one);
c. Including a border, or upgrading a border style;
d. Enhanced style of advert from basic styles;
e. Positional surcharge (guaranteeing a position in a Display advert); and
f. Color surcharge.

All of the above supplemental charges may be available at supplements per Product-Date-Day of week-Category-Sub Category-Classification as with the main rates. The supplements may be flat rates, percentage or increase in SCC, or line charge.

Variable Agency Commission

In an illustrative embodiment, there may be different Agency Commission rates for each different product. This would mean that Agency Commissions and all other discounts would be applied at insertion level and summarized on invoicing. Taking the products in the example above:

| | |
|---|---|
| Daily publication | £50 |
| Weekly publication 1 | £25 |
| Weekly publication 2 | £25 |
| Digital upload | £50 |

For each insertion the calculation below would be made:

| Description | Amount | Total |
|---|---|---|
| Rate Price - daily publication | £50 | |
| Color Surcharge @ 20% | £10 | £60 |
| Position Surcharge @ 10% | £5 | £65 |
| Net price before discounts | £65 | £65 |
| User/Order Discount @ 10% | £6.50 | £58.50 |
| Series Discount @ 10% | £5.85 | £52.65 |
| Customer Discount @ 15% | £7.90 | 44.75 |
| Agency Commission @ 10% | £4.48 | 40.27 |
| (or override from product) | | |
| VAT @ 17.5% | £7.05 | 47.32 |
| Total Value for this insertion | | £47.32 |

The above calculation should be made for each insertion and then summarized to give the total order value:
1. Each customer should be assigned an approved default Agency Commission rate;
2. Each product may be set with an “Override Agency Commission” rate; and
3. Where Agency Commission is payable and the override rate is different (higher or lower) than the Customer default, the override rate should be used for any insertions in that product.

Amends and Cancellations

In an illustrative embodiment, at least two specific scenarios should be covered when amending or cancelling an order:
1. Where an order has been priced with a “fixed value” across the whole order, if the insertion pattern changes, the values would be re-apportioned across the remaining insertions according to the above rules. Where this happens, there are two scenarios to accommodate:
   a. If there are still insertions left and the value is simply being re-apportioned, a warning should appear to advise the user that they are changing the value on the insertions as the order has an overall fixed price; and
   b. If there are no insertions left after the amend and all other insertion values are “locked,” the user must be warned and prevented from saving the order, until they have corrected the Fixed price. The system should calculate and show the user the fixed price they must apply, based on the sum of the insertions remaining

Insertion Value Locking—and Production Deadline

In an illustrative embodiment, the system supports two levels of deadline:
1. The Booking Deadline, after which only users with “Booking Deadline Override” privilege can change an insertion; and
2. The Production Deadline. The function of this deadline is to prevent any further changes to the insertion at all by any user and to lock the value of the insertion so no future amends can change it. This will be set at the time when the publication goes to press, or another form of sale is delivered and can not be changed. After this time any changes must be made by crediting the value, but the content and value of the insertion must not alter.

The booking deadlines may be ahead of the production deadlines—the time difference between them will vary according to product (shorter time on a daily than weekly print product, for example). Between the booking and production deadlines, changes to the content (e.g., proof corrections) will regularly occur. Late Bookings may only be allowed by users granted the privilege.

Packages

In an illustrative embodiment, techniques may be employed to consolidate and link products, both print and online, into packages to help automate the booking process, apply predefined pricing rules, and reduce user time scheduling bookings Packages are typically based on a Primary product, with associated support products, both print and digital, and may contain fixed day first insertion rules. They should be able to provide upsell options where additional publications or digital products can be selected and included, and they should offer pricing options, such as discounts against set rules per individual publication/products.

Series Discounts

In an illustrative embodiment, series discounts are based on a number of insertions in the same publication, or combined across a number of publications/digital uploads configured as a package. The discount can be applied to any or all insertions within the package, and also at any time within the run. Therefore, insertion-based packages are required. A configured discount may range from 1-100%, may be applied against one or more insertions or publications, including digital uploads, within the run, and is activated by the use of a package code, (as opposed to a publication code). Typically the user selects the package code in order for the system to apply the relevant discount. However, the system also has the ‘intelligence’ to automatically recognize elements of a package, and apply the relevant package code if the user selects all the elements of a package without initially entering the package code. Package discounts are reliant on the integrity of the package, therefore, if any insertion within the package is cancelled then all remaining insertions must either be cancelled or have full rate card applied.

Individual Series Booking

Package A (3+1 Free)—Example 4

In this example, Package A is a single publication package with 4 insertions. The first 3 insertions are rated at £10.00 each, followed by the 4^{th} insertions rated zero. The total value of the package is £30.00. Note: insertions may run on consecutive or non-consecutive days:

### Example 4

| | | | | | | |
|---|---|---|---|---|---|---|
| Package A | Mon | Tues | Wed | Thurs | Fri | Sat |

| | | | | |
|---|---|---|---|---|
| One title | Ins 1 | Ins 2 | Ins 3 | Ins 4 |
| 3 + 1 FREE | Paid for | Paid for | Paid for | FREE |
| | £10 | £10 | £10 | |

Multiple Series Bookings.

Package B—6 Nights (4 Paid+2 Free) selected 3 times—Example 5

In an illustrative embodiment, individual Package bookings can span multiple weeks, and may be selected multiple times within a booking To ensure insertions can be cancelled in one package instance without affecting insertions in additional package instance, each package may be configured in a way that allows the individual insertions to be linked to each separate instance of the package.

For example Package B, Example 5, is a single publication package with 6 insertions Monday to Saturday, the first 4 insertions are charged at rate card with insertion 5 & 6 Free. It has no fixed first day insertion rule; therefore, the package start date can be booked for any day. In this example the first insertion is booked for a Wednesday, so the booking will span 2 weeks. If the package is selected 2 more times to run consecutively, then the booking will span 4 weeks with weeks 2 and 3 containing multiple instances of the package. So, in weeks 2 and 3 it must be possible to differentiate between Insertions 5 and 6 of one package and insertions 1 to 4 of the next package, to ensure a cancellation of an insertion in one package does not adversely affect the insertions in the other package. If the user cancels the Friday insertion of week 2, then the Saturday, Ins4 wk2; Monday, Ins5 wk2; and Tuesday, Ins6 wk2; insertions must revert to full rate card or be cancelled. However, the insertions in Package B instance week 1 and 3 will not be affected.

### Example 5

| Package B | Mon | Tues | Wed | Thur | Fri | Sat |
|---|---|---|---|---|---|---|
| Single title | | | Ins 1 | Ins 2 wk 1 | Ins 3 | Ins 4 |
| | | | wk 1 | Paid for | wk 1 | wk 1 |
| | | | Paid for | | Paid for | Paid for |
| | Ins 5 | Ins 6 | Ins 1 | Ins 2 wk 2 | Ins 3 | Ins 4 |
| | wk 1 | wk 1 | wk 2 | Paid for | wk 2 | wk 2 |
| | FREE | FREE | Paid for | | Paid for | Paid for |
| | Ins 5 | Ins 6 | Ins 1 | Ins 2 wk 3 | Ins 3 | Ins 4 |
| | wk 2 | wk 2 | wk 3 | Paid for | wk 3 | wk 3 |
| | FREE | FREE | Paid for | | Paid for | Paid for |
| | Ins 5 | Ins 6 | | | | |
| | wk 3 | wk 3 | | | | |
| | FREE | FREE | | | | |

Fixed Price Package.

In an illustrative embodiment, fixed price packages are defined as a series of insertions where the total charge is attached to the first insertion, and the remaining insertions within the package instance are all discounted at 100%. Note: These are typically used in Private bookings where no discount is offered after the first insertion.

### Example 6

### Package C—3 Night Fixed Package Price

The objective is to collect the full charge for the booking even if the order is cancelled midrun. Therefore, the total revenue will be collected on the first insertion so that any subsequent insertions can be cancelled without affecting the charge for the package, i.e., 100% revenue collected on the first insertion (even if multi-titles) and all subsequent insertions/titles are FREE and reported as volume with no revenue attachment.

| | | | | | | |
|---|---|---|---|---|---|---|
| Package C | Mon | Tues | Wed | Thur | Fri | Sat |

| | | | |
|---|---|---|---|
| One title | Ins 1 | Ins 2 | Ins 3 |
| 1 + 2 FREE | Paid for | Free | Free |
| | £30 | | |

Fixed Day and Primary Publication

In an illustrative embodiment, the start dates may be configured as either fixed or flexible, based on deadlines and package rules, or selected manually by the user, and a publication or digital upload in a package may be defined as the Primary element.

### Example 7

### Package C—Primary Publication with Fixed Day

In this example, a Private Motors Package consisting of a daily title, two weekly titles, and a digital upload, the daily title is set as the Primary element and is configured with the first publication insertion day as Wednesday. Weekly Title A is published on a Tuesday and Weekly Title B on a Thursday, and the digital upload runs for 7 days. If the booking is created on a Monday the sequence would be Daily Title and Digital upload on Wednesday, Weekly Title B on Thursday and Weekly Title A the following Tuesday.

| | Mon | Tue | Wed | Thu | Fri | Sat | Sun | Mon | Tue | Wed |
|---|---|---|---|---|---|---|---|---|---|---|
| Booked | □ | | | | | | | | | |
| Daily | | | □ | | | | | | | |
| Weekly A | | | | | | | | | □ | |
| Weekly B | | | | □ | | | | | | |
| Digital | | | □ | □ | □ | □ | □ | □ | □ | |

General Notes for Packages
1. It is possible to define a mixture of publications, zones, and digital product combinations, together with their valid publication days within a package, and to define the quantity of insertions against each publication, zone, and digital product combination within the package;
2. If a user cancels any paid for insertion within a package, other than a pick n mix package, any remaining paid for or free insertions will be charged at full rate card. All prior insertions that are billed or closed remain at the price originally quoted, i.e., “locked;”
3. It is possible to define a publication as the Primary publication within the package, and no other publication within the package can be published before the Primary publication, irrespective of booking date or day;
4. It is possible to define a specific day as the Primary publication day. This will force the first publication to appear on the Primary day irrespective of when the booking was made;
5. Packages should default to a ‘price protected’ status, but it is possible to configure the package to enable a manual price override;
6. It is possible to configure ‘Pick and Mix’ packages. This allows the user to book a package and then remove insertions without affecting the price of the remaining insertions;
7. It is possible to add insertions to a booking that contains a package, without affecting the price of the package. The price of the booking will increase according to the rate price of the additional insertions;
8. It is possible to copy bookings that contain packages; and
9. It is possible to configure packages to provide a discounted rate on renewal.

Amended Booking

In an illustrative embodiment, when a booking is amended with the addition or subtraction of insertions or detail change, there are a number of options open to the user:

Option One—Non-Discounted Bookings Removing Insertions

In the event of a removal of one or more insertions, pricing should be retained as per the original booking, i.e., any insertion that was priced and the deadline is still open will be refunded and any insertion that has no cost attached, and the deadline still open, can be cancelled and will not be refunded.

Option Two—Non-Discounted Bookings Additional Insertions

Additional insertions will be charged at full rate value, unless they are added as part of a complete package.

Option Three—Discounted Bookings

If a package booking has started its run but has multiple insertions still to appear, the user can cancel one or more insertions. The system will set the cancelled insertions to Non-Publishable and remove any discount associated with the associated package. The value of billed or closed insertions will remain fixed, or “locked.”

Digital Ad Booking

The system facilitates the booking of Web-only products. Digital ‘add ons’ and/or Web product sales bookable with print products are available stand-alone or as part of a package. Feeds to online systems using may be facilitated. Various digital pricing options may be supported including:
Cost per Click;
Cost per Thousand;
Cost per Action;
Backfill (Fixed price booking after the event);
Fixed Price; and
Cost for agreed volume, with end date once reached.

Web type bookings will typically be made in three main formats, but other formats may be used:
Time Framed, Cost per—System to create one insertion for the end of each month from first month within the time frame to one month after time frame completes. Initial booking method to define rate per “x” clicks, acquisitions, etc. Data from Content Management system to be imported back to each booking monthly (linked using Booking reference), for calculation of each month's invoice value—e.g., Cost Per Click=£10 per 1000 clicks; Monthly Clicks=12,000; and Monthly Value for Invoice=£120;
Fixed Price—Set a fixed duration and fixed price for the insertion. This should be manually entered, or via a lookup matrix along the lines of the Product-Date-Day of week-Category-Sub Category-Classification method outlined above; and
Fixed Click/Acquisition Count and Fixed Value—Set Start Date for the booking and record number of clicks/acquisitions to charge for Rate lookup for Product-Date-Day of week-Category-Sub Category-Classification method outlined above and rate to be multiplied by number of clicks/acquisitions entered. System to create one insertion for the end of the first month that the booking starts. Value calculated as above and a single invoice created. Content Management systems manage the content to come off the site when number of clicks/acquisitions is reached. The end date may be fed back into the booking system for reference.

A feed file may be received from Digital Content Management systems to update bookings, generate insertions, and trigger invoicing. Price Surcharge and Discount Mechanism Explanation, Example:
1. The order value will be applied proportionally across all insertions (except where one or more titles have “protected” rates);
2. The system should be configurable by Publication, Category, or Classification to allow manual pricing at individual insertion level. Where an insertion is manually priced, the value of the remaining insertions will not be affected;
   a. Only users with the relevant, configurable, privileges will be able to invoke pricing at insertion level; and
3. It should be possible to protect individual insertions against order discount. Specifically this will be required for digital uploads, but publications, categories, and classifications should be configurable to enable exclusion from order discount. For example, a booking is taken that includes:

| | |
|---|---|
| daily publication | £50; |
| 2 weekly publications | £25 each; and |
| digital upload | £50; |

The total value of the booking is £150.00, and the digital publication is protected against discount. The user enters a manual order price of £120.00; the system should apportion the value as:

| | |
|---|---|
| daily publication | £35; |
| 2 weekly publications | £17.5 each; and |
| digital upload | £50; |

4. User/Order discount can be manually entered as either a fixed value or a percentage of the rate price.
   a. If the manual override is a set order value, e.g., £120 for a complete order, this will equate to the net charge of the booking, i.e., the manual order value should be the net value of the booking excluding VAT and agency commission only;
   b. The user can enter a fixed amount discount, e.g., £10, against the booking, the system will apply the discount to the net value of the booking excluding VAT and agency commission only; and
   c. If the manual override is a percentage discount, e.g., 10%, this will be applied to the booking and applied at the Rate price, with all subsequent discounts and surcharges being affected accordingly;
5. It is possible to amend insertions after the publication deadline has passed;
6. All discount and surcharge amount may be visible within the price explanation screen;
7. Agency Commission should be visible as a percentage within the customer record details; and
8. There may be a field in the price explanation screen to display the percentage discount applied before Customer/Contract discount and Agency Commission.

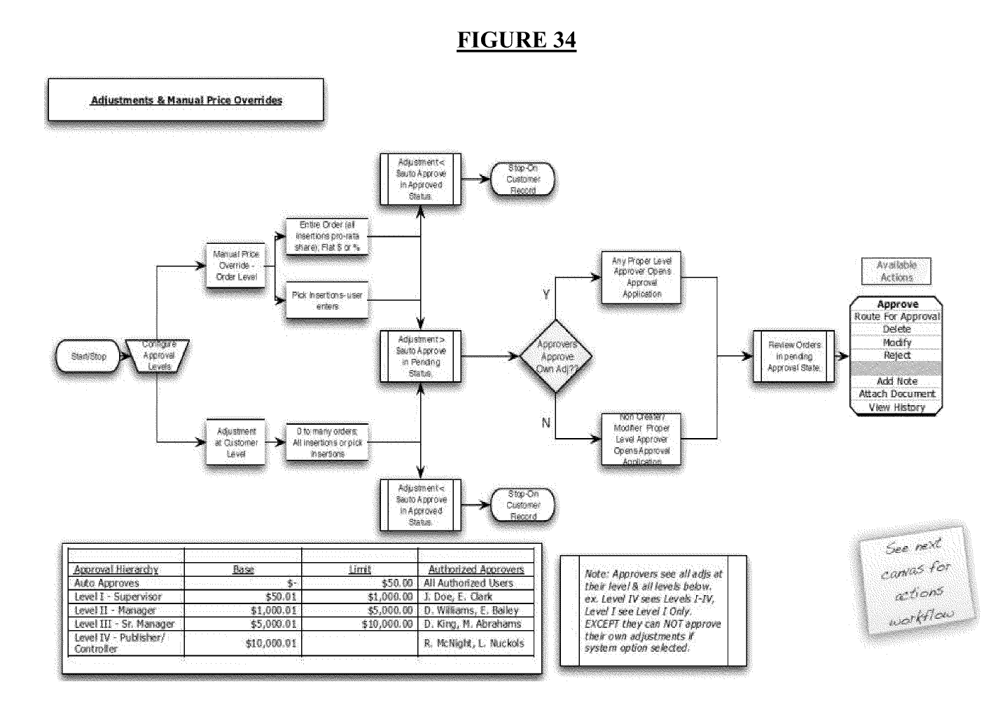

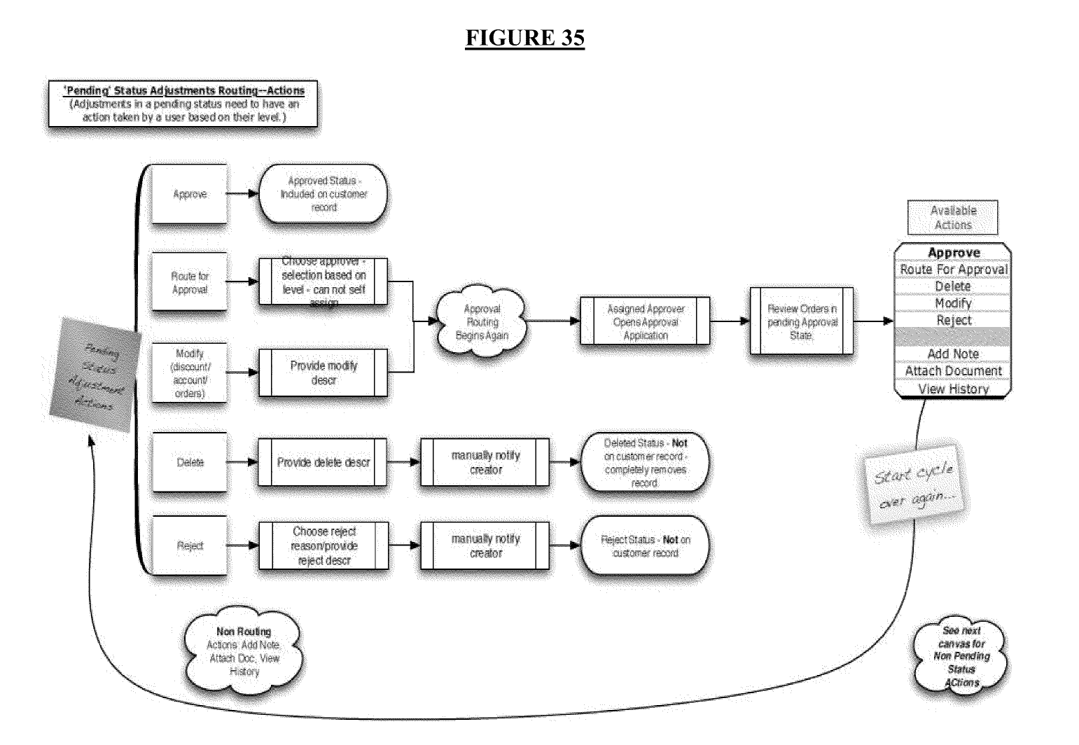

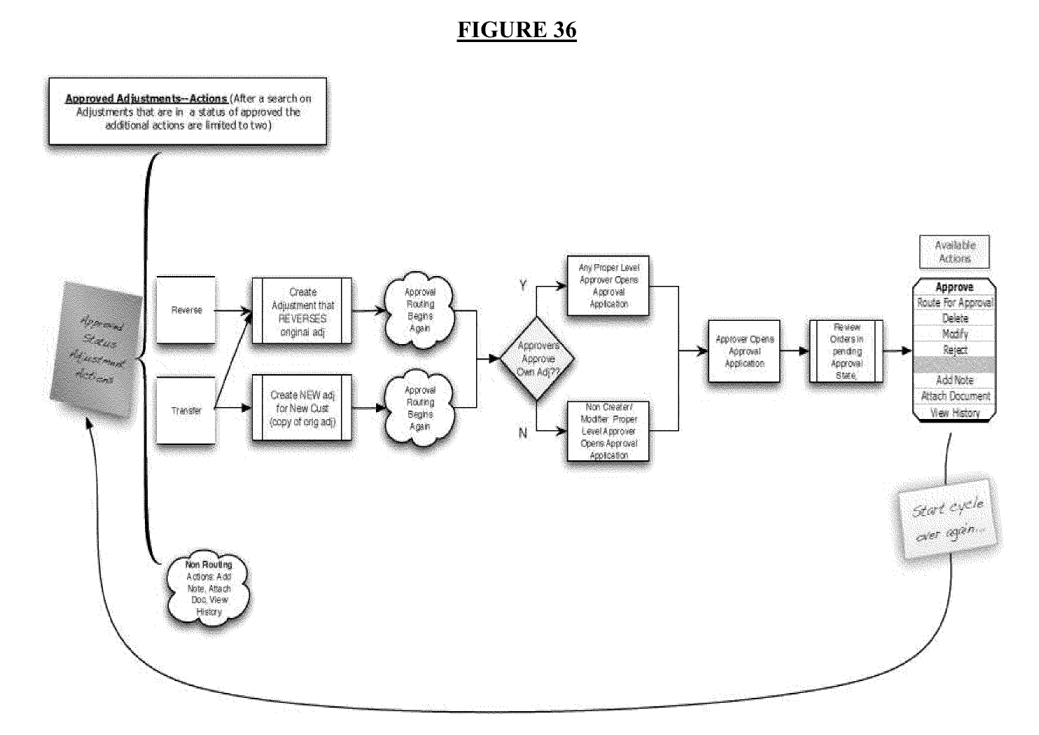

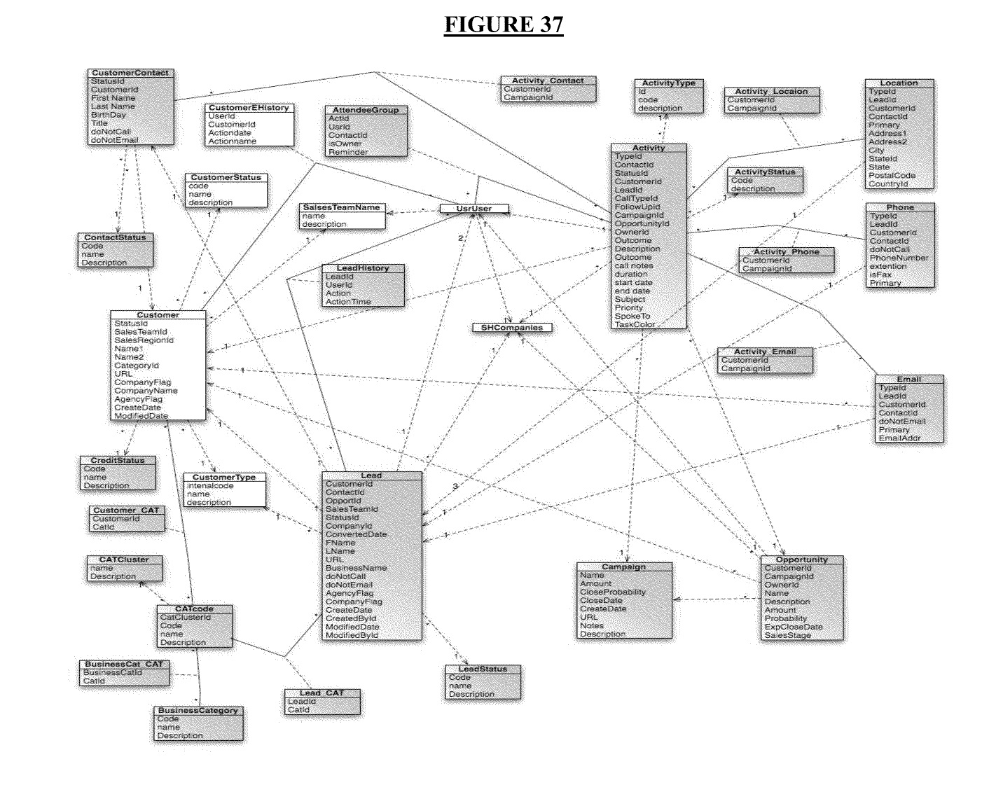

In an illustrative embodiment, a workflow diagram of adjustments and manual price overrides, and approvals is illustrated in FIG. 34 through FIG. 36. In an illustrative embodiment, the platform includes a database structure and logical scheme as illustrated in FIG. 37. to FIG. 37, details of the entities illustrated are described below:

Activity

Describes the main CRM entity Activity (or task);

FollowUpId—FK to Activity (to support follow up activities chain);

TypeId—FK to ActivityType (e.g., meeting, call, etc.);

CallTypeId—FK to CallType (e.g., phone call, email, etc.)—Not Used;

ContactId—FK to Contact;

StatusId—FK to LeadStatus;

AssignedId—FK to SalesUser;

CampaignId—FK to Campaign;

CustomerId—FK to Customer;

LeadId—FK to Lead;

OpportunityId—FK to Opportunity;

OwnerId—FK to UsrUsers;

Outcome—Text value. Describes with what status task is closed (Successes, Need to analyze, etc.);

Description—Text description of the activity details;

SpokeTo—Person with whom spoke;

Call Notes—Text notes of the details of the call;

Duration—Amount of time between today and Start Date (i.e., Start date—today);

Start date—Start date of the activity;

End date—End date of the activity;

Subject—Short description of the activity intend;

Priority—Priority of the activity; and

Task Color—User specified color for the activity.

Customer

Describes Customer information;

SalesTeamId—FK to SalesTeamName (Which is responsible for that customer);

SalesRegionId—______;

StatusId—FK to CustomerStatus;

TypeId—FK to CustomerType;

CompanyFlag—Shows is it Person or Company;

URL—web address of the company site;

Name1, Name2—Name of the Customer if it is private person;

CategoryId—______;

AgencyFlag—Shows if Customer is an Agency;

CreateDate—Date of record creation;

ModifiedDate—Date of record modification; and

CompanyName—Name of a company if it is not private customer.

CustomerType

Describes Customer types—trade/private.

Lead

Describes Lead information;

SalesTeamId—FK to SalesTeamName (Which is responsible for that customer);

CustomerId—FK to Customer. Shows relation if Lead was converted to a Customer;

ContactId—FK to CustomerContact;

OpportunityId—FK to Opportunity;

StatusId—FK to LeadStatus;

TypeId—FK to CustomerType (Private/Trade);

ConvertedDate—Date, time of conversion;

CompanyFlag—Shows is it Person or Company;

CompanyId—______,

doNotCall—Shows if it is restricted to contact by Phone;

doNotEmail—Shows if it is restricted to contact by Email;

URL—Web address of the company site;

FName, LName—First name and Last name of a Lead contact person;

AgencyFlag—Shows if Customer is an Agency;

CreateDate—Date of record creation;

CreatedById—FK to UsrUsers;

ModifiedDate—Date of record modification;

ModifiedById—FK to UsrUsers; and

BusinessName—Name of a company if it is not private customer.

CreditStatus

Stores information about credit status of a Customer—Good, Bad, CashWO, Unknown.

LeadHistory

Stores application specific events for Lead and UsrUser objects (Actually changes of Lead related objects made by User);

UserId—FK to UsrUsers;

LeadId—FK to Lead;

Action—Action name; and

ActionTime—______.

CustomerEHistory

Stores application specific events for Customer and UsrUser objects (Actually changes of Customer related objects made by User);

UserId—FK to UsrUsers;

CustomerId—FK to Customer;

Actionname—Action name; and

Actiondate—______.

Sales Division

In Physical DB—“Shcompanies”

Describes Sales structure Unit—“Division” (each Customer should be assigned to a single Division).

CustomerContact

Describes Customer contact information;

StatusId—FK to ContactStatus;

CustomerId—FK to Customer;

First Name, Last Name—First name and Last name of Customer;

BirthDay—Birthday of Customer;

Title—Job title of Customer;

doNotCall—Shows if it is restricted to contact by Phone;

doNotEmail—Shows if it is restricted to contact by Email.

SHCompanies

Stores information on a geographical and organizational unit to which User belongs.

UsrUsers

Describes Sales users information;

TeamId—FK to SalesTeamName; and

CompanyId—FK to Company.

Campaign

Describes Campaign entity;

Name—Name of the Campaign;

Notes—Text notes for Campaign;

Description—Text description of the Campaign details;

URL—Web address of the Campaign site;

Amount—Float: Prospected Amount value;

CloseDate—Prospected Date of closing;

Probability—Float: Success probability for the campaign; and

Created—Date of creation.

AttendeeGroup

Describes “attendee” relation between Activities and Sales users. That is what users participate in what activities;

ActId—FK to Activity;

UsrId—FK to UsrUsers;

ContactId—FK to User Contact;

IsOwner—Whether User the Owner; and

Reminder—Reminder(s) for Users.

Activity_Location, Activity_Phone, Activity_Email, Activity_Contact

Describe many-to-many relations between Activity and Location/Phone/Email/Contact. E.g., single contact may have multiple locations, emails, phones, and in the same time linked to some activity. Also activity can have multiple contacts linked.

Email, Phone, Location

Data describing phone, emai,l and location (address) where records stored.

Opportunity

Describes sales Opportunity details;

CustomerId—FK to Customer;

CampaignId—FK to Campaign;

OwnerId—FK to UsrUsers;

Name—Name of the Opportunity;

Description—Text description of the opportunity details;

Amount—Expected amount to gain;

Probability—Probability of the success (gaining specified amount);

ExpCloseDate—Expected date of closing an opportunity; and

SalesStage—Short text description of stage of a sale.

CATCluster

Describes CAT Cluster types (see above “Definitions” section);

Name—Short name; and

Description—Text description of CAT Cluster.

CATCode

Describes CAT codes (see above “Definitions” section);

Code—______;

Name—______;

Description—______; and

CatClusterId—FK to CATCluster.

BusinessCategory

Stores description of External category scheme for external data source (typically “Experian”). It is used to define CAT category for imported Customer/Lead data.

BusinessCat_CAT, Lead_CAT, Customer_CAT

Defines many-to-many relation for CAT code and Customer/Lead, BusinessCategory.

Company

Describes company level for CRM organization hierarchy;

Name—Short name; and

Description—Text description.

Team_Campaign

When Activity associated with Campaign and assigned to Sales Team is saved, this relation is saved in the table. If a relation already exists, it is not saved (for example, if save another activity for the same Sales Team and Campaign). (Note: Single team can be in multiple Campaigns, and single Campaign can relate to multiple Teams).

CustomerCreditInformation

Extended description of Customer credit status.

SalesRegionName

Zone assigned to account which adds middle-grained geographical description (City<Zone<Country).

### Use Cases

### Use Case 004—Approvals

1. Basic Information

| Use Case ID | 004 |
|---|---|
| Description | This Use Case describes the requirements for the approvals |
| | section. |
| Primary | Booking Agent |
| Actor(s) | Sales Rep |
| | Credit Rep |
| Successful | User is able to view, sort, and approve relevant approvals |
| Post | with the least steps necessary. It is the business's goal to |
| Conditions | manage approvals from one main screen, instead of |
| | needing to enter each approval individually. |
| Performance | Each click should take less than a few seconds to respond, |
| | depending on the complexity of the click. |

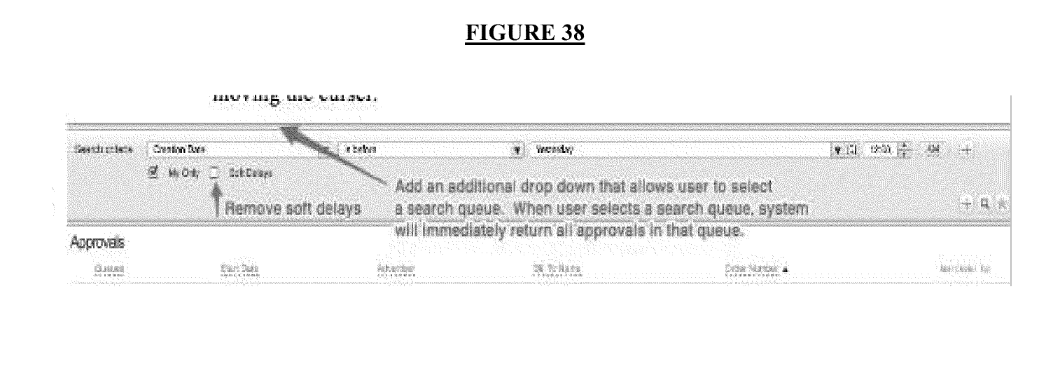

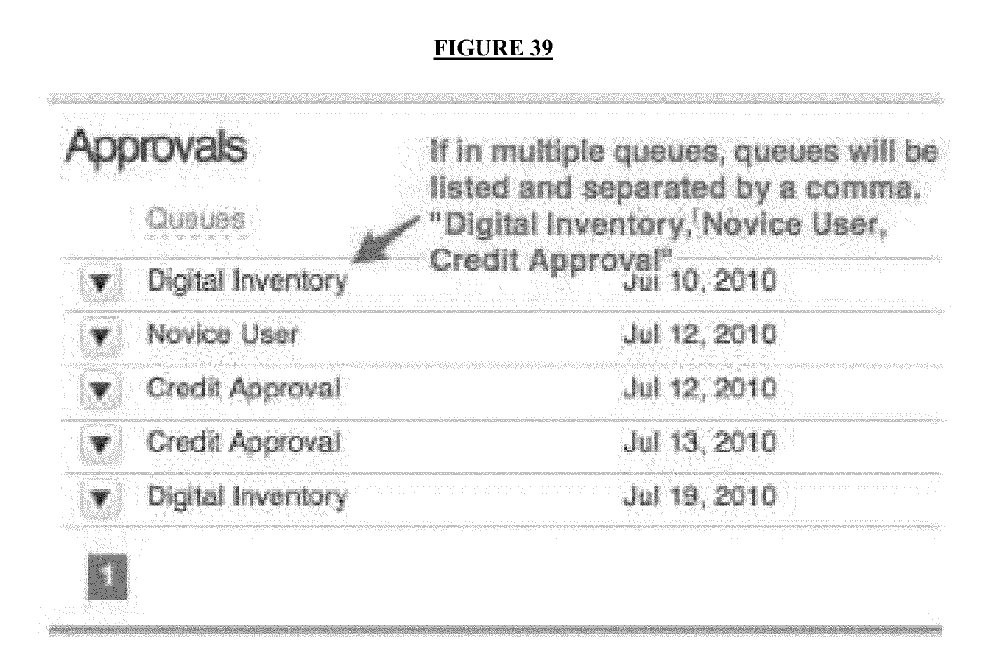

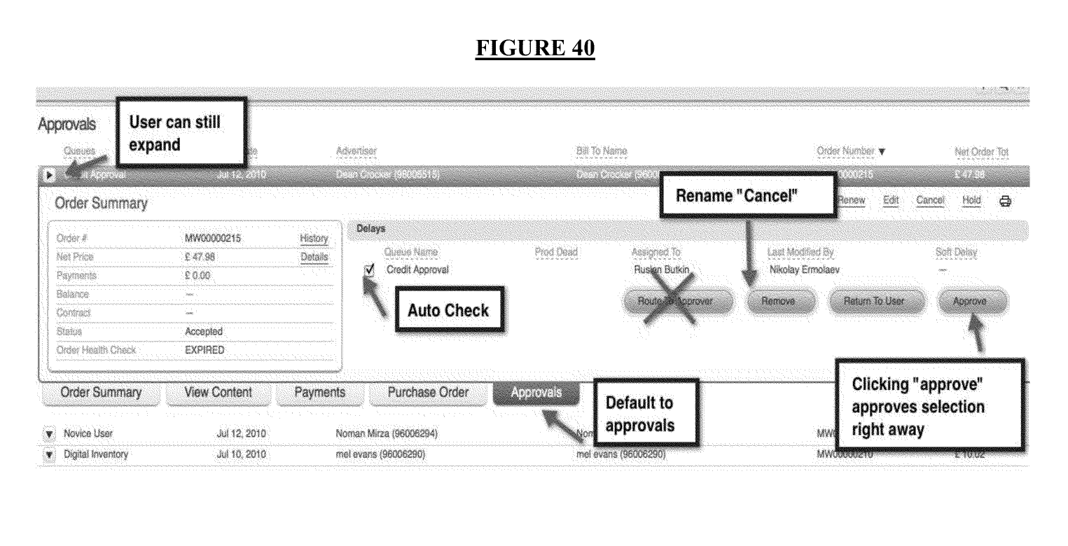

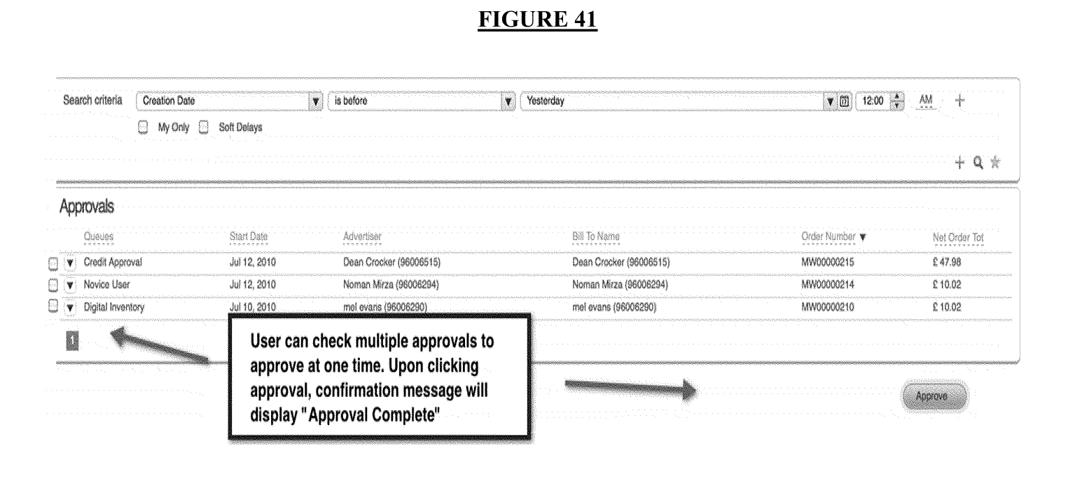

1.1 Approval Queue Flow Changes
1. Approval Queues can be managed through configuration
   a. Approval queues can be managed by the business through configuration. Although there is currently a set list of approval queues (see definition sections 1.2), the business may wish to add an additional approval queue in the future;
   b. Approval queues can be divided into groups. Each approval queue may be assigned to a particular group (such as either sales or finance);
      i. Based on a users logon criteria, the user will be given permissions to approve a certain list of queues based on what group to which he belongs; and
      ii. Group setup can be managed by business through configuration;
2. User executes a search within the approvals section
   a. When the user first navigates to the approvals section, the user may not see any approvals in the search results right away;
   b. The user will see an additional search criteria drop down that is displayed above the existing drop downs. This drop down will be titled “Queue” and when selected, the user will see a selection of all the approval queues (see section 2.2 for approval definitions);
      i. The user will only see approval queues in his grouping. For example, if the user is in Finance group, the user will only see the queue the Finance group to which the user has access. This access will be defined through configuration; and
      ii. When the user selects a queue from the drop down, all approvals within that queue will immediately display without the need for the user to enter additional search criteria or select enter. The user can also multi-select queues by selecting shift and moving the curser, as illustrated in FIG. 38;
   c. “My Only” may be renamed “My Approvals.” When the user selects “My Approvals” the user will be returned approvals within the user's search criteria that are within the user's group's access and specifically in the user's section;
      i. My Approvals includes any order that lists the logged in user as the credit rep (if in the Finance group) or sales rep (if in the Sales group);
   d. Credit Rep may be added to the search criteria drop down so a user can look up the approvals belonging to a different credit rep;
   e. Sales Rep may be added to the search criteria drop down so a user can look up the approvals belonging to a specific sales rep;
3. Users will only be able to make approvals for queues his assigned group has access;
   a. Users can make approvals for orders within a queue to which the user's group is assigned;
      i. User can make approvals for orders assigned to a different credit or sales rep, as long as the order is within a queue to which the user has access;
4. Approvals can be in multiple approval queues;
   If an approval is in multiple queues within a group, the user will see all the queues in which it is currently positioned. Queues may be listed out, divided by a comma, as illustrated in FIG. 39;
   a. The user will not see the queue if it is in a queue belonging to a different group;
      i. For example, if one order were in the finance queues of credit limit and credit status and also the sales queues of a novice user and unverified address, a finance user would only see the finance queues of “credit limit” and “credit status;” and
      ii. Once the credit rep makes the approvals within his queue, he will no longer see that order in his approvals section. However, a sales user would still see the pending approvals for “novice user” and ‘unverified address;” and
5. The user needs the ability to make many approvals in the least steps possible, but still be able to view detail;
   a. Approval checkbox will display next to the arrow drop down so the user can either tick multiple approvals or choose to expand the approval to view details;
   b. When a user expands an approval, the page will default to the approval section, with the order checked;
   c. “Route to Approver” will not display, since if the user can see the approval in the search results essentially means he is the approver;
   d. “Remove’ will be renamed “cancel.” Selecting cancel will cancel the insertion/order selected;
   “Approve” will approve the order right away and not require the user to select any more approval buttons. It will then no longer display that specific approval queue; and
   e. The user can select multiple approvals at once and approve them altogether by selecting the approve button at the bottom of the page, as illustrated in the FIG. 40 Mockup of Expanded View and in the FIG. 41 Mockup of Collapsed View.

1.2 Approval Queue Definitions
Awaiting payment—Customer is flagged as must prepay, compare cost of the ad against the payment received—any difference (tolerance allowed in config. 50p) the ad is put into approval or first ad for a new customer and cost is under £100 inc VAT;
Awaiting payment soft—Ad has been moved manually from awaiting payment;
Credit limit—Assess current booking against credit limit criteria—credit limit from customer plus any un-invoiced ads plus balance;
Credit status—Customer status—status will be 0-7. These statuses will have a configuration against them to denote which of these 0-7 statuses has the following 3 conditions attached to them—book the ad, book the ad and credit fail, and can't book an ad;
New Trade—First ad booked on the system for new customer ad is between £100-£250 inc VAT, then the ad is processed without issues. If the first ad cost is over 250, then the ad booking fails and the ad is statused in the approval queue as a New Trade;
High Risk—New ad for a new customer booked against high risk classifications. In configuration, business must be able to set what classification is high risk (example, home services—roofers);
Unauthorized Card—Credit card payment has been attempted and payment has not been authorized by the card merchant;
Credit Card Auth Error—No response from the card merchant;
Purchase Order Number—Customer is set up to require purchase order numbers—ad has been booked without a purchase order number;
Novice User—Salesperson is flagged as novice user—any ads booked by the novice user. This is set through configuration. Manager determines when user should be unchecked as a novice user;
Unverified Address—Customer address has not been verified by PAF (Postcode Address File) software;
Free Ad Approval—Ad is 0.00 price;
Sensitive Copy—All BMD (Births Marriages and Deaths) category ads are scrutinized, specific classifications can be optionally sent for approval;
Order Discount 50-100%—Order discount % is between 50-100%; and
Low Yield—Yield calculation per insertion—cost of insertion divided by size to determine the yield. Low yield is defined as minimum yield acceptable for a category. This is set through configuration.

1.3. Additional Info

If an ad has been approved and is amended, it should only go back into approvals if there has been a material change (price change or size change). All actions concerned with approvals, the ad going into approval and being released from approval should be logged on the history of the ad. Approval queues can be hard delays (ad is not publishable) or soft delays (ad is publishable). Approvals can be configurable down to category level and sales team.

### Use Case 006—Data Feeds AdWatch™

### 1. Basic Information

| Use Case ID | 006 |
|---|---|
| Description | This Use Case describes the features for the sales |
| | component integration with AdWatch. It explains how the |
| | data feed from the sales component to AdWatch will |
| | improve the user experience |
| Primary | Booking Agent |
| Actor(s) | Sales Rep |
| Successful | Data entered in the sales component will be sent to |
| Post | AdWatch |
| Conditions | The user can book an ad without content if the production |
| | method is AdWatch |
| Performance | Each click should take less than a few seconds to respond, |
| | depending on the complexity of the click. |

### 2. Flow of Execution

### 2.1 Basic Workflow

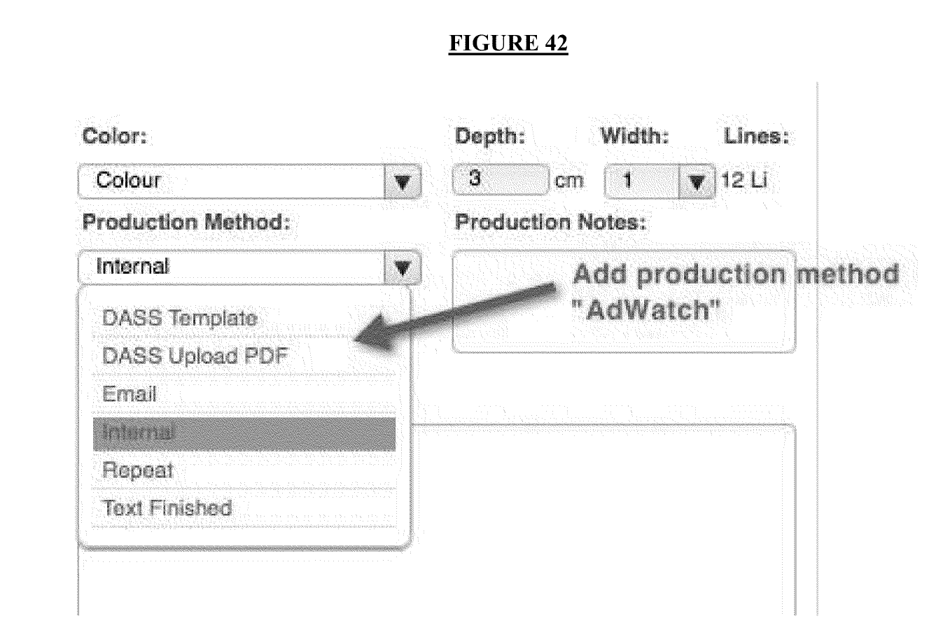

1. Log into the sales component;
2. Navigate to “Book a new call center ad;”
3. Select classified ad type;
4. Set production method to “Adwatchex,” which will create a flag in the system that print proof not required, as illustrated in FIG. 42;
5. Book the ad without entering any content. System will not display error message that the ad is incomplete;
   a. If a user changes the production method to something other than ‘Adwatchex,’ the system will require ad content to book the ad;
   b. Take note of the order number when it is saved; and
   c. Other ad types (print display/digital) should be able to book without content, without selecting the new production method of AdWatch;
6. Log into AdWatch;
7. Search for the specified order number from the sales component;
8. The ad that the user entered in the sales component will be returned, with any data entered in the fields;
9. The user has the ability to build the ad content in AdWatch; and
10. After content is created and applied to the ad in AdWatch, AdWatch will connect with the sales component. The user can view the content that was added in AdWatch through the sales component.

### Use Case 008—Track History

### 1. Basic Information

| Use Case ID | 008 |
|---|---|
| Description | This Use Case describes the sales component track history |
| | section for all ad types |
| Primary | Booking Agent |
| Actor(s) | Sales Rep |
| | Credit Rep |
| Successful | System tracks history of an order down to what field was |
| Post | changed, what the new value is, when the field was |
| Conditions | changed, and the user that made the change. |
| | History should be tracked at this level for all ad types |
| Performance | Each click should take less than a few seconds to respond, |
| | depending on the complexity of the click. |

### 2. Flow of Execution

### 2.1 Status Change History

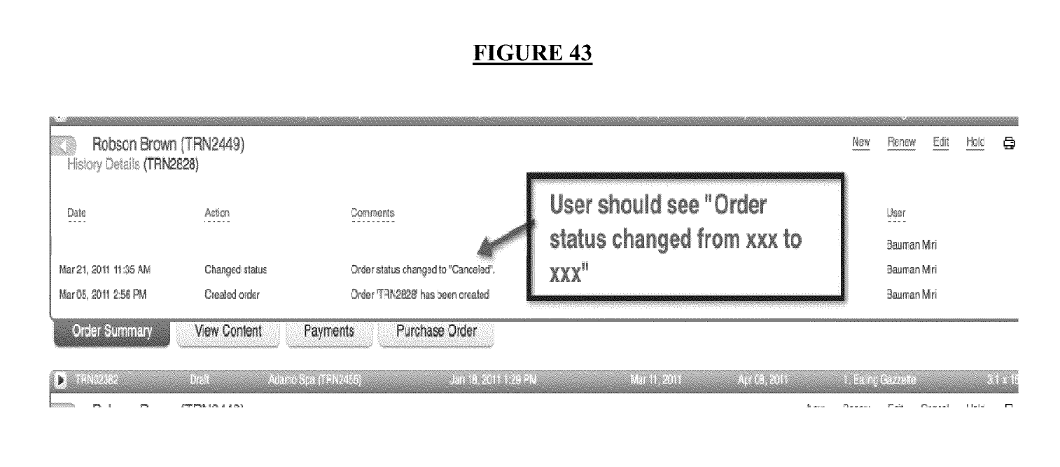

1. The user can view all status changes made to an order;
   a. Action displays “Changed Status” (current functionality);
   b. Comments section displays what the status used to be and to what the status changed; and
   System Statuses includes all statuses tracked as per the booking status in WebAdmin. These include Draft, Approved, Accepted, Canceled, Renewed, etc., as illustrated in FIG. 43.

### 2.2 Edited Order History

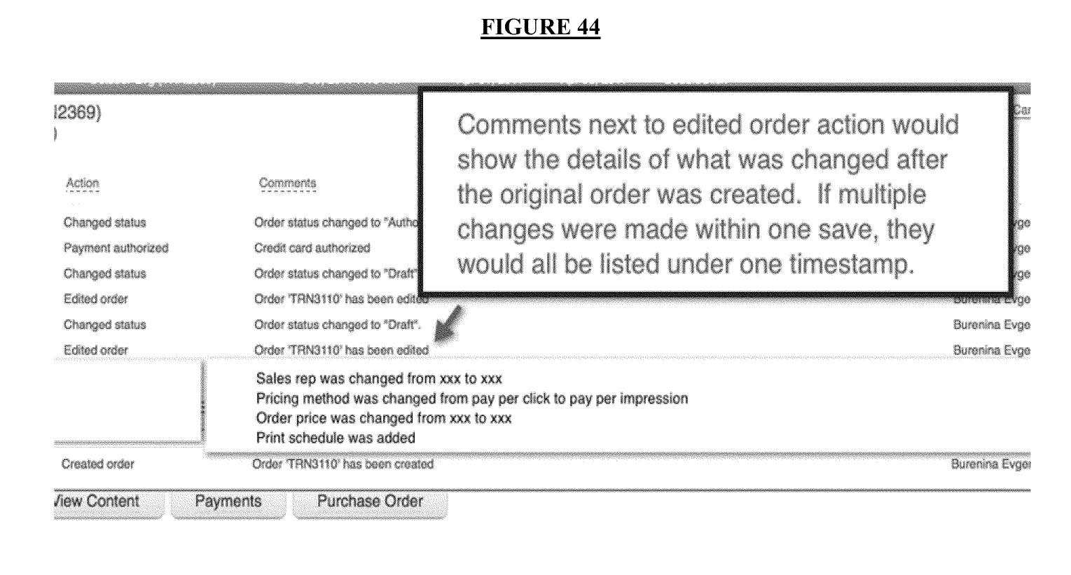

1. The user can view the details on all saved edits made to an order's data and content;
   a. Edited order may not display history details if the user changes a data field but does not save the change;
2. Comments generally display the detail for any edit;
   a. Examples of changes include date change, price change, sales rep change, product change, discount added/edited, insertion added/deleted, etc. (basically any data field in the various ad types); and
   b. Comments display the old and new value of the edit;
      i. Examples include: date changed from xxx to xxx; sales rep changed from xxx to xxx; discount amount of xxx added to order; etc.; and
   c. Comments list multiple changes within one time stamp if user makes multiple changes within one save, as illustrated in FIG. 44; and
3. Comments do not need to display the detail of what the old value was and the new value is for long free text entry fields, as the field data may be too long for the history sections. These fields include all notes sections and classified fielded data. Instead, comments will say “notes were added/edited” or “xxx field was added/edited.”

### Use Case 010—Print Positions and Guarantee

### 1. Basic Information

| Use Case ID | 010 Print Positions |
|---|---|
| Description | This Use Case describes how a user can create a print ad |
| | and define what location(s) in which the ad will be |
| | displayed. |
| | Any requirements regarding inventory management are not |
| | included within this Use Case. |
| Primary | Booking Agent |
| Actor(s) | Sales Rep |
| Successful | 1. Positions will be configured per |
| Post | publication/package so that only positions available |
| Conditions | for the chosen publication(s)/package(s) will |
| | display. |
| | 2. Ad position requirement can be guaranteed. |
| | 3. Guaranteed positions can only be saved if the |
| | position was not previously guaranteed. |
| | 4. Positions can be guaranteed at the insertion level. |
| | 5. Guaranteed positions will have a premium price. |
| Performance | Each click should take less than a few seconds to respond, |
| | depending on the complexity of the click. |

### 2. Flow of Execution

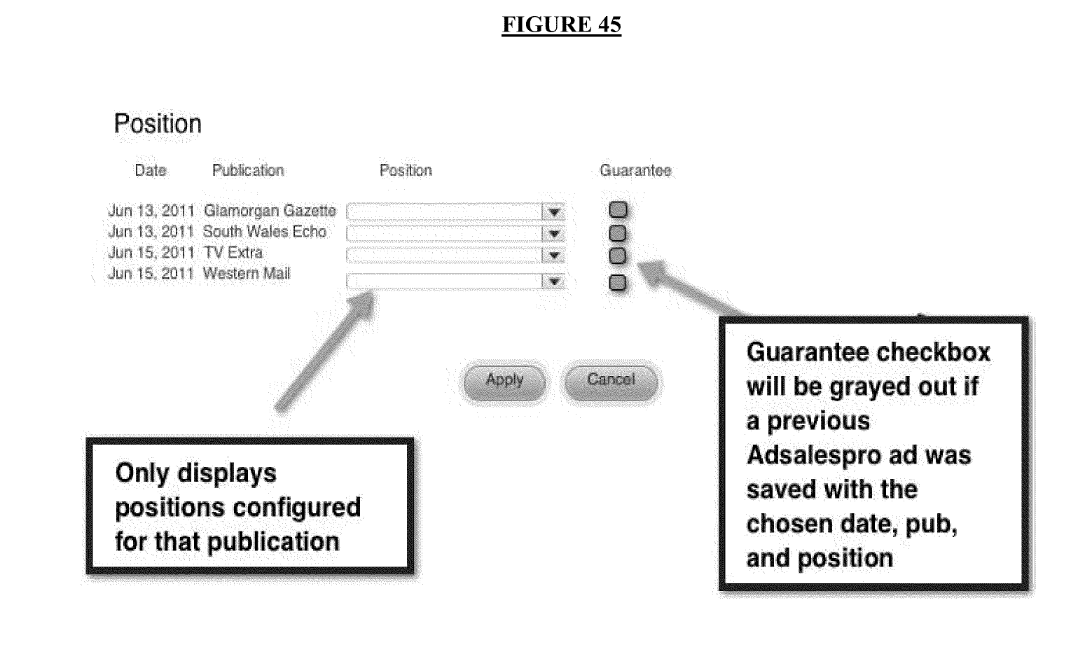

2.1 User can select position
1. Positions may be configured based on the selected publication/package. Different publications may have varying positions available for booking;
2. The user can either select the position from a drop down or type it in manually. If the user types in the position, only positions matching the text will display (user cannot manually enter a position that does not exist in the drop down); and
3. The following positions may be available based on the publication/package selected:
   a. Front Page;
   b. Specific Page;
   c. Early in Paper;
   d. Early in Section;
   e. Right hand page;
   f. Left hand page;
   g. First page in section;
   h. Last page in section;
   i. First ad in classification;
   j. Top of page;
   k. Bottom of page;
   l. Inside page;
   m. Outside page;
   n. Solus;
   o. Coupon; or
   p. Strap.
      2.2 User can adjust position per insertion and define if it is guaranteed in a new window
1. The user may select a new link to “Assign Position,” as opposed to the existing drop down on the main booking screen;
2. New window will open that allows the user to select different positions for each insertion. Window displays each insertion date, each insertion's publication, and a drop down that will allow the user to pick a position per insertion;
3. Position drop down per insertion will only display positions that are configured to the specified publication. This field is optional; the user may leave position blank for some or many insertions;
4. Insertions may have a checkbox that can be ticked if that particular product, position, and insertion date were not previously saved in the sales component with a guaranteed selection; and
If a different booking in the sales component already saved an order that guaranteed the particular product, position, and date, then the checkbox will be grayed out so the user cannot guarantee, as illustrated in FIG. 45.
   2.3 Customer will pay premium price for guaranteed position
1. The system can be configured to adjust the price of the booking based on whether guaranteed is selected;
2. Business will setup position requirement price adjustment rules through rate sheet in Drools. When a user selects guaranteed, the user will see the price update based on the configured rules; and
3. The user or business can define the pricing rules via Drools. Price may be either a percentage increase or flat rate, based on the category.
   2.4 User cannot save a guaranteed position as a draft order
1. If a user selects guarantee, but then saves the order as a draft, the system will display an error message that “Order has been saved as a draft without the guaranteed position;” and
2. The system will then automatically un-tick any guaranteed insertions before saving as a draft.
   2.5 Position and Guarantee will be sent to the planning system
1. If a user guarantees any insertion, and saves the order, “Guaranteed” will be sent to the planning system behind the scenes through the xml interface; and
2. If the user does not select the checkbox, then the position is “requested” and this will be sent behind the scenes to the planning system in the xml interface.
   2.6 The system may provide a list of the available positions/sizes for each page.

### 3.1 Position Definitions

1. Front Page—More than one booking may be planned on a front page. These will normally be “fixed” sizes and positions. The front page of the paper still exists when a wraparound may be planned outside of it (i.e., Page 1 is not necessarily the instruction);
2. Specific Page—Page 3, Page 5, Page 7, etc. Specific pages may be requested or guaranteed;
3. Early in Paper—Early would normally be defined as a set percentage that is configurable (e.g., first 25% of pagination);
4. Early in Section—This is defined as a configurable percentage, commonly used in the ROP section, often the first 50%;
5. Right/Left Hand Page: Advertisement should be placed to the right or left;
6. First/Last Page in Section—First page of a section such as Motors, Property, Recruitment where it runs across several pages;
7. First Advert in Classification—Within classified headings, the first advert immediately under the heading;
8. Top/Bottom of Page—Advert must be at the top/bottom of the page (only element above may be a banner heading for the page);
9. Inside/Outside of Page—Advert must be placed on the inside/outside edge of the page;
10. Solus—Advertisement must be the only ad on the page;
11. Coupon—Advert must be placed on a cutting edge, with no other coupons on the reverse side; and
12. Strap—Top position across the page.

### Use Case 011—Apply Discount

### 1. Basic Information

| Use Case ID | 011 |
|---|---|
| Description | This Use Case describes how a user can apply discounts to |
| | an order or a portion of an order |
| Primary | Booking Agent |
| Actor(s) | Sales Rep |
| | Credit Rep |
| Successful | Discounts can be applied at either total order value |
| Post | or individual insertions level. |
| Conditions | Discounts can be configured as either percentage or |
| | set value. |
| | Discount authority must be controlled by |
| | user/group security or permissions, and the system |
| | should provide multiple levels of user security/ |
| | permissions. |
| | Discounted Orders/Insertions may be routed to |
| | approval queues. |
| Performance | Each click should take less than a few seconds to respond, |
| | depending on the complexity of the click. |

### 2. Flow of Execution

### 2.1 Apply Discount Fields

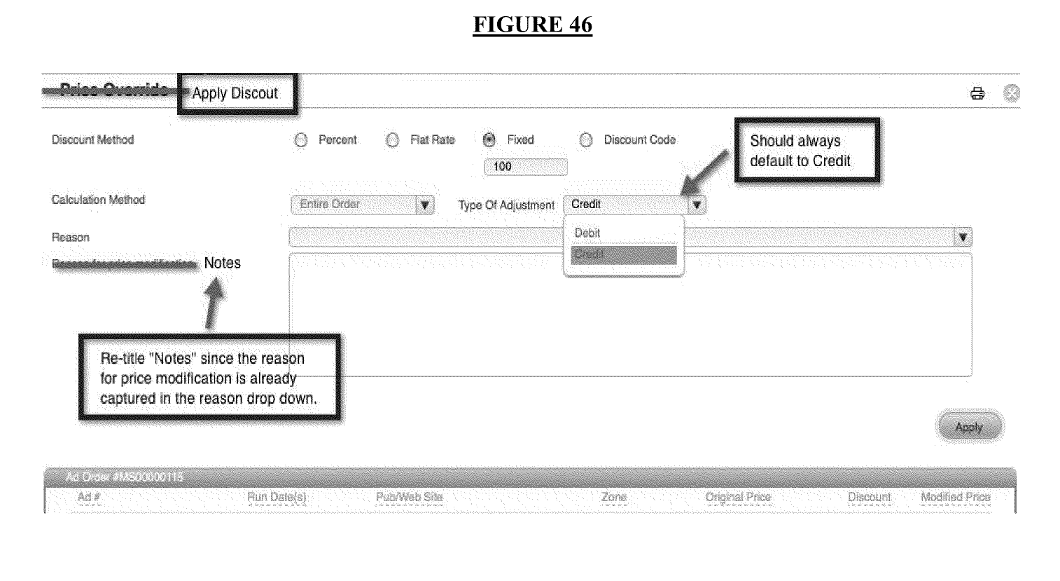

1. Create a new order;
2. Enter required fields and navigate to order details;
3. Select ‘Apply Discount;”
   a. New browser panel will open. “Price Override” may be renamed “Apply Discount;”
   b. Type of Adjustment will always default to ‘Credit;”
   c. When user selects Reason drop down, the following reasons will display:
      i. Reasons will be configurable by sales group or sales person. One sales user may need to see different reason codes than another depending on his/her sales group or individual logon; and
      ii. Although reason codes are configurable, the following are exemplary reasons for a discount:
         1. Corporate;
         2. For Sale/Bargains
         3. Free For Error;
         4. Goodwill;
         5. House Advert;
         6. Promotional;
         7. Sch/Club/Char Events;
         8. Sponsorship; and
         9. Staff Ad; and
   d. Field “Reason for price modification” may be retitled “Notes” since the reason for modification is already captured in the “Reason” drop down, as illustrated in FIG. 46. Notes field may be optional.

### 2.2 Permissions

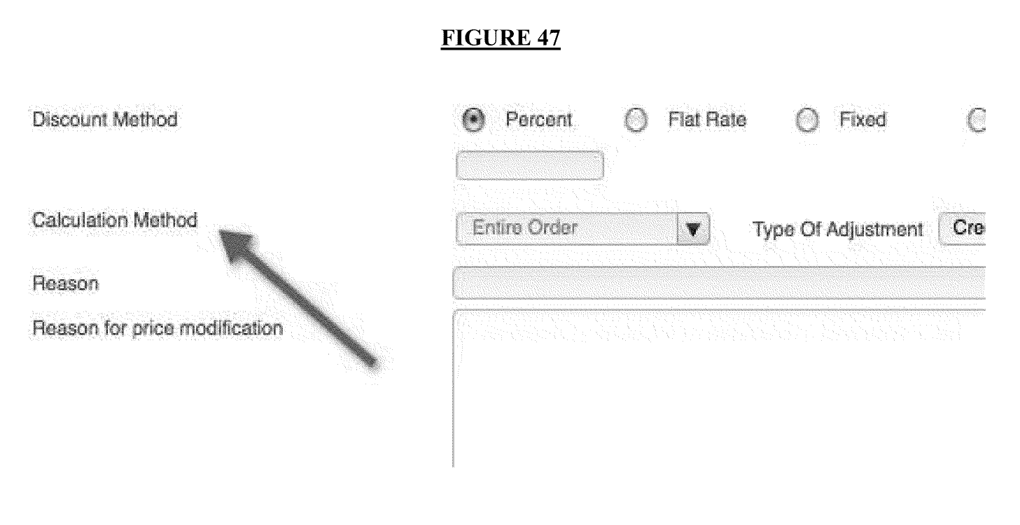

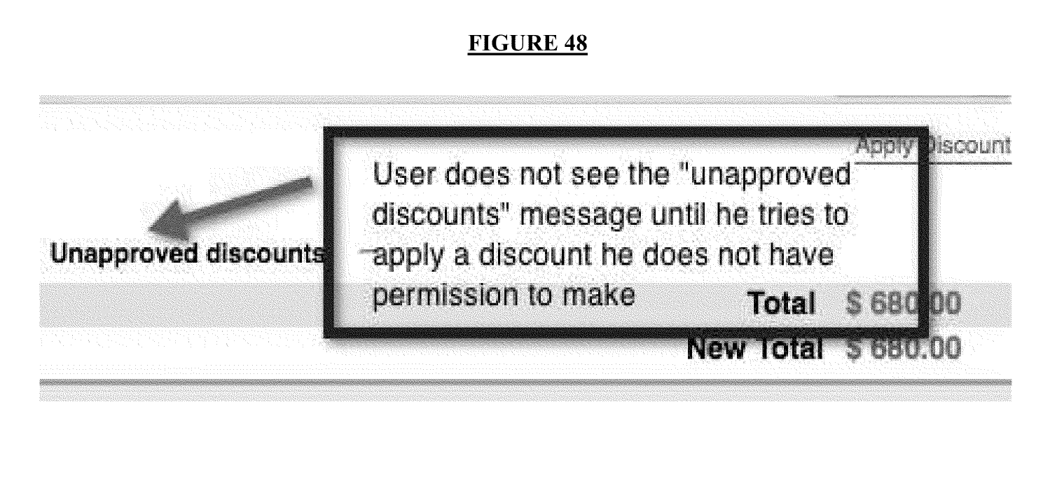

1. Through configuration, users may have permissions to make varying levels of discounts either by User or Sales Group. Discount levels include:
   a. Ability to discount entire order;
   b. Ability to discount a portion of an order (IE at the insertion level) by adjusting the calculation method to “Insertion Level.” If the user does not have permission, only discount method “entire order” will be selectable, as illustrated in FIG. 47; and
   c. Ability to discount at a certain percent or value of the order;
      i. Example: Only certain users can discount above 10%, 20% of total order or a maximum fixed discount of £100;
2. When a user applies a discount, system may validate the user has the permissions to make that discount by ensuring the user has permission to use the particular discount code;
   a. If the user does not have permissions, he will receive a message that the order has moved into the approval queue and must be approved by valid user before being applied to order;
      i. The current message that displays automatically for “unapproved discounts” will not display until the user actually tries to apply a discount he does not have permission to make, as illustrated in FIG. 48. When a separate user with permissions approves the discount through the approval queue, then the “unapproved discount” message will no longer display. See Approval Use Case for details on various approval queues; and
   b. If the user does have permission to make the discount, he will receive a message that the discount has successfully been applied to the order. When the user closes the discount window, he will see the price updated appropriately in the order information summary; and
3. When a user applies a discount code, system will ensure the discount code is associated to selected product;
   a. When the user enters a promotion code (example, Vehicle 11 is a 20% discount for Motors), the system that will validate the code is only used against the Motors Category/Classification; and
   b. If the Discount code does not match the configured Category/Classification, the user will receive message that the discount code is not valid.

### Use Case 012—Business Structure

### 1. Basic Information

| Use Case ID | 012 |
|---|---|
| Description | This Use Case describes how a WebAdmin may be setup. |
| Primary | WebAdmin User |
| Actor(s) | |
| Successful | The system can be configured to ensure a business structure |
| Post | is correctly integrated with the sales component. |
| Conditions | |
| Performance | Each click should take less than a few seconds to respond, |
| | depending on the complexity of the click. |

### 2.1 General Business Structure Needs

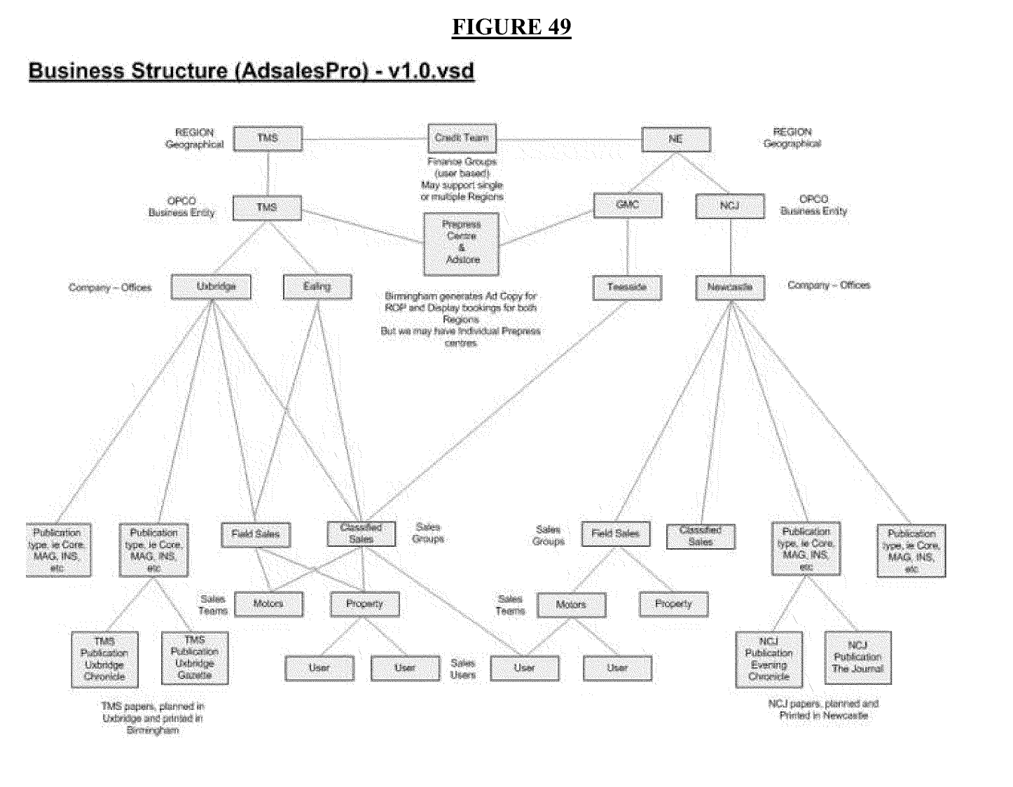

1. The user can configure each office within and across the business structure shown in FIG. 49; and
2. Each structure within the business structure requires an alphanumeric code for configuration:

| Structure | Description |
|---|---|
| Region | Geographical region. |
| Code | |
| OPCO | The Operating Company, or Business Entity operating within |
| Code | a Region; there may be multiple OPCO's within a Region. |
| (Com- | |
| pany) | |
| Office | Offices associated with an Operating Company (each sales |
| Code | person associated to an office). |
| Prepress | The Prepress Center associated with an OPCO; a Prepress |
| Code | Center may support multiple OPCO's. |
| Publica- | Publications are associated with offices; there may single or |
| tion | multiple publications associated with an office. |
| Code | |
| Sales | Sales Groups are associated with offices; there may single or |
| Groups | multiple Sales Groups associated with an office. |
| Sales | Sales Teams are associated with Sales Groups, there may |
| Teams | single or multiple Sales Teams associated with a Sales Group. |
| Sales | Sales Users are associated with a single Sales Team; they can |
| Users | be associated with Multiple Sales Groups in order to access |
| | other publications across a Region. Sales Users are associated |
| | with a single Sales Territory setting. The Sales Territory is a |
| | configurable element to allow accurate reporting. |

### 2.2 WebAdmin:

1) Company List
   a. Under the existing Company List (company is also known as OPCO), the user will also see new fields “Region Code” and “Prepress Center;”
2) Office List
   a. The user will have a new list to select “Office.” Office will have the same fields that display within the Companies List with the following changes:
      i. There may not be a “Prepress Center” field; and
      ii. There may be an additional field for “Company;” and
3) User Group
   a. Under the existing Users Group, the “Office” field may be added.
      Use Case 013—eProof™ Navigation

### 1. Basic Information

| Use Case ID | 013 |
|---|---|
| Description | This Use Case describes how a user can open eProofs |
| | content within the sales component order details through a |
| | new eProofs navigation bar |
| Primary | Booking Agent |
| Actor(s) | Sales Rep |
| Successful | User can view eProofs content within the sales component. |
| Post | User cannot view eProofs content within the sales |
| Conditions | component if he does not have permissions or if there is no |
| | content available. |
| | User can view the sales component order details within |
| | eProofs. |
| | User cannot view the sales component content within |
| | eProofs if he does not have permissions or if there is no the |
| | sales component order detail available. |
| Performance | Each click should take less than a few seconds to respond, |
| | depending on the complexity of the click. |

### 2. Flow of Execution

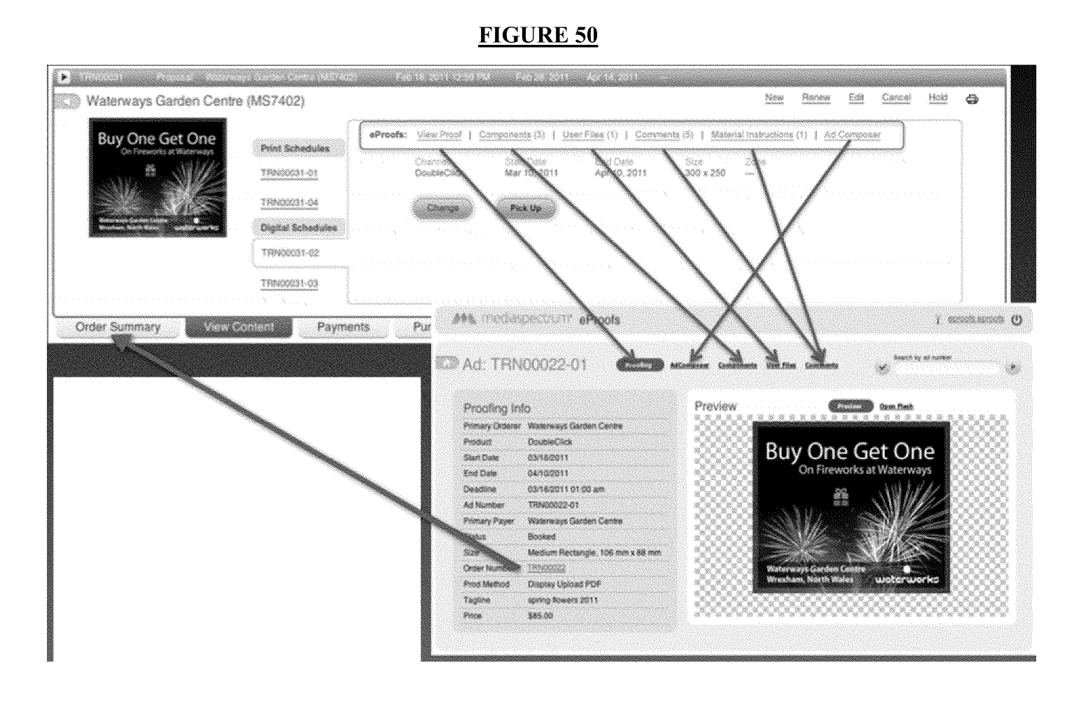

2.1 eProofs content displays within the sales component
1. Select an order within the sales component that has content associated to that same order number in eProofs;
2. The user will see a new “eProofs” navigation bar; and
3. When the user selects a link within the navigation bar, the content within eProofs opens in the sales component browser window;
   a. The user can view the following eProofs content within the sales component:
      i. View Proof;
      ii. Components;
      iii. User Files;
      iv. Comments;
      v. Material Instructions; and
      vi. Ad Composer; and
   b. The user may not see the eProofs navigation bar in the following circumstances:
      1. There is no eProofs content for the chosen ad;
      ii. The user logged in does not have access to eProofs; or
      iii. The customer does not have eProofs installed.
         2.2 eProofs links to the sales component
1. In eProofs, view content that is associated to an Order Number in the sales component;
2. Select the order number within eProofs;
3. The “Summary” tab that displays in the sales component will open within eProofs for the user to browse the order details. The system will determine what order to display by matching the order number, as illustrated in FIG. 50;
4. The user will not be able to open the sales component content in eProofs in the following circumstances:
   a. There is no the sales component ad associated to the content;
   b. The user logged into eProofs does not have access to the sales component; or
   c. The customer does not have the sales component installed

### Use Case 014—Upload Order Level Content

### 1. Basic Information

| Use Case ID | 014 |
|---|---|
| Description | This Use Case describes how a user can upload content to a |
| | sales component order. |
| Primary | Booking Agent |
| Actor(s) | Sales Rep |
| Successful | The user can upload content from the order summary. |
| Post | |
| Conditions | |
| Performance | Each click should take less than a few seconds to respond, |
| | depending on the complexity of the click. |

### 2. Flow of Execution

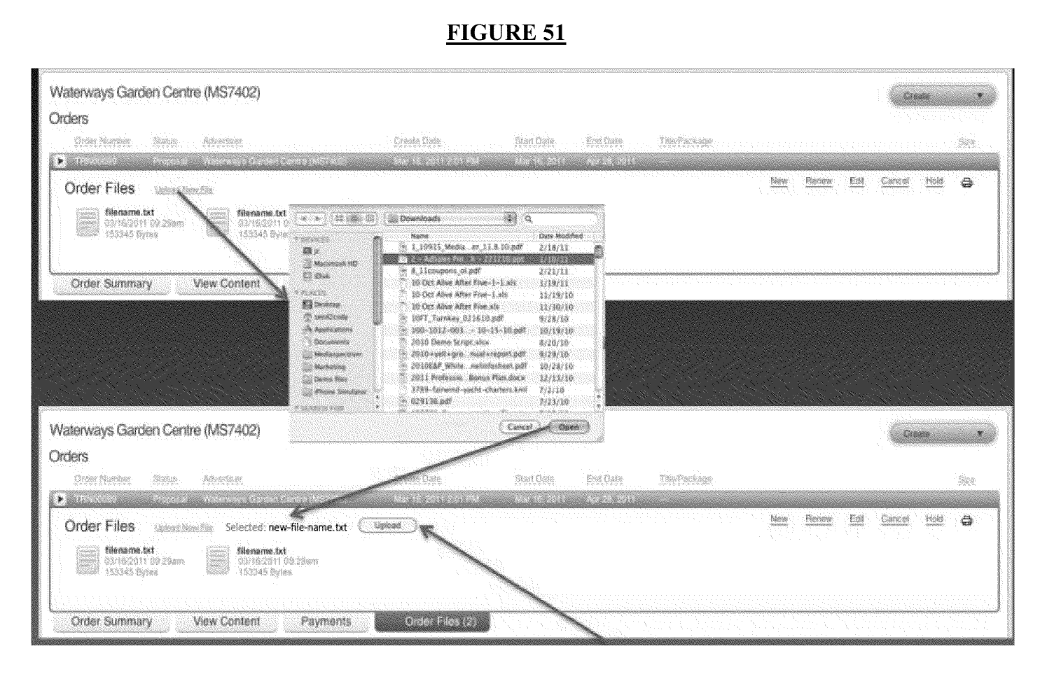

2.1 Upload Content from the Order Summary
1. Select an order in the sales component Dashboard,
2. Expand to view the details,
3. The user will see new tab “Order Files;” and
4. Upon selection, the user will see any files that had previously been uploaded to the file and has the option of uploading a new file;
   a. When a user selects “upload new file,” a window will open for the user to select a file to add to the order. The user will select content and then select “upload” to complete action; and
   When a user selects a file that has already been uploaded to the file, a new window will open with the file's content, as illustrated in FIG. 51. Use Case 015—Export Orders

### 1. Basic Information

| Use Case ID | 014 |
|---|---|
| Description | This Use Case describes how a user can export an order list. |
| Primary | Booking Agent |
| Actor(s) | Sales Rep |
| | Credit Rep |
| Successful | The user can export order list to .XLS or .CSV. |
| Post | |
| Conditions | |
| Performance | Each click should take less than a few seconds to respond, |
| | depending on the complexity of the click. |

### 2. Flow of Execution

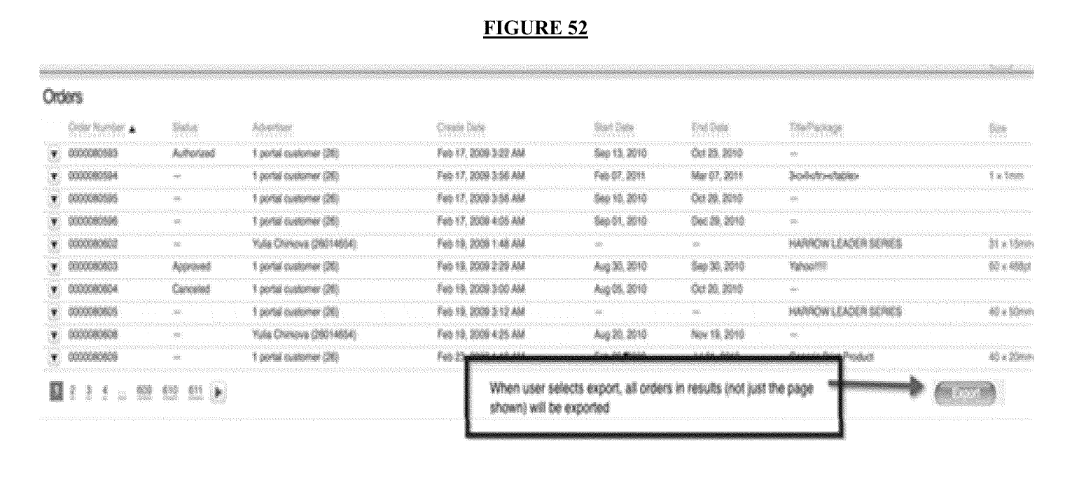

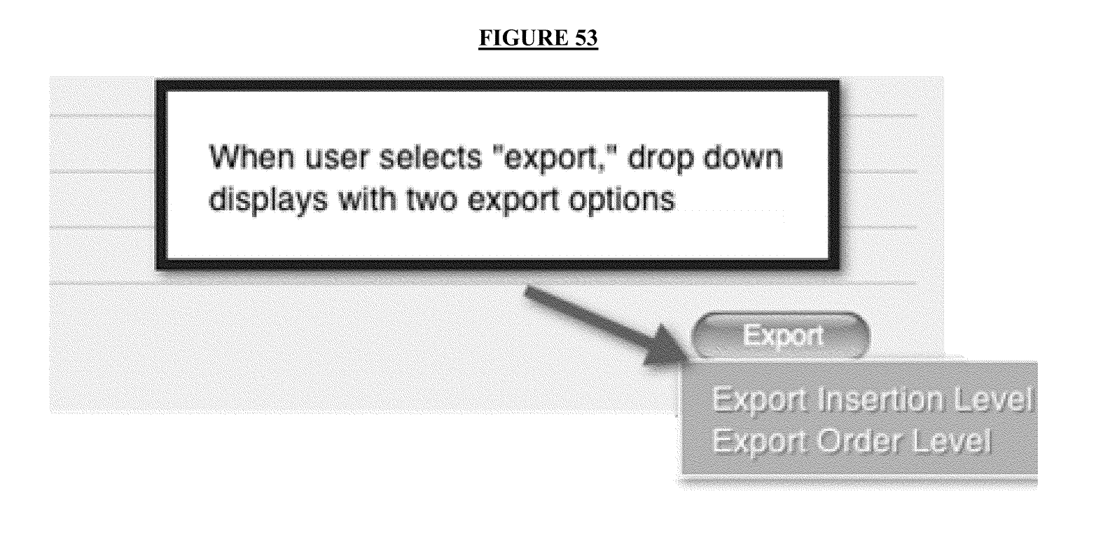

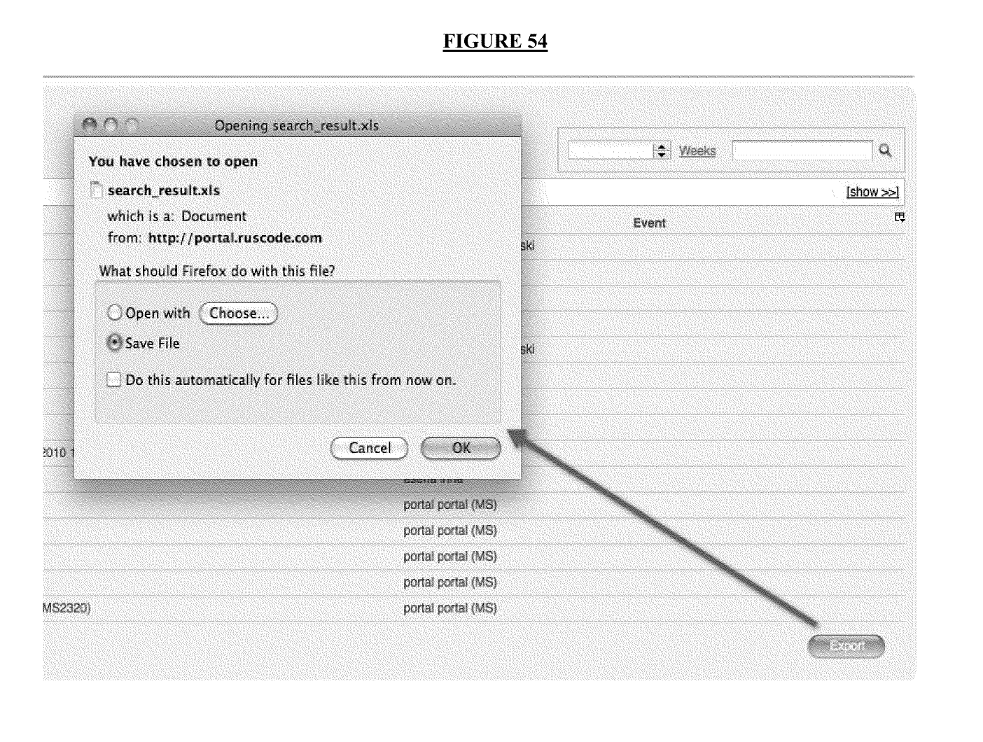

2.1 User can export orders at the insertion level
1. Navigate to the dashboard;
2. The user will see an export button at the bottom of the page, as illustrated in FIG. 52;
3. When the user selects export, he will see a drop down with two options: export at the insertion level and export at the order level;
4. Select “Export Insertion Level,” as illustrated in FIG. 53;
5. The user can save or open file;
   a. When exporting at the insertion level, the user will see a row for every insertion;
   b. Insertions will be grouped by the orders to which they are associated, and will display as the orders were sorted on the Dashboard; and
   c. Any number of fields can display in the export, as illustrated in FIG. 54.
      2.2 User can export orders at the order level
1. Select export at the “order level;” and
2. The user can save or open file;
   a. When exporting at the order level, the user will see a row for every order, sorted as the orders were displayed on the Dashboard; and
   b. Any number of fields can display in the export.

### Use Case 016—Pickup Order Schedule

### 1. Basic Information

| Use Case ID | 016 |
|---|---|
| Description | This Use Case describes how a user can pickup and renew |
| | just a portion of the order. |
| Primary | Booking Agent |
| Actor(s) | Sales Rep |
| Successful | The user can renew a subset of an order. |
| Post | |
| Conditions | |
| Performance | Each click should take less than a few seconds to respond, |
| | depending on the complexity of the click. |

### 2. Flow of Execution

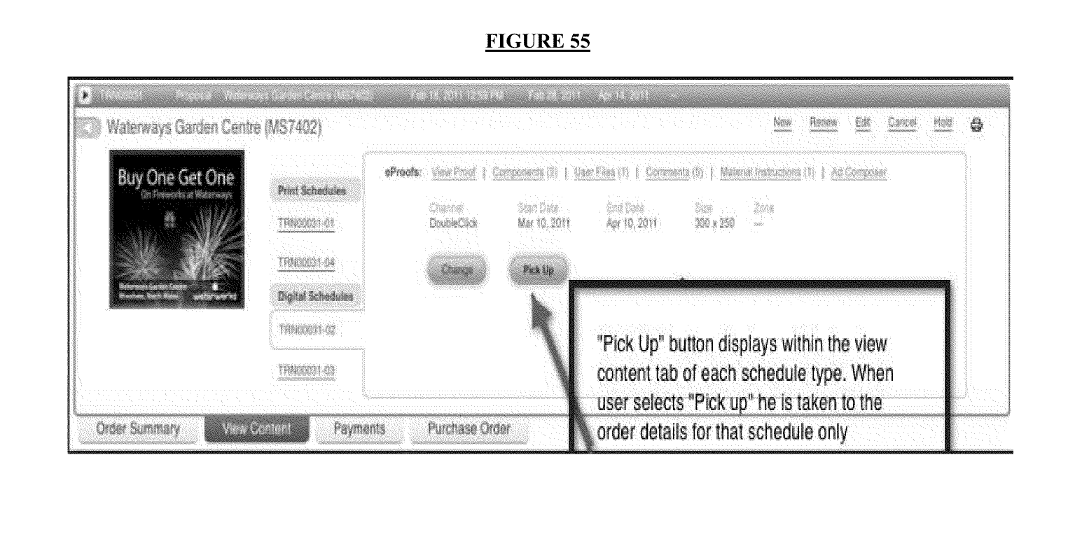

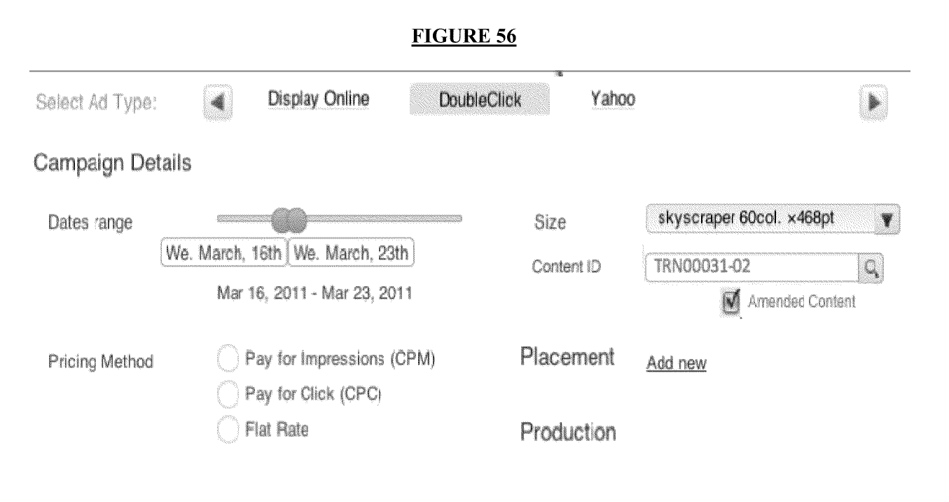

2.1 User can pickup a portion of an order's schedule
1. Navigate to the Dashboard;
2. Select an old order with multiple schedule types, such as digital and print classified;
3. Select view content;
4. The user will see a new button within each schedule type to “Pick Up” the order, as illustrated in FIG. 55;
5. Select Pick Up for the digital schedule only. This is separate from “renew” since renew picks up the entire order. If THE user picks up just digital, the system will only pick up the digital schedule, selected, content, and the advertiser bill-to-relationship; and
6. The system will display the Digital schedule only, allowing the user to edit and/or renew, as illustrated in FIG. 56.

Use Case 017—Assign Content by Searching eProofs™

### 1. Basic Information

| Use Case ID | 017 |
|---|---|
| Description | This Use Case describes how a user can assign content by |
| | searching eProofs within the sales component. |
| Primary | Booking Agent |
| Actor(s) | Sales Rep |
| Performance | Each click should take less than a few seconds to respond, |
| | depending on the complexity of the click. |

### 2. Flow of Execution

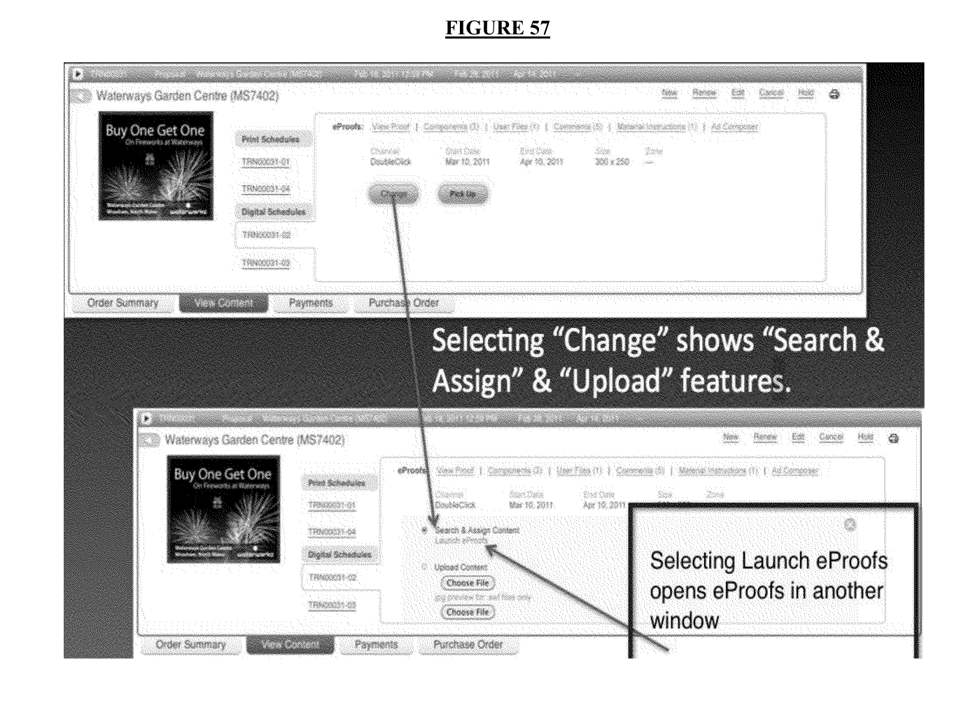

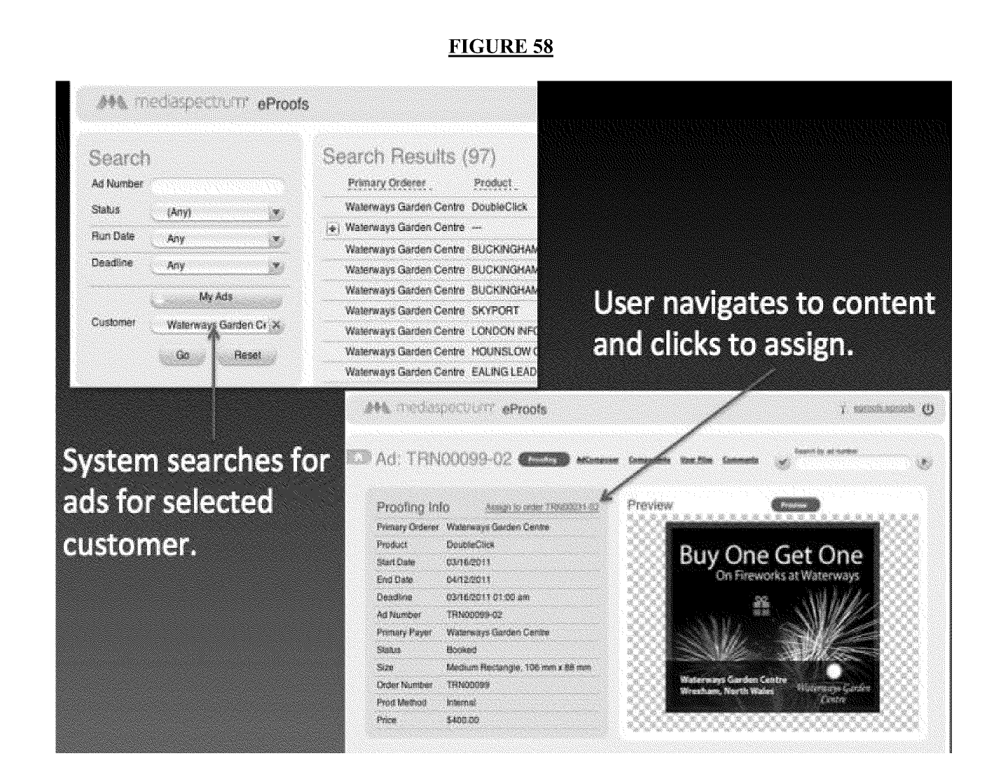

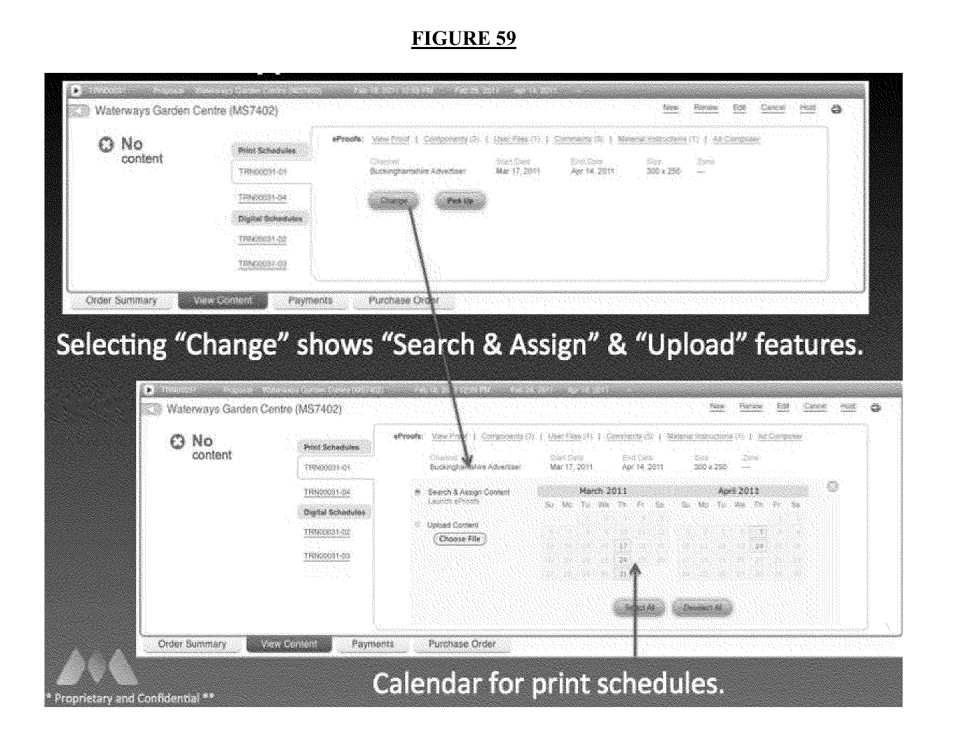

2.1 User assigns Digital Ad content by searching eProofs within the sales component
1. Navigate to the Dashboard;
2. Select an existing order with content assigned;
3. Select “View Content;”
4. Select a digital schedule;
5. Select “Change,” as shown in FIG. 57;
6. Selecting change shows both the ability to upload content and the ability to “Search and Assign;”
7. Select “Search and Assign;”
8. A separate window will open with eProofs;
9. The system will show a selected customer in the search, with all orders associated to that customer in the search results;
10. The user will select the order he needs to change the content, choose the new content, and select “Ad to order xxxx;” and
11. Upon adding to the order, the user can see the new content and content ID in the sales component, as illustrated in FIG. 58.
   2.2 User assigns Print Ad content by searching eProofs within the sales component
1. Navigate to the Dashboard;
2. Select an existing order with content assigned;
3. Select “View Content;”
4. Select a print schedule;
5. Select “change;
6. A calendar tool will open that allows the user to find, upload, and change content for a particular insertion. The calendar tool is used for print ads, as it is more common to change content for just a particular insertion with print than digital;
7. The user can select a single date, a range of dates, or a manually selected group of dates;
8. Select search and assign; and
9. The user can search and assign content as in 2.1 steps 8-11 above, as illustrated in FIG. 59.
   Use Case 018—Assign Content from Order Entry

### 1. Basic Information

| Use Case ID | 018 |
|---|---|
| Description | This Use Case describes how a user can assign content |
| | to an order on the order entry page. |
| Primary | Booking Agent |
| Actor(s) | Sales Rep |
| Successful | 1) User can assign content from the create order page. |
| Post | 2) User can identify if the content is amended. |
| Conditions | |
| Performance | Each click should take less than a few seconds to respond, |
| | depending on the complexity of the click. |

### 2. Flow of Execution

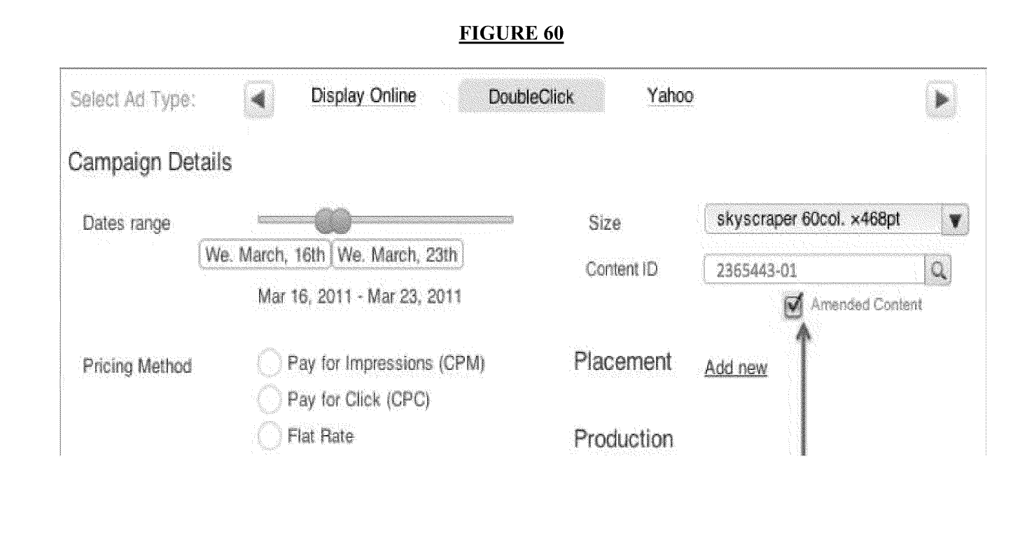

2.1 Assign content from the Order Entry Page
1. Pickup an existing order (any ad type);
2. The user will see a content “ID” field;
3. The user can search for content (based on the Adwatch™ content number) and assign to the order;
   a. If the content assigned does not match the size selected, the user will receive an error message that size and content do not match. The user must replace the content with content of the correct size; and
   b. If the user is picking up an existing order and the content is not an exact replica, he can select the production method type of “Amended Content;”
      The Amended Content production method will tell the content creator that the content must be amended. The user would look at the production notes to determine how the content must be amended, as illustrated in FIG. 60.

### Use Case 019—Option Ads

### 1. Basic Information

| Use Case ID | 019 |
|---|---|
| Description | This Use Case describes how a user can define an option |
| | order, so that the order will have flexible insertion dates. |
| | The advertiser gives the publisher flexibility regarding |
| | when the ad will run. For that flexibility, the advertiser |
| | typically receives a discount off the list price. |
| Primary | Booking Agent |
| Actor(s) | Sales Rep |
| Successful | The user can book an order as an “option order.” |
| Post | Option orders will be discounted based on pricing |
| Conditions | rules setup by business. |
| | The user can manually “expire” certain option days |
| | so the system books the option on the next available |
| | day in the option. |
| | The user can identify an option insertion from the |
| | Dashboard and within the order details. |
| Performance | Each click should take less than a few seconds to respond, |
| | depending on the complexity of the click. |

### 2. Flow of Execution

### 2.1 Define Option Insertions

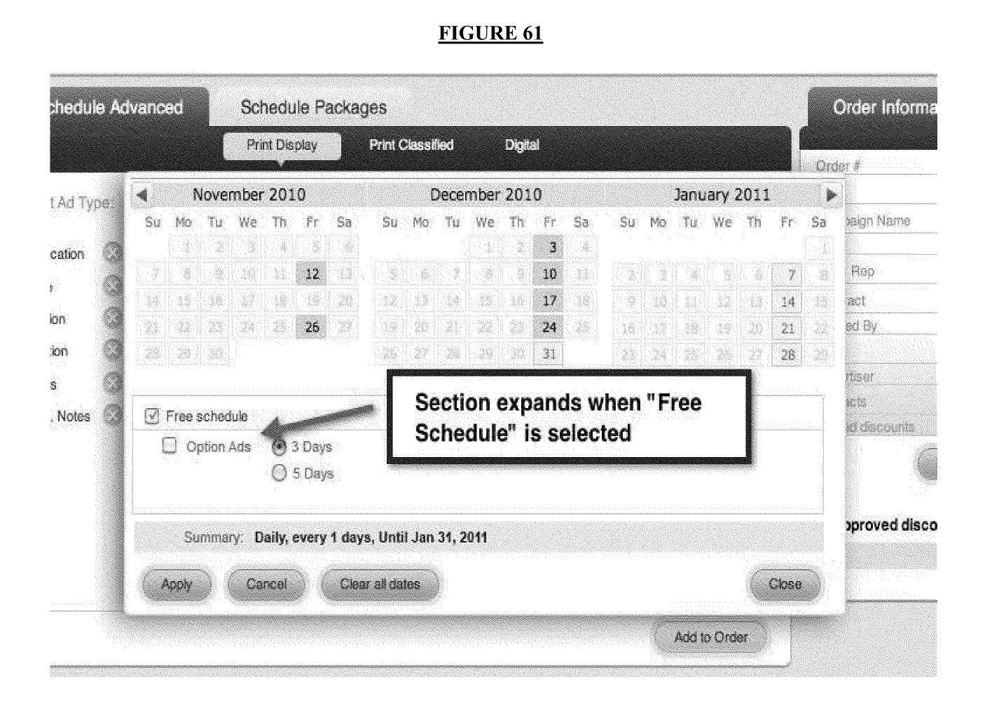

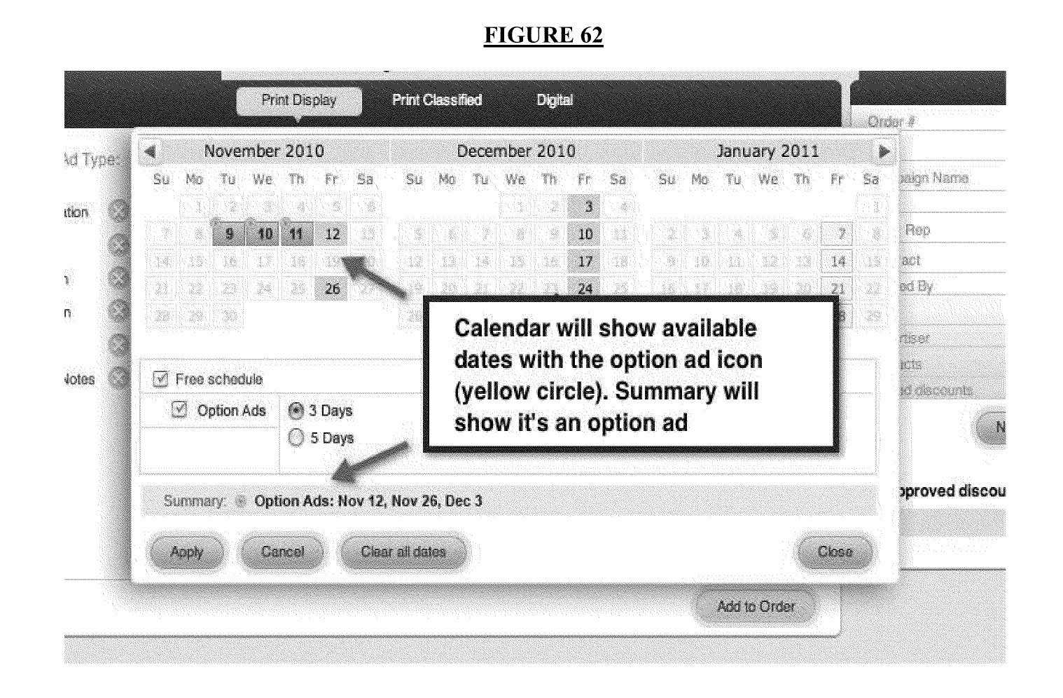

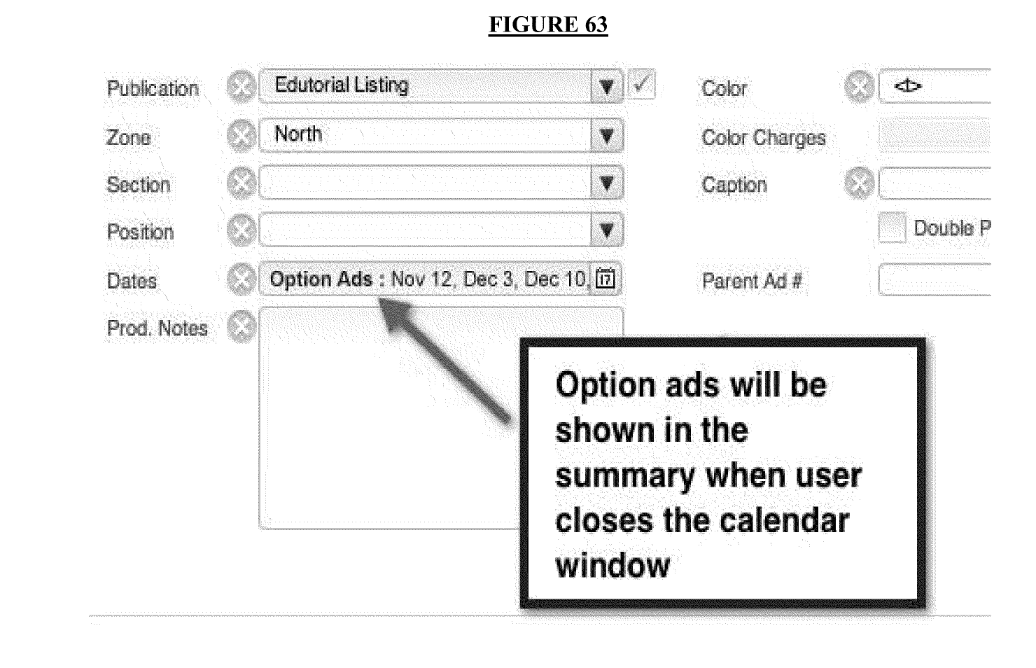

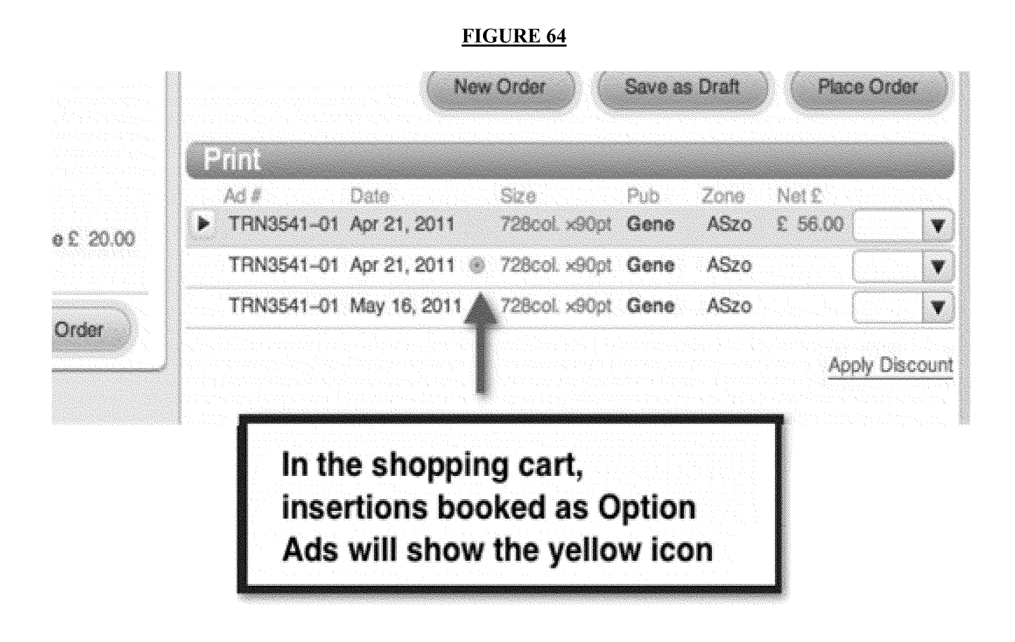

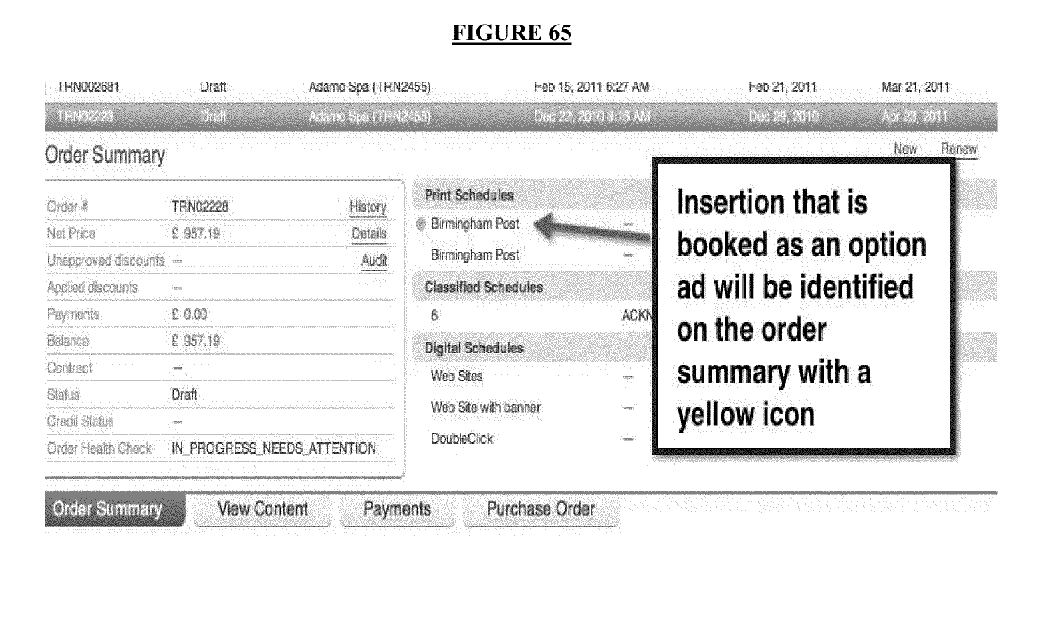

1. The user books an ad for a customer that has flexible ad dates;
2. Within the calendar tool, select “Free schedule;”
3. The user can select “option ad” to indicate that the advertiser is flexible with the insertion dates, as illustrated in FIG. 61;
4. Select “Option Ad;”
   a. Repeat will not display, as an option ad only displays one time within the selected time period. If the user wants to repeat the option insertion, he would add the option insertion to order and then add on a new insertion;
   b. The user can select the number of days that the option ad could run. This time period will be configured in WebAdmin (Example—ad will run within 3 days time or 5 days time);
   c. The user will select the start date of the order, as he would any other order;
   d. Based on the selected start date and the either 3 or 5 day option, the end date will update. Example—if the user selects a start date of April 10^{th} and a 5 day option, the system will automatically enter an end date of April 15^{th}. Example—if the user changes the end date to the 17^{th}, then the start date will update to the 12^{th}; and
   e. Summary will display “Option Ads—dates selected;” and
5. Once an Option ad is placed, any user can identify that it is an option ad. If the user changes the insertion so it is no longer an option ad (by unchecking the option ad checkbox), then the option icon will no longer display next to that run schedule;
   a. In the shopping cart, a yellow circle icon will display next to the option insertion;
   b. In the order details, a yellow circle icon will display within the calendar tool and on the calendar summary; and
   c. On the Dashboard, the option icon will display at the order level (not the insertion level). When the user expands the order, the option icon will only display next to the insertions that are booked as option ads, as illustrated in FIG. 62 THROUGH FIG. 65.

### 2.2 Publish Option Insertions

1. When a user books an option insertion, the system will book all days of that option (example, dates April 10-April 15^{th}), but only 1 of those 5 insertions will claim space;
2. The system may default to making the 1st day—April 10th—the ‘publishable’ insertion. If nothing else changes, that will publish and all other insertions will expire without publication;
3. If the publisher has another ad it wants to put in that April 10th slot, it will expire the April 10th insertion. The system will tag the April 11th insertion as the one now trying to claim space. If nothing else changes, that ad will be published and 12^{th}-15th insertions will expire without publication;
   a. The user will manually expire the individual insertion by changing the status of the insertion within the order information section to ‘hold.’ Once the user saves, the system will auto activate the next available day;
4. The publisher can define business rules on how to handle option ads where all options are canceled:
   a. “Cancel—bill for space” will allow the user to cancel all insertions and charge for one; and
   b. “Cancel—no charge” will allow the user to cancel all insertions and not charge for any; and
5. Option ads are considered complete when just one insertion has run.

### 2.3 Pricing Option Insertions

1. The system can be configured to apply a discount to the “option insertion;” and
2. Business can define the amount of discount based on the option type (example, 3 vs. 5 day).

### 3.1 Additional Information

1. The publisher can cancel the insertion if it wants to publish a different ad on that day;
   a. In the shopping cart, there may be a status dropdown. Any given option run schedule can be set to ‘Hold’ or ‘Paused.’ For example, if the Monday of a 5-day option the publisher wants to not have that Monday published, the publisher could alter the status in the shopping cart for that day, and the publisher could select the next preferable day manually (e.g., Wednesday) or the publisher could select save and the system would automatically activate the next viable date (e.g., Tuesday);
2. The system may allow for the ability to adjust both the start date and end date of an option ad;
3. If the insertion continues to be canceled until the last day of the options, the final day may be canceled and the whole order refunded, or the system could disallow the cancel;
   a. For example, generally the business will decide. The system can “cancel-bill for space” or allow a cancel without billing;
4. The various statuses of the non-publishable option insertions may include, for example, ‘Hold’ for the non-publishable; and
5. All option insertions can have content assigned or just one insertion at a time;
   a. For example, when booked, if all the criteria are the same (size, etc.), then one piece of content can be assigned to all insertions, but if one wants to assign different content for each, the system allows for this as well;
   b. An option ad can have different sun schedules besides dates; and
   c. An insertion can also be edited to have a different size that others.

### Use Case 20—Business Classification Code

### 1. Basic Information

| Use Case ID | 020 |
|---|---|
| Description | This Use Case describes how a user can better define the |
| | classification code for a customer and the orders associated |
| | to that customer's classification code. |
| Primary | Booking Agent |
| Actor(s) | Sales Rep |
| Successful | User can select a business classification code at |
| Post | order. |
| Conditions | Chosen classification code must be tied to the |
| | customer profile. |
| | Recruitment orders must have a recruitment |
| | classification code. |
| Performance | Each click should take less than a few seconds to respond, |
| | depending on the complexity of the click. |

### 2. Flow of Execution

### 2.1 Customer Workflow

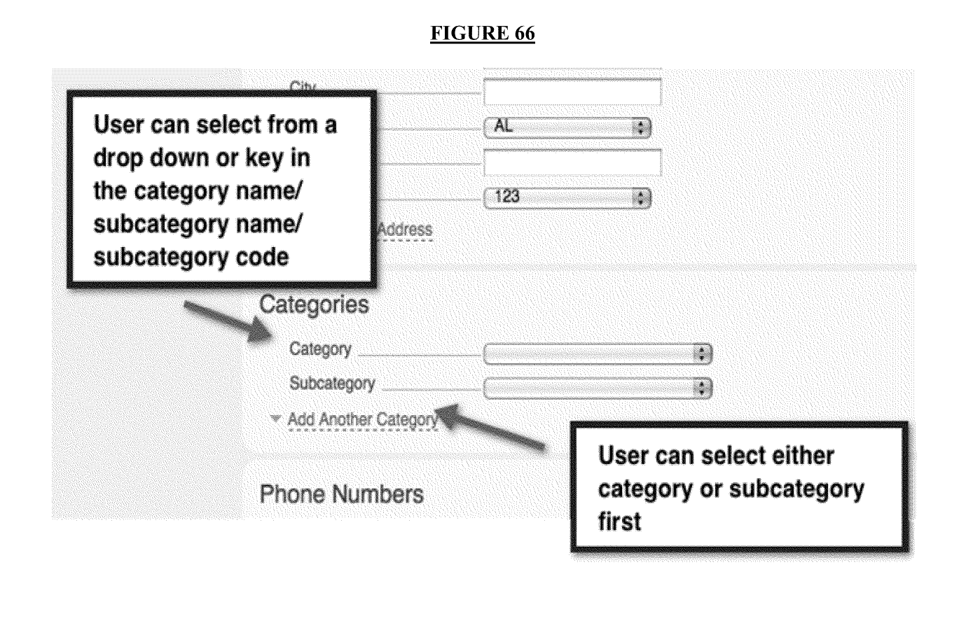

1. The user has the option of defining the subcategory that must be tied to the customer before choosing the category;
   a. Log into the sales component;
   b. Navigate to a customers page;
   c. View the business category section;
      i. The user can first select the category he must associate to the business;
         1. Subcategories tied to that category will then be available from the drop down;
      ii. The user can also first select the subcategory from the drop down, key in the subcategory, or type in the subcategory code, as illustrated in FIG. 66;
         1. When the user selects or keys in the subcategory or subcategory code, the category associated to the subcategory will auto populate;
         a. Example: the user keys in CS01 into the business subcategory. Then Public Notices—CS01 will display in the subcategory field and Consumer Services will automatically populate in the category;
         b. Example: the user selects Public Notices—CS01 from a drop down that lists all subcategories tied to the customer, then “Consumer Services” will automatically display in the category field; and
         c. Example: the user selects “Consumer Services” in the category field, then only the subcategories tied to that category will display in the subcategory drop down; and
   d. The user cannot have mismatching business categories and subcategories. Subcategory must be tied to the category.

### 2.2 Order Workflow

1. Create an order for a customer (any order type);
2. The order will show fields for business category and subcategory within the order details;
3. If there is only one business category/subcategory associated to the customer, then it will auto-populate and the user cannot change to a different category type;
4. If there are multiple categories/subcategories associated to the customer, the user will select a drop down that shows all associations to the customer. Category and subcategory will be blank initially to ensure that the user is choosing the correct category, instead of automatically choosing the default; and
5. If the customer needs a new category, the user will add it on the customer profile, not on the order page;
   a. The user can easily connect to the customer page by selecting the customer's name that displays towards the top of the order booking Customer profile will open in new tab; and
   b. As soon as the new category is added and saved, the user will see the addition category/subcategory in the order booking

Print Display:

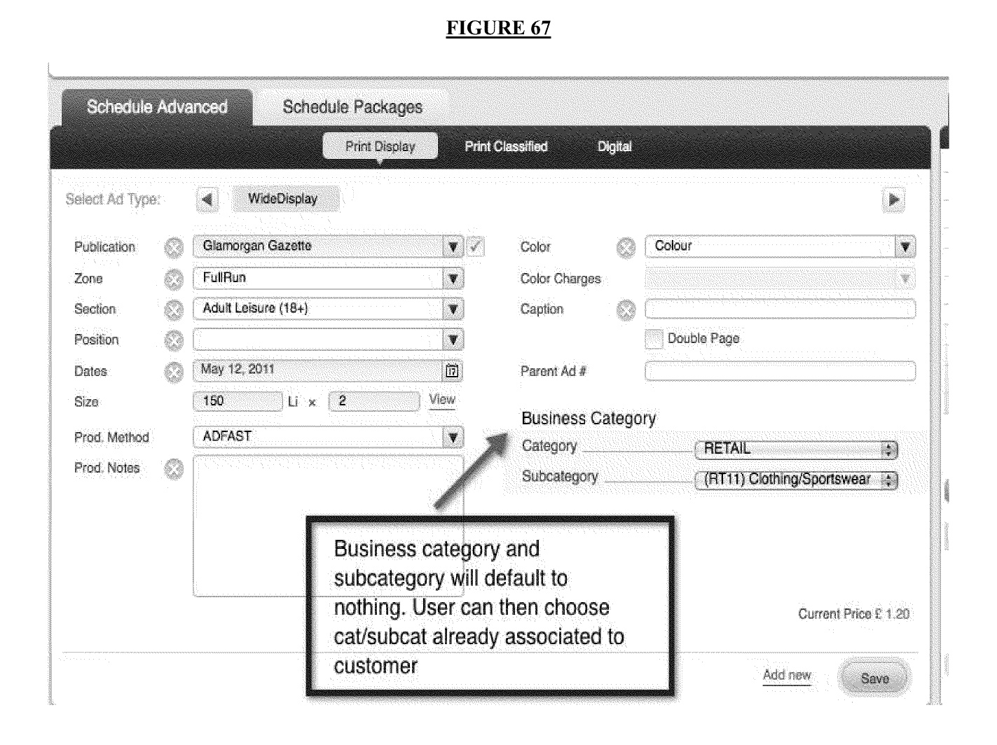

FIG. 67 illustrates an exemplary Print Display step in the business category/subcategory Order Flow process for an order booking regarding Use Case 20.

Print Classified:

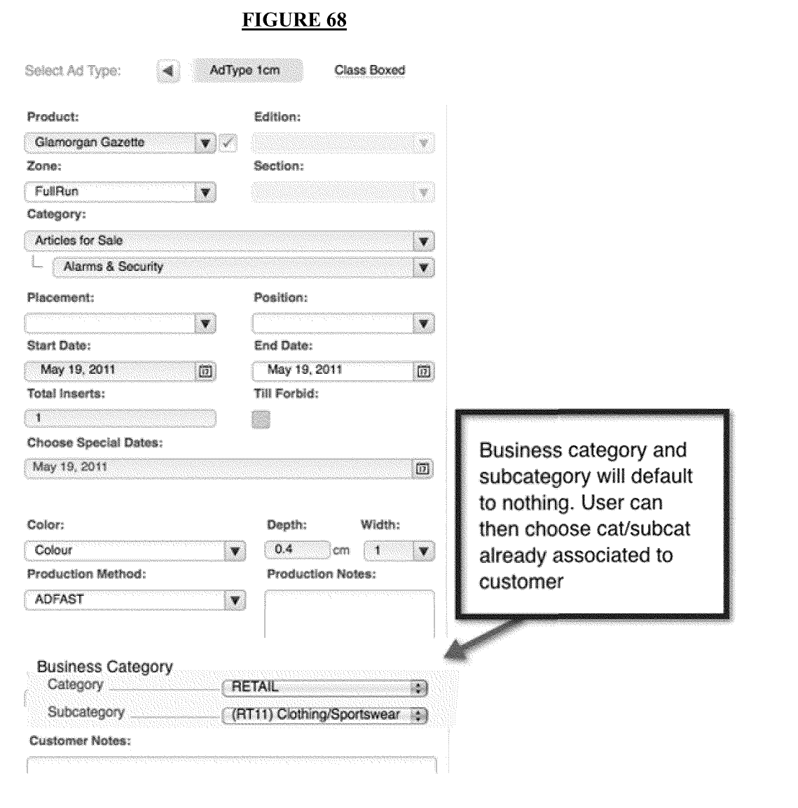

FIG. 68 illustrates an exemplary Print Classified step in the business category/subcategory Order Flow process for an order booking regarding Use Case 20.

Digital:

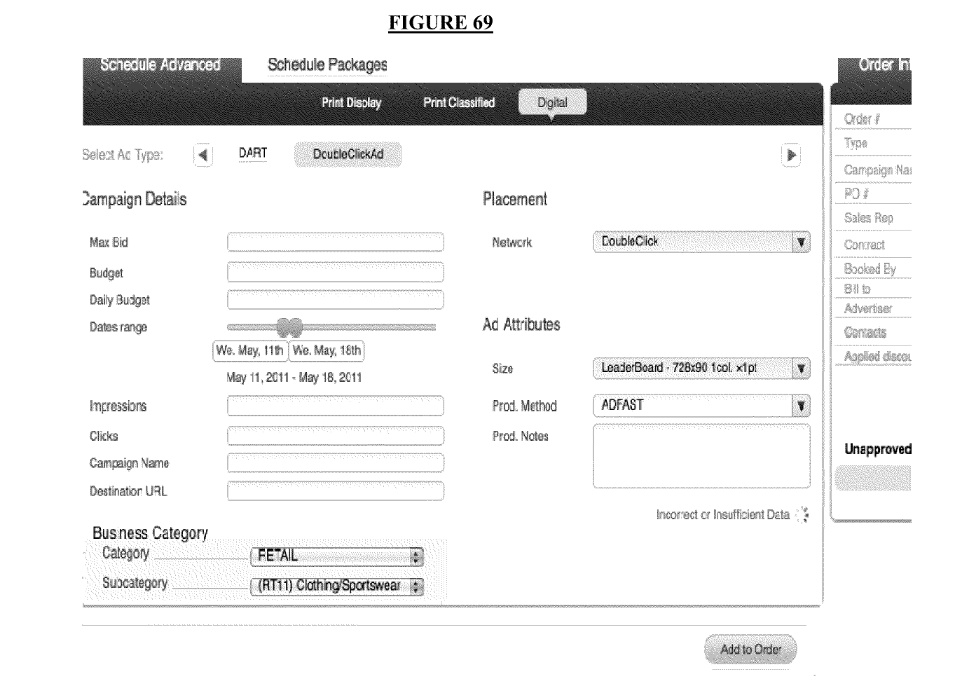

FIG. 69 illustrates an exemplary Digital step in the business category/subcategory Order Flow process for an order booking regarding Use Case 20. 2.3 Recruitment Workflow

1. The user books a Recruitment ad; and
2. The system will automatically populate the business category/subcategory with a recruitment code;
a. If the advertiser does not have a recruitment code tied to the account, the user must access the advertiser's account before continuing with the booking; and
b. If the user does not add a recruitment category/subcategory to the advertiser's account, he cannot book a recruitment ad. The user will receive error message and the system will highlight business category/subcategory fields before he can move on. An error message will say “Please add a recruitment category to the customer's profile before booking a recruitment ad.”

### Use Case 021—Select Multiple Publications at one Time

### 1. Basic Information

| Use Case ID | 021 |
|---|---|
| Description | This Use Case describes how a user can select multiple |
| | publications from the product drop down, without |
| | needing to add to order and then add a new publication. |
| Primary | Booking Agent |
| Actor(s) | Sales Rep |
| Successful Post | 1. The user can select multiple publications from the |
| Conditions | product drop down. |
| | 2. Insertions will update based on the publications and |
| | dates selected. |
| | 3. All order details, including Category, Classification, |
| | and copy, will be maintained across all insertions |
| | during the booking process. |
| | 4. The user can manually adjust the insertion dates per |
| | publication within the calendar tool. |
| | 5. Publications will update if dates are adjusted in a |
| | manner that would not incorporate a particular |
| | publication. |
| Performance | Each click should take less than a few seconds to |
| | respond, depending on the complexity of the click. |

### 2. Flow of Execution

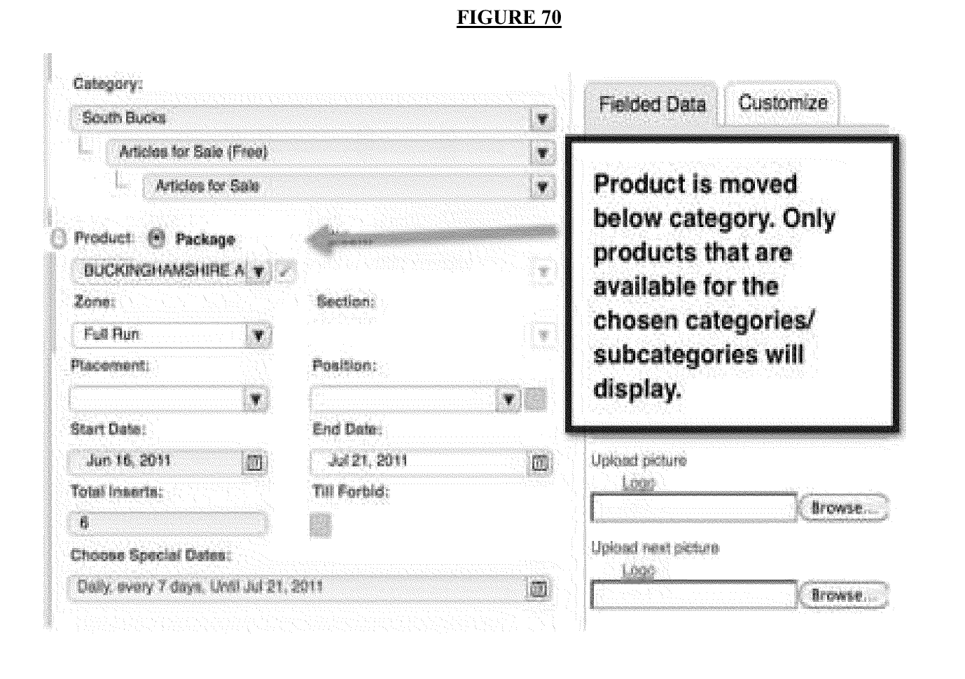

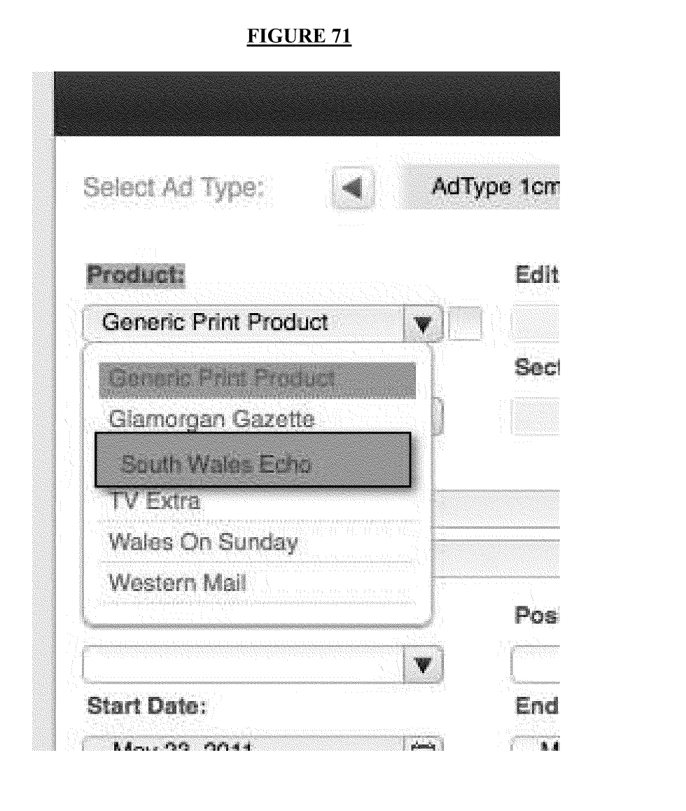

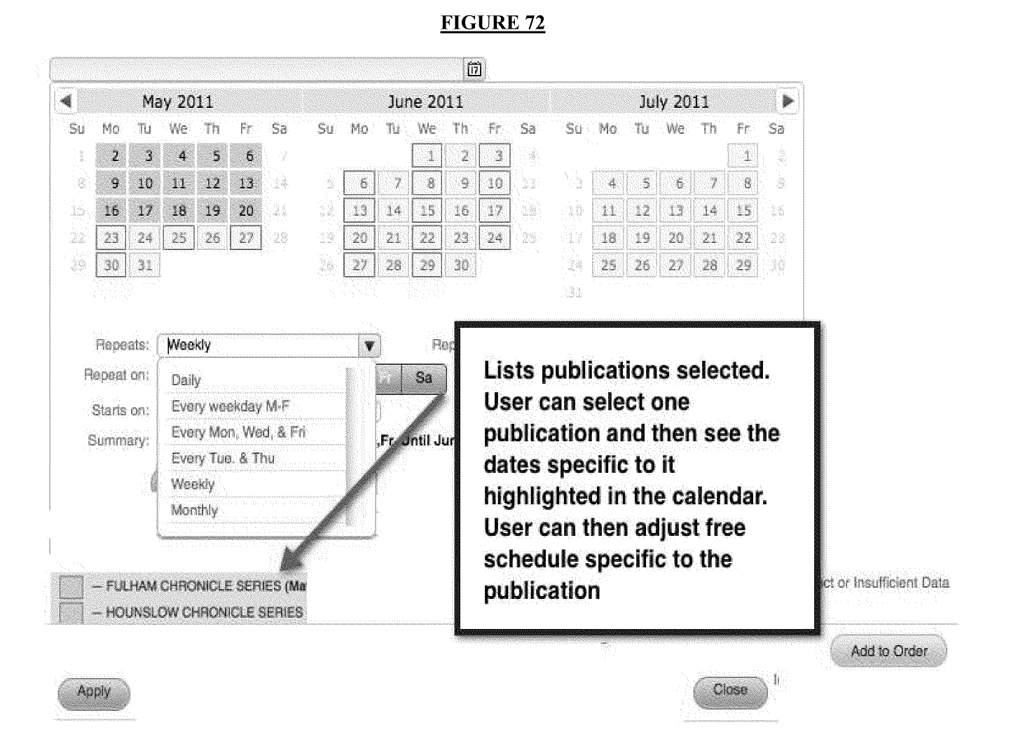

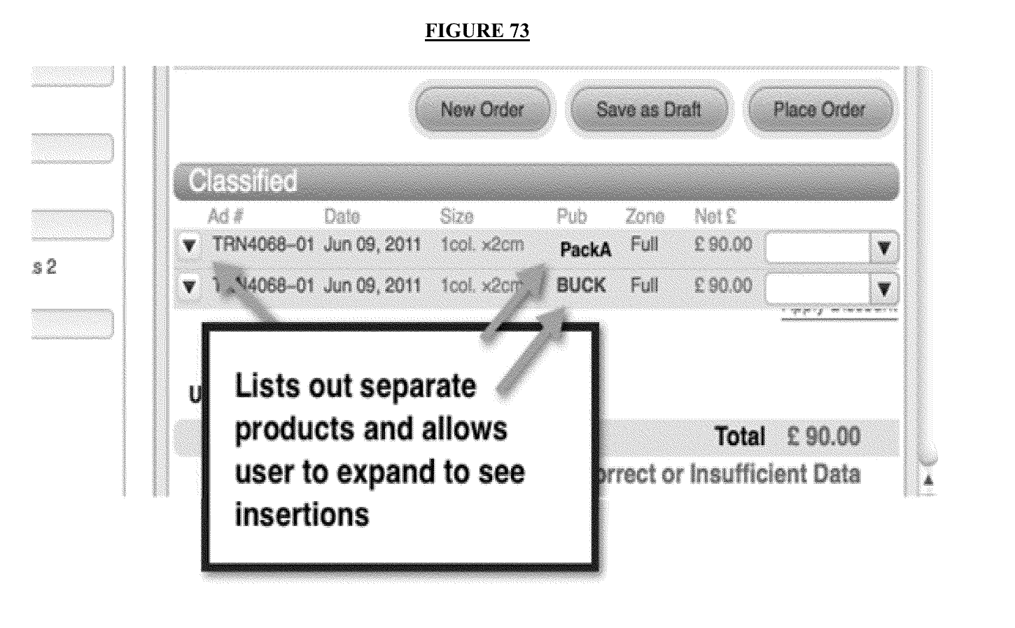

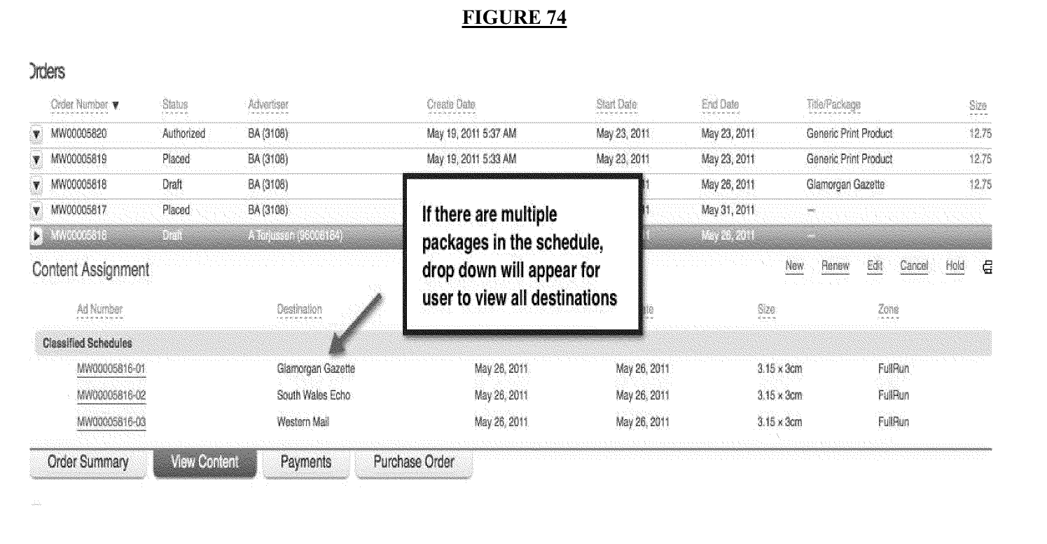

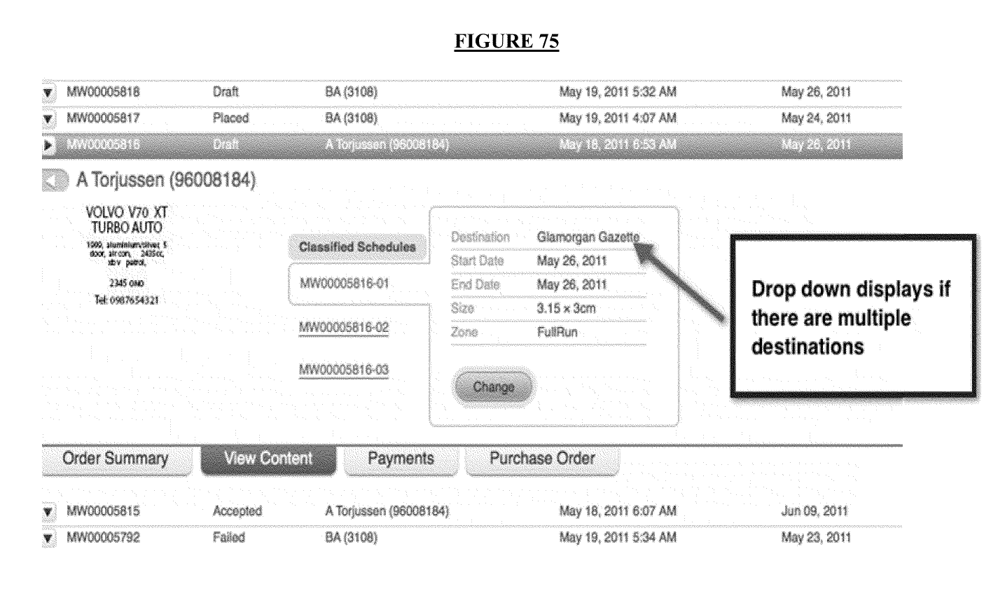

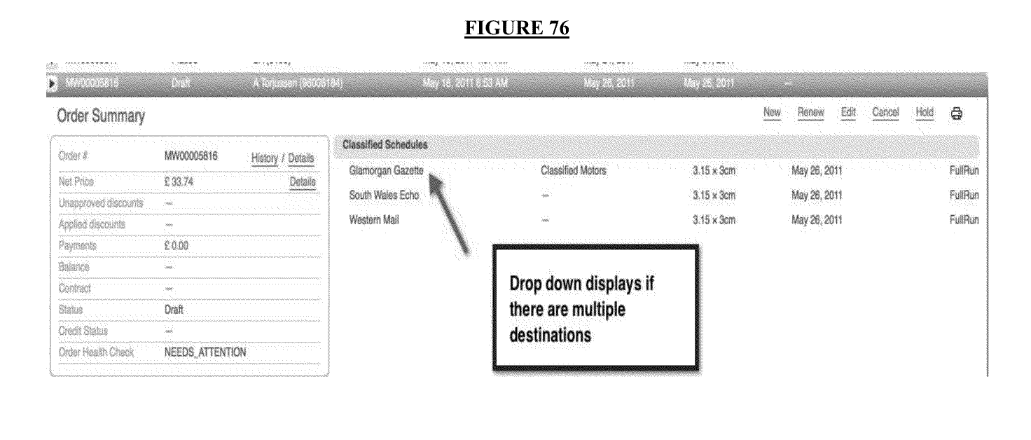

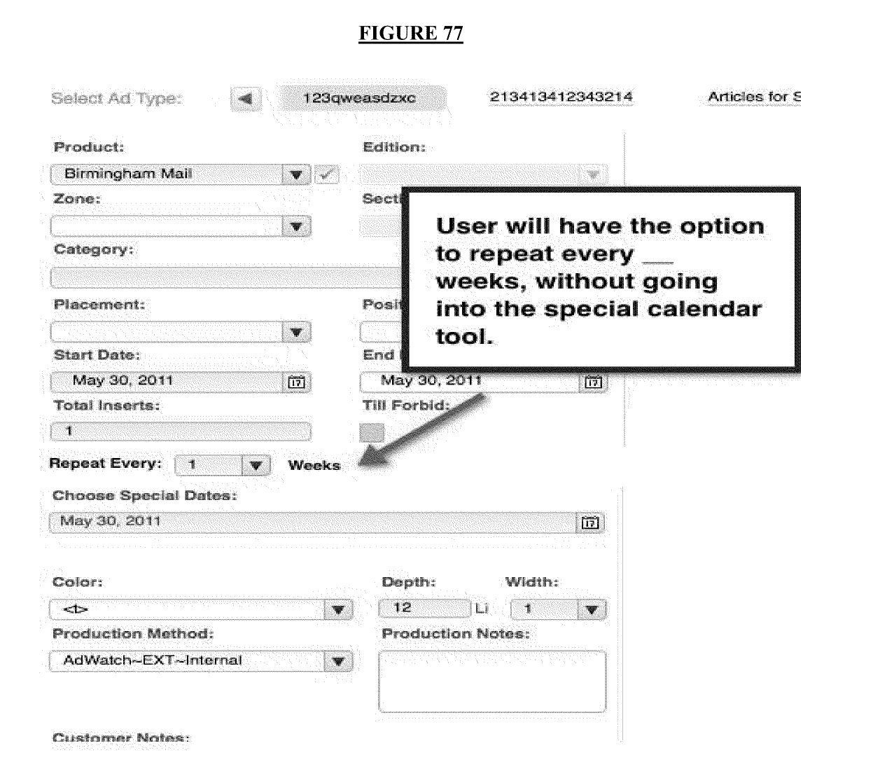

2.1 Change order of fields
1. In the sales component, navigate to book a Print Ad;
2. Ad type will be preselected;
3. The user will first select the category and subcategory(ies);
4. The user will select product. Only products associated to the categories/subcategories will be display as options. The user can still select “My Region” to only display products in that logged-in user's region; and
5. If the user adjusts the category to one that is not compatible with the selected product, product list will refresh, as illustrated in FIG. 70. 2.2 Add multiple publications from publication drop down to run schedule
1. Expand the product drop down;
   a. The user can select one product, hold down the command key, and select other products. All products selected while the command key is held down will be highlighted; and
   The user can select one product, hold down the shift key, and select another product. The user will see the two selected products and all products in between highlighted, as illustrated in FIG. 71. 2.3 Define Insertion Dates
1. The user can select simple dates by defining a start and end date without opening the calendar tool;
   a. All publications selected will default to a single insertion based on the publication's deadline and print date;
   b. The insertion field will be greyed out. The user cannot manually enter insertions when multiple publications are selected since the system would not know how to divide the insertions across the publications;
   c. The user can select an end date and the system will populate the insertions with one insertion per product per run day within a given timeline;
      i. Example: The user chooses a daily paper (Mon-Fri) and a weekly paper (Wed). The user then enters a start date of Monday, May 23^{rd} and an end date of Sunday, May 29^{th}. The system will automatically populate 6 insertions in the insertion field since the daily paper will have 5 insertions and the weekly paper will have 1 insertion;
2. The user can define special dates per publication using the calendar tool;
   i. When the user opens the calendar tool, the start and end date will default based on publications selected (current functionality);
   ii. Similar to Self Service, all publications selected will be listed within the calendar tool so the user will be reminded of what he has selected; and
   iii. In order to adjust dates by free schedule, when the user selects a publication listed, the calendar will only highlight dates specific to that publication. The user can select or unselect dates specific to the publication and the insertions will update accordingly, as illustrated in FIG. 72; and
3. If the user makes a change to dates, price will update to reflect the new number of insertions per products.
   2.4 Publications will update if a user makes adjustments in the calendar tool
1. Select multiple publications, with varying run dates in the product drop down;
2. Select the calendar tool next to “Choose special dates;”
3. Adjust the insertions in a manner that a particular publication is no longer active; and
4. The publication that is no longer active will not display at the bottom of the calendar tool and will not be selected on the booking entry page;
   a. Example: Choose one publication that runs M-F and one publication that runs Wednesday only. Select free schedule. De-select all highlighted Wednesday dates so that no Wednesdays are highlighted. The user will then see the Wednesday-only publication no longer display at the bottom of the calendar tool and not selected on the order entry screen. Insertions then would update based on the highlighted selections of the M-F publication. Price will be updated to reflect this product is no longer selected.
      2.5 The system will recognize a package selection if a user manually chooses all publications that make up that package
1. Multi-select several individual publications in the product drop down;
2. The system will determine if those selected publications, as a whole, create a package; and
3. If the publications create a package, the user will receive the package discount;
   a. Example: drop down contains Package A, Package B, and Publications 1-8;
   b. Package A=Pub 1, 2, and 3;
   c. Package B=Pub 3, 5, 7;
   d. The user manually selects publications 1, 2, 3, and 4 from the drop down;
   e. The system will then recognize the user has actually selected package A+publication 4; and
   f. The system will then apply package rate rules to package A and any individual rates to publication 4.
      2.6 Summary and Dashboard will identify multiple publications
1. Select multiple publications and add to order;
2. The user will see the order summary update to show that there are multiple publications listed. Each publication will be listed as a separate line item;
3. The user can expand each publication line item to see any additional run dates specific to that publication, as illustrated in FIG. 73;
4. When the user views the order detail from the Dashboard, any area that lists the publication will list out all publications when multiple publications are selected, as exemplified in FIG. 74 through FIG. 76. 2.7 Repeat insertions every weeks
   1. Without going into the calendar tool, a user can define how many weeks the selected product(s) and/or packages(s) will repeat;
   2. Although the user can define this within the calendar tool, frequently the user will not need to go into the calendar tool if the user has the ability to adjust the weeks repeated from the main booking screen; and
   3. When the user defines how often the selected product(s) will repeat, insertions and end dates will update (per current functionality in the calendar tool), as illustrated in FIG. 77. (A feature could be developed as a separate request, as a multiple publication selection is not dependent on this feature).

### 3.1 Additional Information

1. When a user selects multiple publications from the product drop down, the insertions across the publications will have the same category, subcategory, position, size, color, content, etc. Apart from the dates, everything on the order-booking screen will be the same per publication. If a user chooses to customize the insertions by applying separate copy, sizes, etc., then he has the option of adding the insertion to the shopping cart and adding a new publication (as per current process);
2. Once an order is booked, the user has the option of making changes to each publication run schedule on an individual basis, by selecting the line item specific to the publication within the order details;
3. There is no limit to how many publications a user can add to one insertion; and
4. The relevant categories/subcategories that are available across all chosen publications can be shown by adjusting the order of the fields so the user first chooses category, then ad type, then product.

### Use Case 022—Agency-Agency Client Relationship

### 1. Basic Information

| Use Case ID | 022 |
|---|---|
| Description | This Use Case describes how agency and agency client |
| | relationships are associated and displayed in the sales |
| | component of MS Sales. |
| Primary | Booking Agent |
| Actor(s) | Sales Rep |
| Successful Post | 1. The user can associate advertiser to multiple agencies |
| Conditions | and agency types. |
| | 2. The user can associate agency to multiple advertisers |
| | with multiple agency-advertiser relationships. |
| | 3. An agency will be the “bill to” when the agency is an |
| | invoicing type. |
| Performance | Each click should take less than a few seconds to |
| | respond, depending on the complexity of the click. |

### 2. Agency Client Profiles

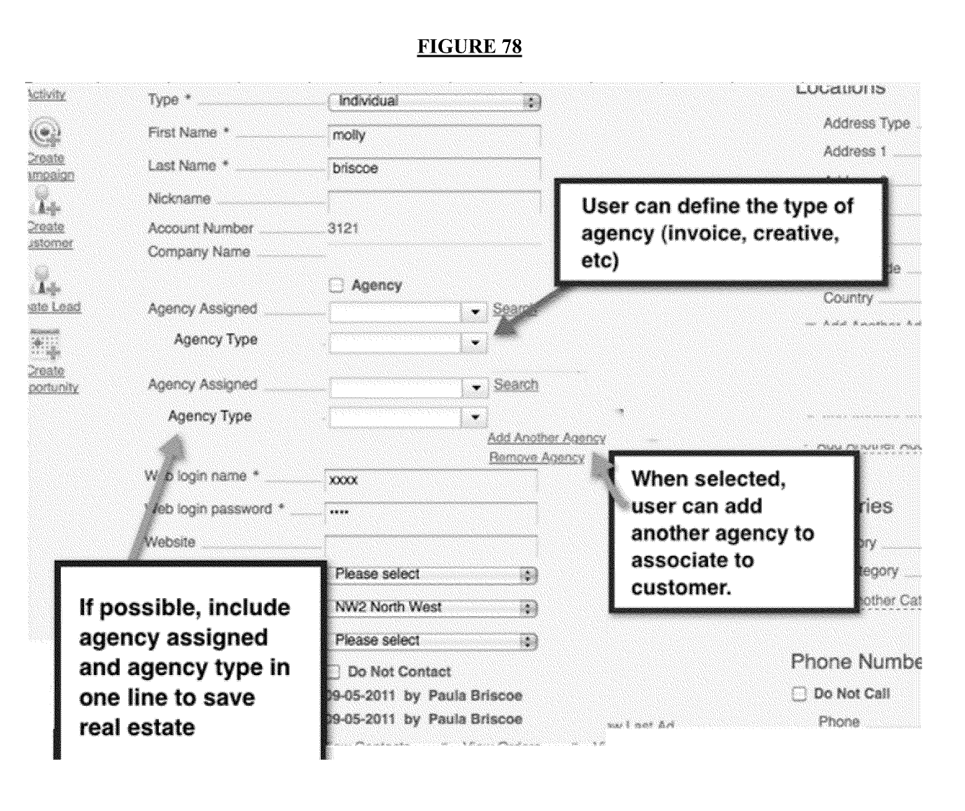

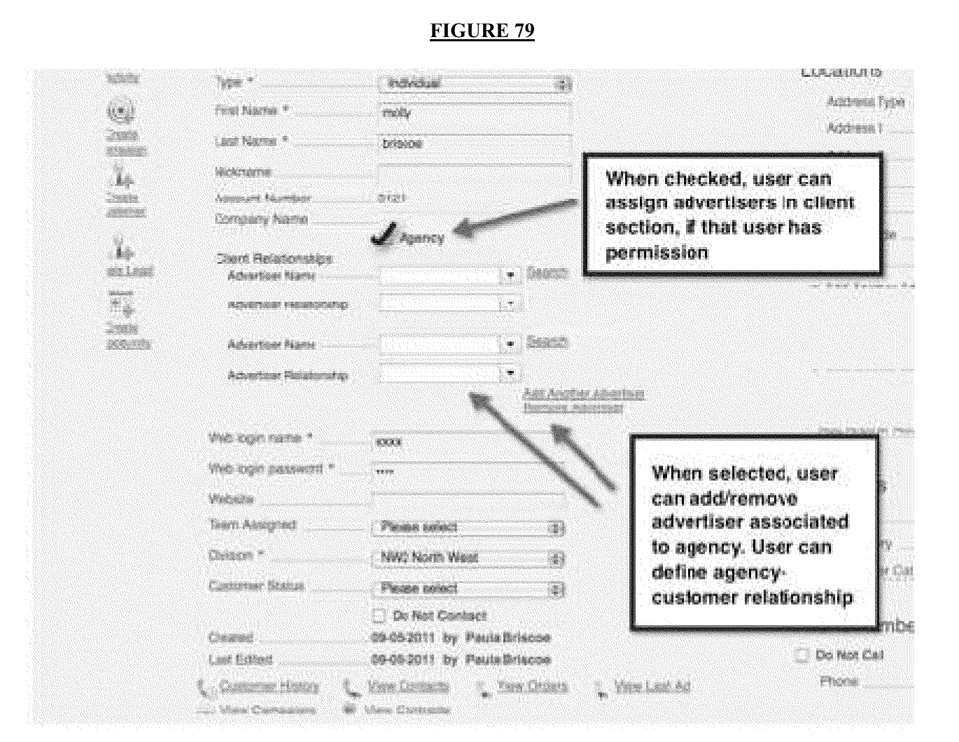

2.1 Agency Client (non-invoicing) can be associated to multiple agencies and multiple agency types
1. Navigate to an advertiser's profile page;
2. The user can define what the “Agency Type” is for each agency assigned to the advertiser;
   a. Agency types are configured by business; and
   b. Examples include Invoicing Agency or Creative Agency;
3. The user can “Add another” agency to the advertiser's account so the advertiser can be associated to multiple agencies, as illustrated in FIG. 78;
   a. When a user has multiple agencies of the same type (such as two invoicing agencies), the user will see a radio button to define a primary invoicing agency. The system will then display the primary agency as the default bill-to in the order information and the user can adjust to a different invoicing agency, if needed; and
4. When an advertiser is associated to an existing invoicing agency, the advertiser profile does not require an address or telephone number since sales users will generally contact the invoicing agency. This information will instead be optional.
   2.2 Agency account profile relationships
1. When on a customer profile, select the “agency” checkbox;
   a. “Agency Assigned” fields will disappear since an agency cannot be assigned to another agency (current functionality);
   b. “Customer Assigned” fields will display so a user (with certain permissions) can associate multiple customers to the agency;
   c. “Advertiser relationship” will display next to each customer assigned so the user can define what the agency's relationship is with each customer;
   d. The ability to add or delete customers associated to an agency will be dependent on the user's role, as illustrated in FIG. 79. Business will be able to define what roles have what permissions; and
   e. When a profile is defined as an agency, the address is not required to save the profile
2. Relationships setup through customer or agency page will stay in sync;
   a. If the user creates/edits/changes an agency or agency type from the customer page, the agency's page will be updated to show the adjusted customer relationship; and
   b. If a user creates/edits/changes a customer or agency type from the agency page, the customer page will be updated to show the adjusted agency relationship.

### 2.3 Invoicing Agency Rules

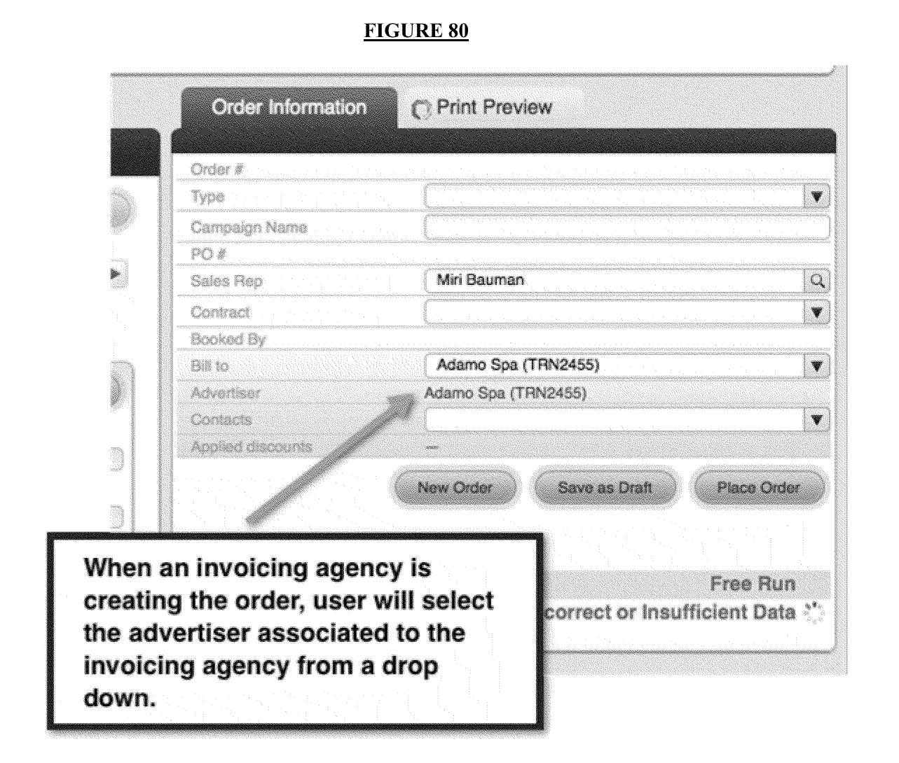

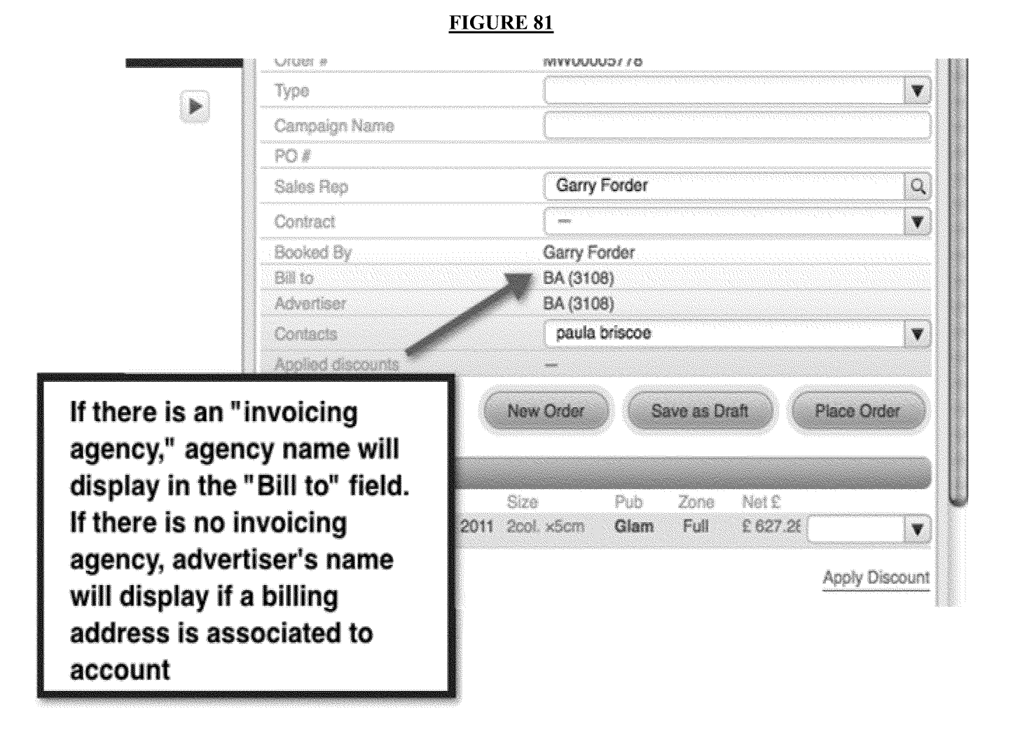

1. When an agency has the agency type of “Invoicing,” that agency has the ability to book ads on behalf of the advertiser;
2. When a user selects ‘advanced booking’ for an invoicing agency, the user will be taken to the booking screen. The user must define for which customer the invoicing agency is doing the booking, before saving the order. The user chooses from a drop down the customer (that is associated to the invoicing agency) for which the order should be booked, as illustrated in FIG. 80;
3. Any other agency type (creative, etc.) can be associated within an order, but cannot book on the advertisers behalf or be the main, billable entity for the order representing the advertiser account;
   a. If that advertiser has any other agency type associated, the booking screen would show a new line item for any agency associated to the advertiser. Underneath the ‘advertiser’ line, a new row would display—Creative Agency: agency name. This would be repeated for all agency types other than invoicing; and
4. When booking an ad for a customer with an “invoicing” agency associated to the customer's profile, the invoicing agency will always display in the “bill to” field. The user can edit the “bill to” drop down to change to either the advertiser itself or a different invoicing agency associated to the account, as illustrated in FIG. 81. Use Case 023—Pricing Refinements

### 1. Basic Information

| Use Case ID | 023 |
|---|---|
| Description | This Use Case describes the pricing and discount |
| | features. |
| Primary Actor(s) | Booking Agent |
| | Sales Rep |
| | Credit Rep |
| Successful Post | 1) The user can view price breakdown from the order |
| Conditions | entry page. |
| | 2) The user can apply a discount at the insertion level. |
| | 3) Cost per insertion will show on the order details. |
| | 4) Payments applied will update on the Dashboard and |
| | payment details screen. |
| Performance | Each click should take less than a few seconds to |
| | respond, depending on the complexity of the click. |

### 2. Flow of Execution

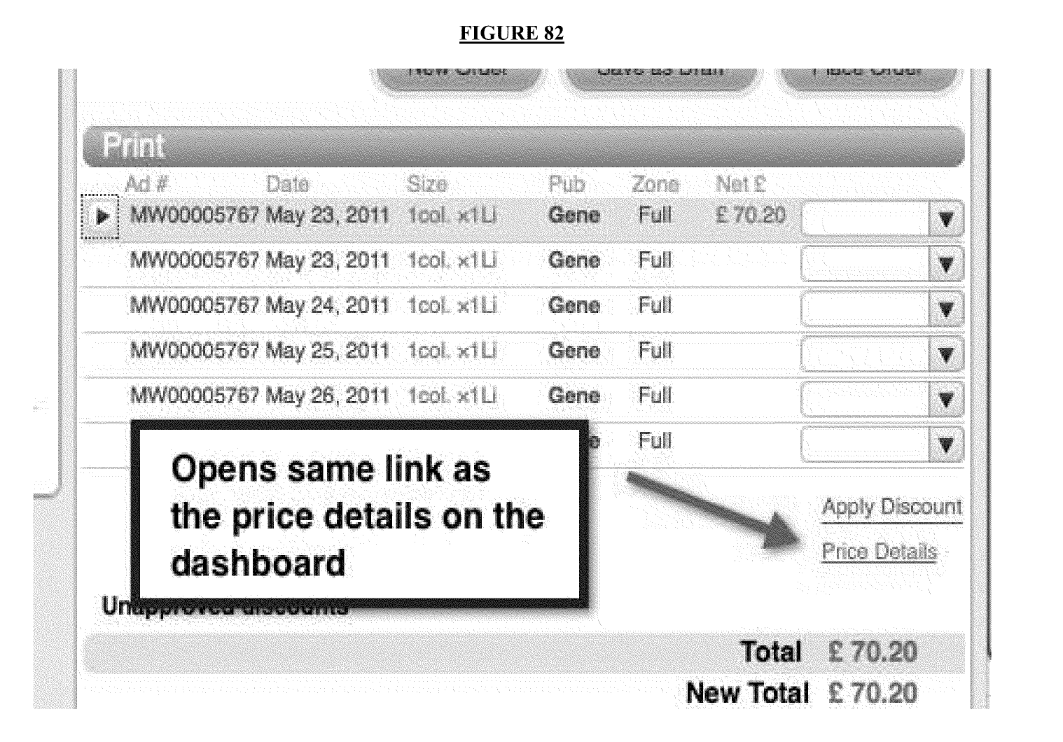

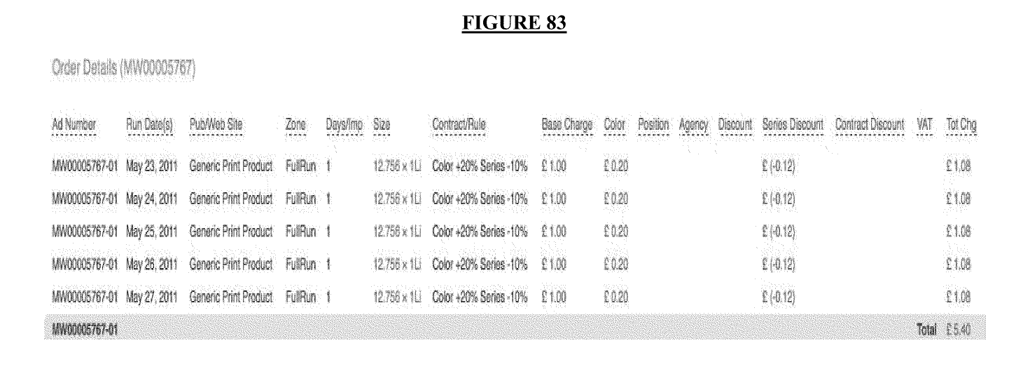

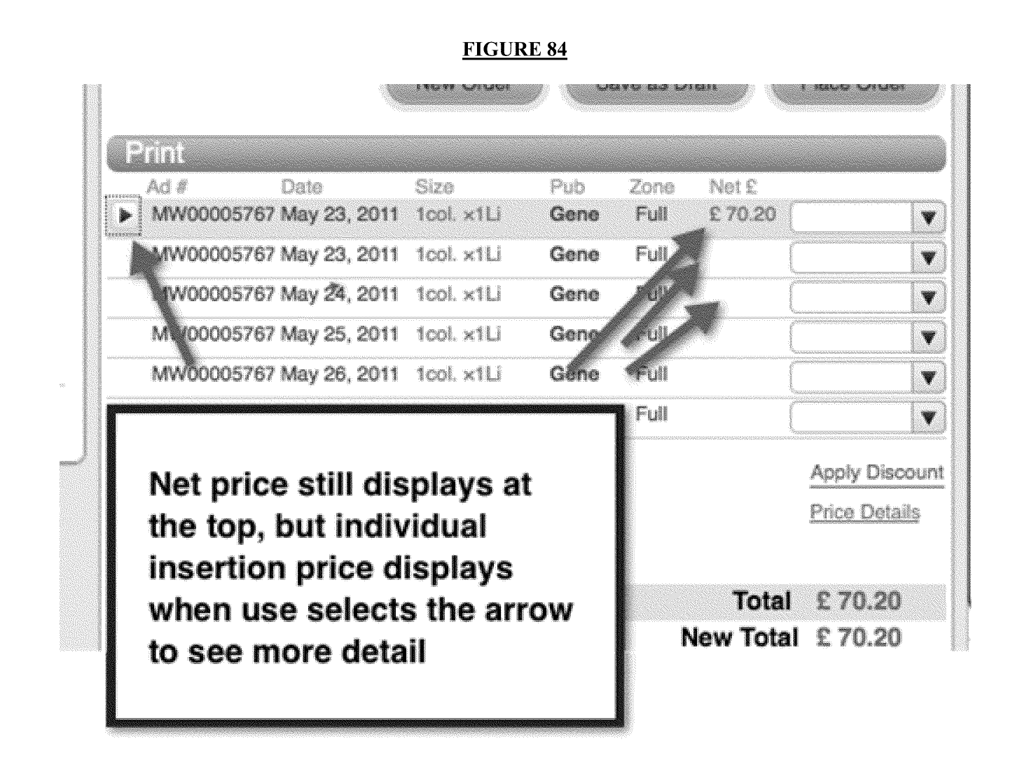

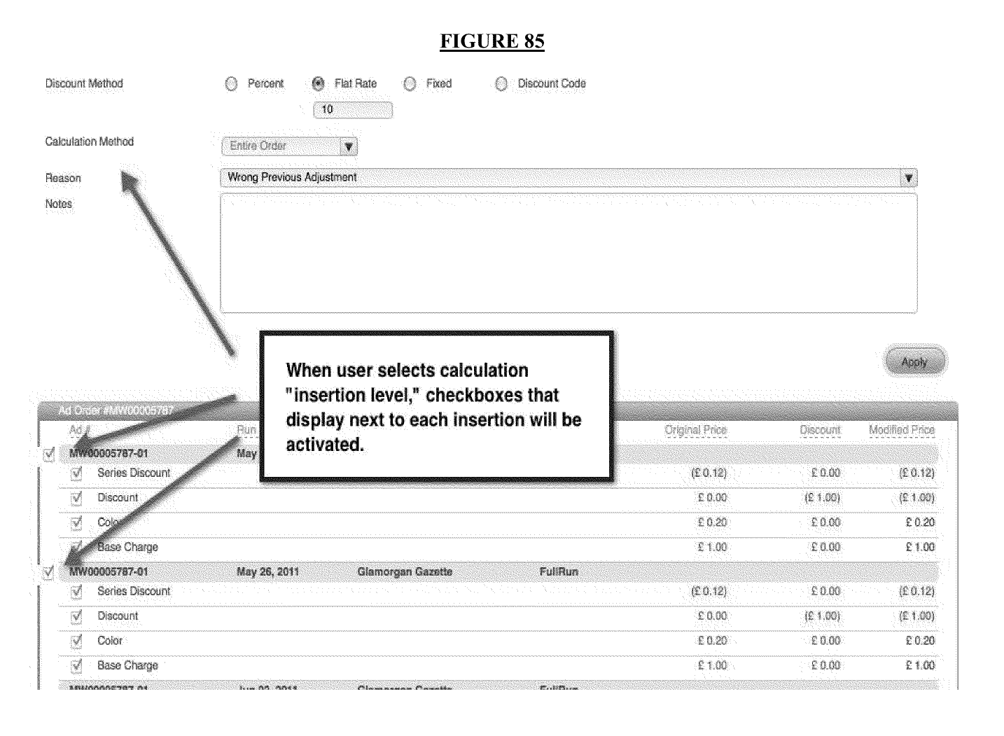

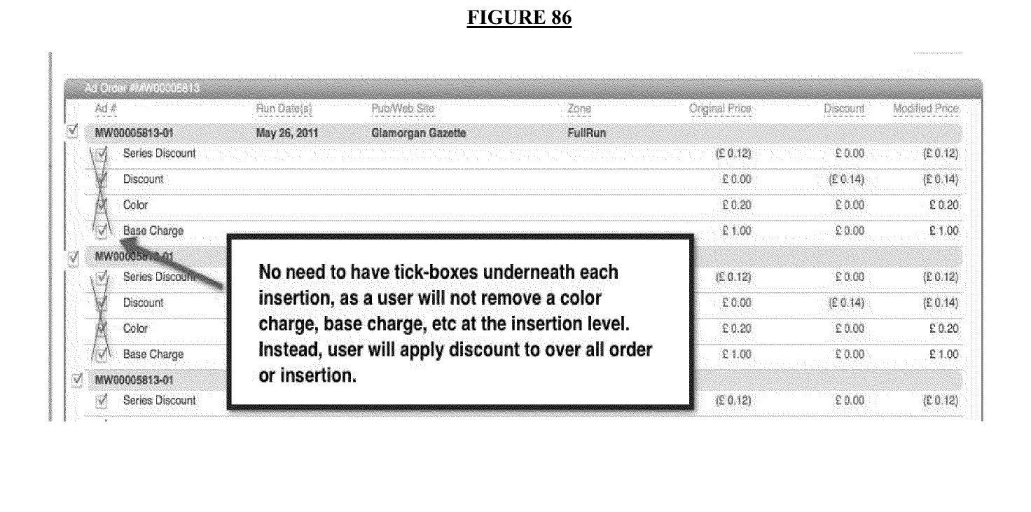

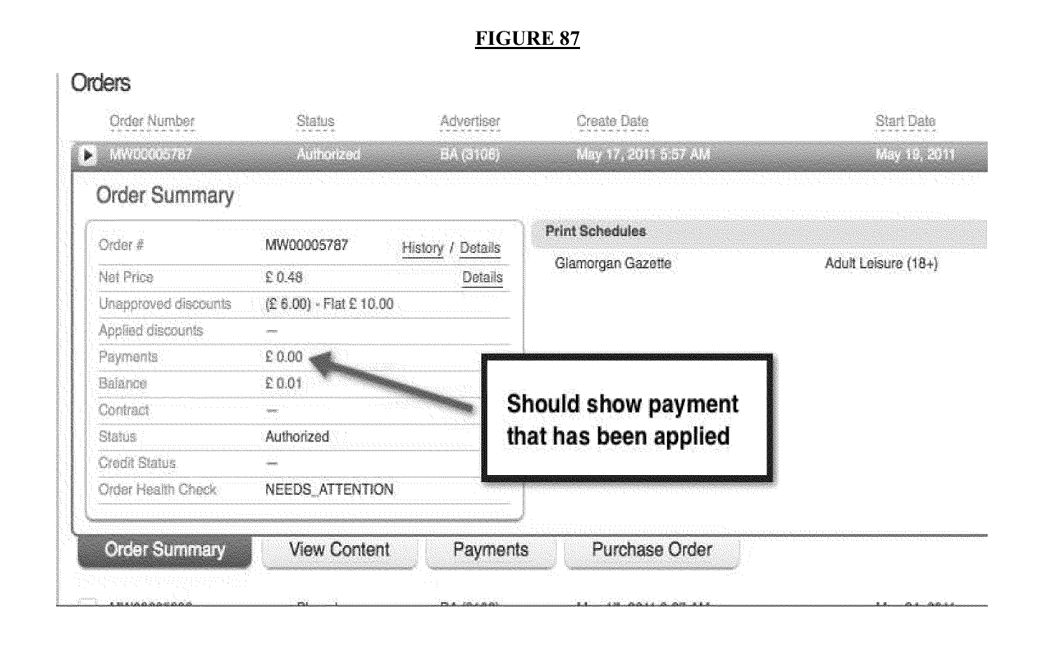

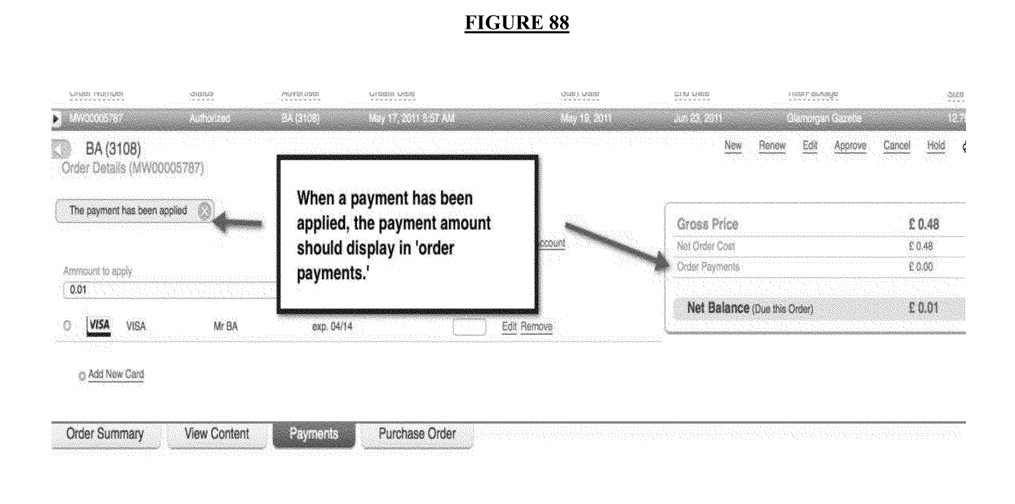

2.1 User can view price breakdown from the order entry page
1) Create an order;
The same link that displays on the order Dashboard to view ‘pricing details’ will display within the order so the user can view the price breakdown without selecting “apply discount,” as illustrated in FIG. 82 through FIG. 83.
   2.2 User can view price breakdown of insertions from order entry page
1) Create an order with multiple insertions;
2) Select the arrow that displays next to the order in the order information screen; and
3) When the individual insertions display, the price of each insertion will show with the total price still displaying on the top, as illustrated in FIG. 84. 2.3 Users with certain permissions can apply discount at an insertion level
1) Create an order with multiple insertions;
2) Select ‘apply discount;’
3) Apply a discount and select calculation method “insertion level;”
4) Checkboxes display next to each insertion and will be auto-checked;
5) If the user un-checks an insertion, then the discount does not get applied to that particular insertion;
Only certain individuals have access to change calculation method to insertion level. Business will define what user roles have this ability through configuration. If the user does not have access, then he will see the calculation method greyed out, as illustrated in FIG. 85; and
6) The individual discounts and charges that display underneath each insertion cannot be checked-off, since a user would not adjust these. Instead, the user would apply a discount to the overall insertion or overall order, as illustrated in FIG. 86. 2.4 Payments applied will update on the payment and Dashboard
1. Create an order;
2. Pay Now;
3. Pay for a portion or for the full amount; and
4. The user should see the amount the user has applied to the order update on the payment details screen and the Dashboard—Payments+Balance=Net Price, as illustrated in FIG. 87 and FIG. 88.

### Use Case 024—Multiple Content Per Run Schedule

### 1. Basic Information

| Use Case ID | 024 |
|---|---|
| Description | This Use Case describes how a user can select any |
| | combination of insertions within one run schedule |
| | and give them unique content id's. |
| Primary | Booking Agent |
| Actor(s) | Sales Rep |
| Successful Post | The sales component should provide the user with a |
| Conditions | means of setting either unique or common |
| | content against insertions, and should clearly display the |
| | booking reference and content id. |
| Performance | Each click should take less than a few seconds to |
| | respond, depending on the complexity of the click. |

### 2. Flow of Execution

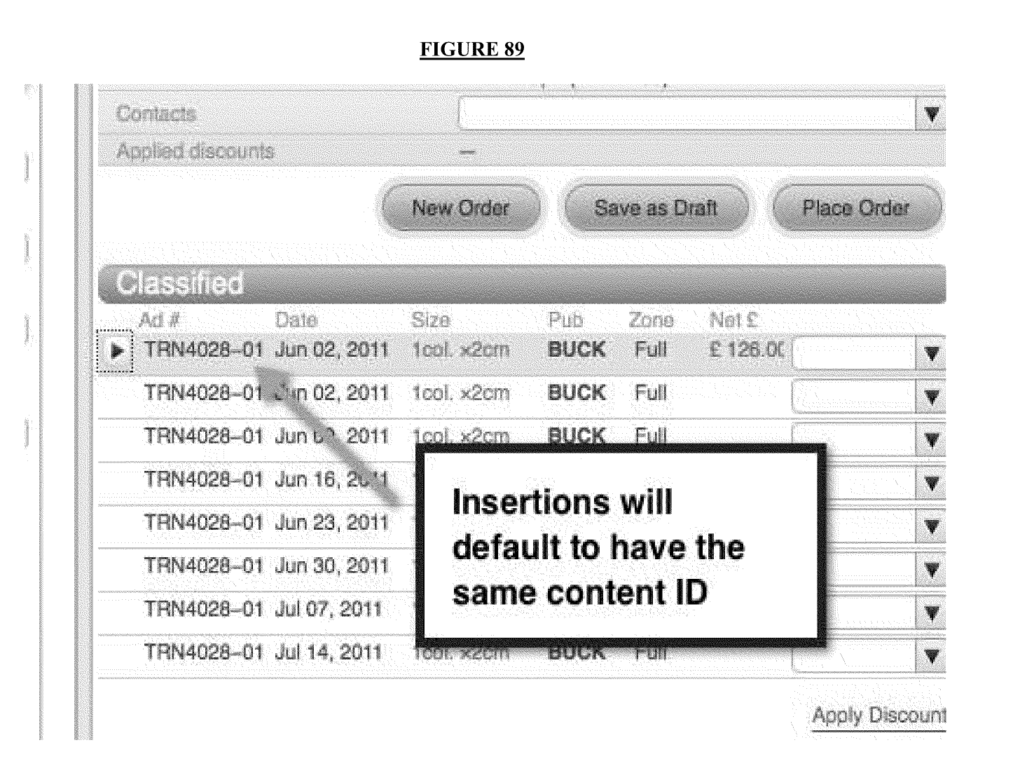

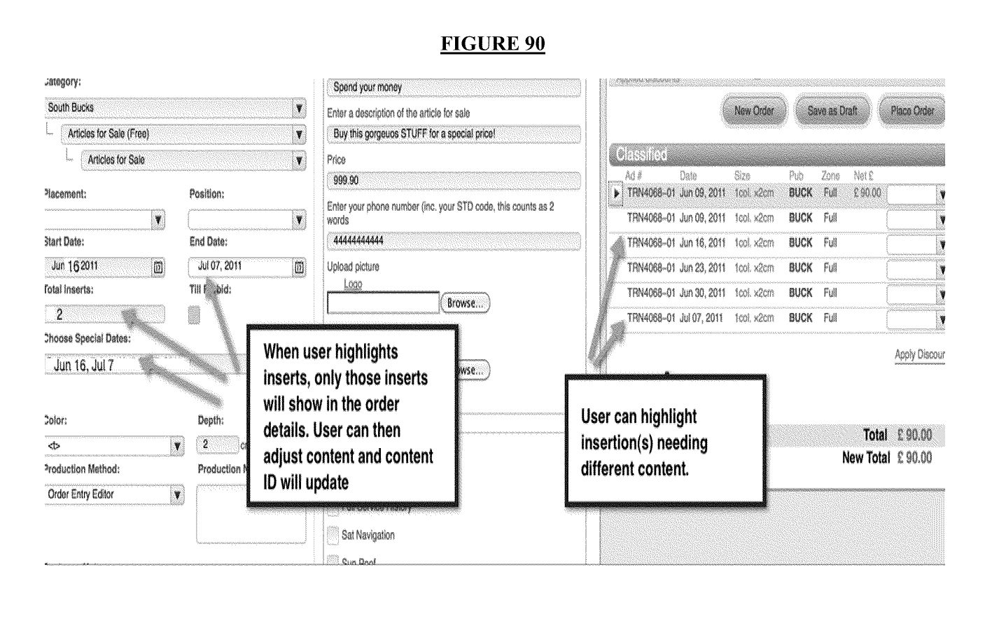

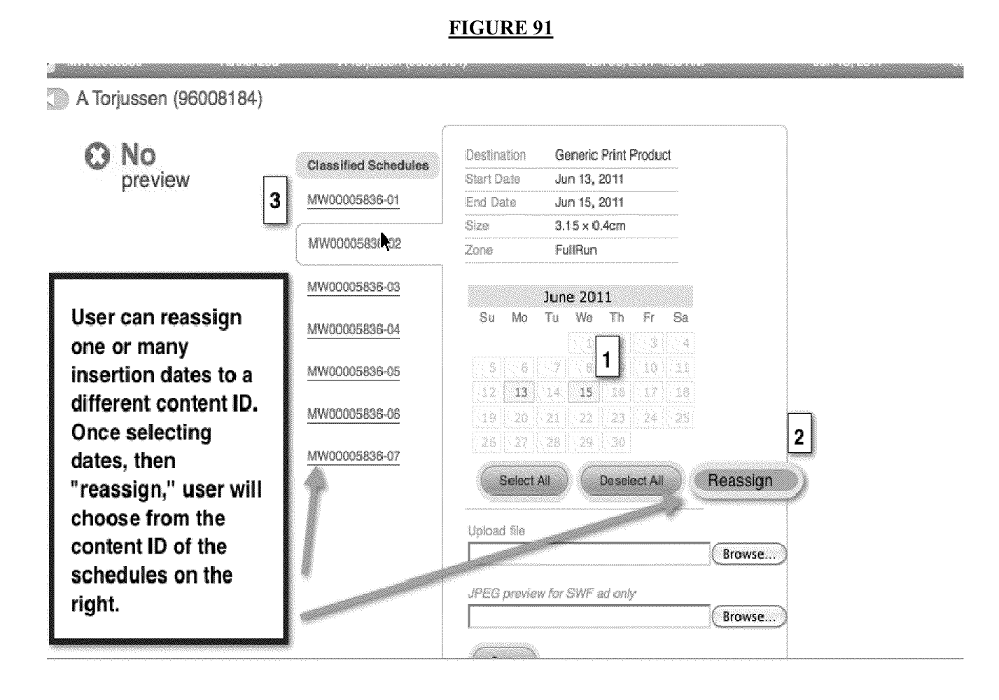

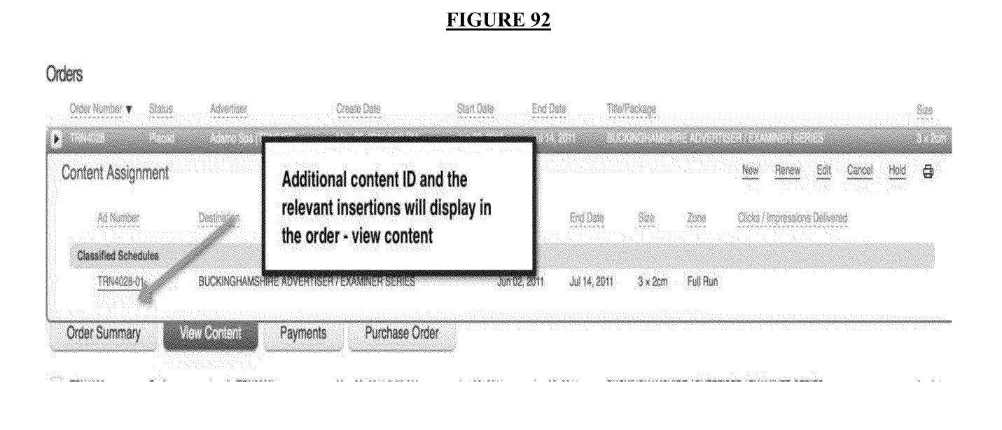

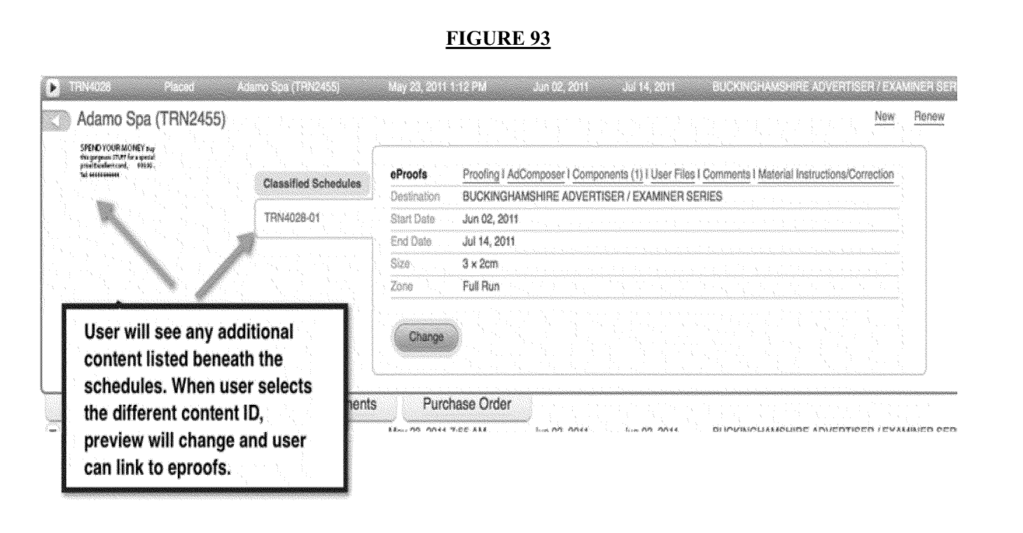

2.1 User can define insertions needing separate content
1) The user creates a booking with several insertions and adds to order;
2) The user determines the insertions cannot all have the same content;
   a. Example: the user is advertising a sale where each insertion must specify the remaining days of the sale, such as 5 days left, 4 days left, 3 days left, etc.;
3) All insertions will default to the same content ID number, as illustrated in FIG. 89;
4) The user can select one or many insertions to define different content for internal production method;
   a. From the order information section, the user selects insertion(s) needing different content;
   b. If the user must select many insertions to change the content, he can select one insertion, hold down the shift key, and then another insertion. All insertions in-between the two selected should be highlighted;
   c. The system will show only those selected insertions in the order details section so the user may update the content of those insertions only;
   d. The user then makes the necessary changes to the content's fielded data, customized data, production method, or ad size;
   e. The user saves changes;
   f. The user then sees the content ID number has been updated for the chosen insertion(s). If the master content ID is TRN4028-01 (for example), then the next saved content ID for that order would be TRN4028-02. If the user can select multiple insertions at once to change the content, then all the content will have the same ID;
      i. Example: Run schedule originally has 5 insertions with same content ID (TRN4028-01). The user highlights insertion 2 and 3, and the user makes edits to insertions' 2 and 3 content. Then the user sees insertions 2 and 3 have content ID (TRN4028-02). The user then selects insertion 4 and makes edits. Insertion 4 then has content ID TRN4028-03. Insertion 1 and 5 will still have ID TRN4028-01; and
   g. If the user adjusts the insertion in a manner that changes the price, such as color, borders, etc., then the price of the insertion and overall order will be updated, as illustrated in FIG. 90. Other insertion prices will not change. The user can select one or many insertions to define different content for ads with an external production method;
a. On the Dashboard, the user selects view content;
b. Current functionality allows the user to select existing dates and add new content, which then creates a new content ID; and
c. The user needs ability to reassign a date from one content ID to an already existing content ID;
   i. Example: Customer creates an order with 3 run schedules;
   ii. Customer has different content for schedule 1, 2, and 3;
   iii. Half-way through run schedule 3, the customer decides the content should go back to the content in run schedule 1; and
   iv. The user should be able to select the dates applicable from run schedule 3, select reassign, and then highlight run schedule 1 to utilize that run schedules content, as illustrated in FIG. 91; and
6) The user cannot edit the content ID of an insertion where the publication deadline has past. If the user is viewing an order where a portion of the insertions have past the publication deadline, the insertions in the past will have their checkbox to change the content greyed out.
   2.2 Summary Pages will identify insertions with separate content
1) Book an order that has a different content ID assigned to different insertions;
2) View the order form the Dashboard;
3) Navigate to “view content.” The user will see different content ID listed for the user to select, as illustrated in FIG. 92;
4) Select a new content ID; and
The user will see the preview of the content and can also link to eProofs with the selected content ID, as illustrated in FIG. 93.
4.1 Additional Information
   a. If the customer wishes to revert either a single or all insertions back to the original, i.e., 12345678-01:
      i. For an internal ad, the user can manually update the content to what was in the original insertion; and
      ii. For an external ad, the user can reassign the content to the original content ID.
         Use Case 025—Select Packages within Order Print Screen

### 1. Basic Information

| Use Case ID | 025 |
|---|---|
| Description | This Use Case describes how a user can select a package of |
| | products within the order booking screen |
| Primary | Booking Agent |
| Actor(s) | Sales Rep |
| Successful | 1. Packaged products can be selected within the order |
| Post | booking |
| Conditions | 2. Packages can be set to have a primary product or primary |
| | date. |
| | 3. Package will receive a discount price. |
| | 4. Package price will update as the user changes package |
| | parameters and breaks the package rules. |
| | 5. The user can update package details within calendar tool. |
| Performance | Each click should take less than a few seconds to respond, |
| | depending on the complexity of the click. |

### 2. Flow of Execution

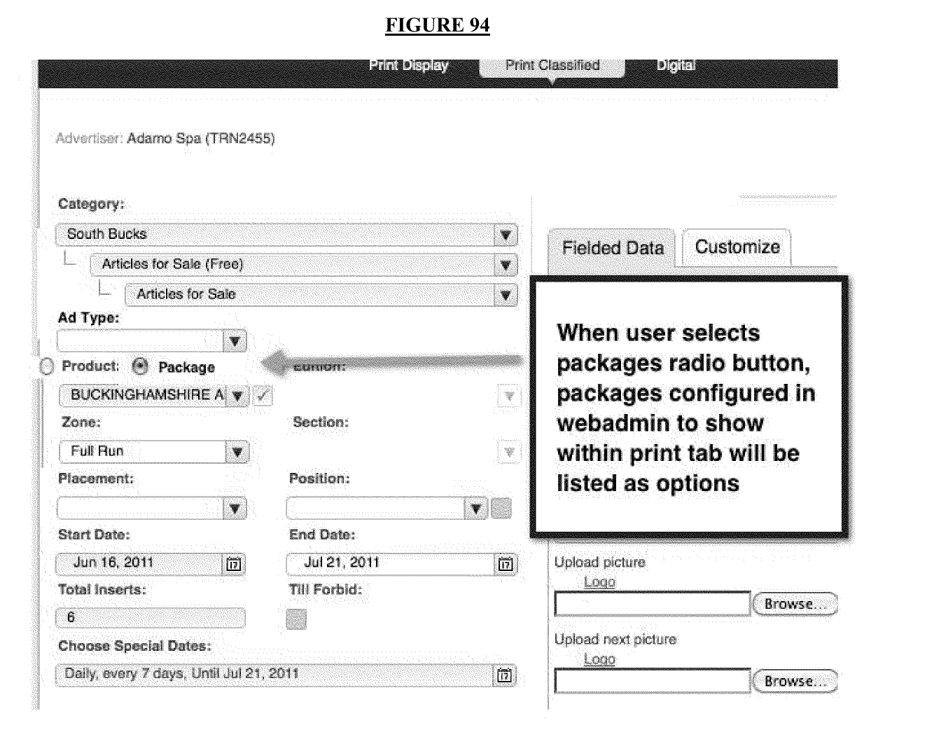

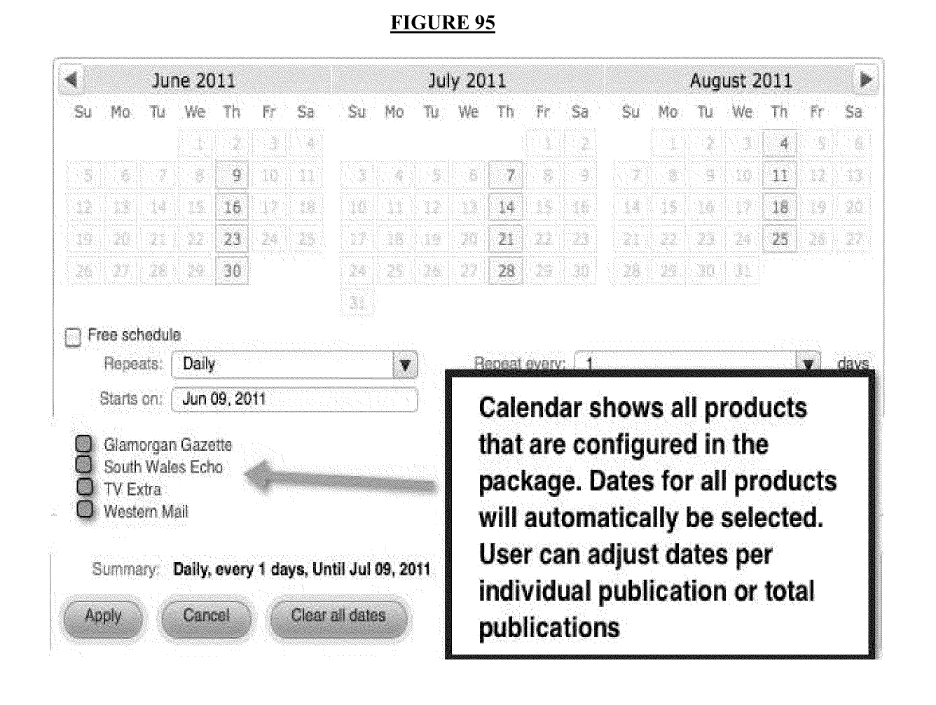

2.1 For setup purposes, a new package type will be created that allows for editing
1) Sales component package types are different than self service package types since the sales component allows much more flexibility. To clarify this for setup purposes, packages in the sales component will be a different package type that allows for more editing;
   a. Each publication within a package type B is a separate line item in the order information and Dashboard. As an order is edited in a way that removes a publication, the publication will no longer be listed in the order information/Dashboard;
   b. Each package type B has its own rule set; and
   c. Once the user edits the package type B in a way that breaks the package rule set, then the pricing rule will adjust.
      2.2 User can select a package of products in the order booking
1) Create a new order;
2) The user will see a new radio button to choose a package of products next to the listing of single products; and
3) When the user selects the “package” radio button, only packages defined as package type B will display in the drop down, as illustrated in FIG. 94;
   a. Package type B consists of packages created differently than packages in Self Service. The content of these packages defines the price. Each package has its own rule set.
      2.3 Packages will display based on the chosen category and/or subcategory
1) The administrator can associate a package with a specific category or it can be available with several categories;
   a. Example: Package A is associated only with the Motors category and Servicing Subcategory. Package B is associated with only the Motors category but not any subcategory. Package C is associated with the Motors, Property, and Articles for Sale categories;
2) The user selects creates a new order;
3) The user selects category/subcategory;
4) The user changes the radio button to select a package instead of individual products;
5) Only packages that are tied to the category/subcategory will display as options in the package drop down;
   a. If the user tries to change the category/subcategory after choosing the package, the system will check to see if the new category/subcategory are associated to the package; and
6) Edition and Zone will be grayed out so the user cannot adjust, as these fields will be defined based on the package and cannot be edited in the user interface.
   2.4 User can edit package dates through the calendar tool
1. The user can define special dates per publication using the calendar tool;
   a. When the user opens the calendar tool, start and end date will default based on publications selected (current functionality);
   b. All publications contained in the package selected will be listed within the calendar tool individually;
   c. In order to adjust dates by free schedule, when the user selects a publication listed, the calendar will only highlight dates specific to that publication. The user can select or unselect dates specific to the publication and the insertions will update accordingly; and
   d. If a user deselects a date that breaks the package instance rule, then the package instance will be broken and priced without the package discount, as illustrated in FIG. 95.

### 2.5 Fixed or Flexible Start Dates

1. It must be possible to configure start dates as either fixed or flexible, based on deadlines and package rules;
   i. If a package has a fixed start day, the start date will always default to the defined start day of the week, based on deadline;
      i. Example: if a package has a start day of Monday, when the user selects the package, start day will auto-populate as the next available Monday where the booking deadline has not passed; and
   ii. If a package has a fixed start day, the user can only change the start date to one on the specified day;
      i. Example: if a package has a start day of Monday, when the user changes the start date, he can only choose a Monday date. If the user chooses a different day of the week, he will receive an error message that “Chosen start date is not available for that package.”

### 2.6 Primary Product

1. It must be possible to define a publication as the Primary publication within the package, and no other publication within the package can be published before the Primary publication, irrespective of booking date or day;
   a. Example: The user books package A, which includes a daily product, a Wednesday product, and a Sunday product. The Sunday product is listed as the primary publication in WebAdmin. When selecting the package, the start date will default to the next available Sunday; and
   b. If the user manually edits the start date to Monday, the start date will auto-adjust to the next Sunday and display a message to the user that “Chosen start date is not compatible with this package's primary product.”
      2.7 Insertions in one instance of a package can be deleted in the calendar tool or canceled without impacting other instances of a package
1. Individual Package bookings can span multiple weeks, and may be repeated multiple times within one booking To ensure insertions can be cancelled in one package instance without affecting insertions in additional package instance, it must be possible to configure each package in a way that will allow the individual insertions to be linked to each separate instance of the package;
   a. Example:
      i. Package B is a single publication package with 6 insertions Monday to Saturday; the first 4 insertions are charged at rate card with insertion 5 & 6 Free. It has no fixed first day insertion rule, therefore, the package start date can be booked for any day. In this example the first insertion is booked for a Wednesday, so the booking will span 2 weeks;
      ii. If the package is selected to repeat 2 more times, then the booking will span 4 weeks with weeks 2 and 3 containing multiple instances of the package. So, in weeks 2 and 3 it must be possible to differentiate between insertions 5 and 6 of one package and insertions 1 to 4 of the next package, to ensure a cancellation of an insertion in one package does not adversely affect the insertions in the other package;
      iii. If the user cancels the Friday insertion of week 2, then the Saturday Ins4 for week2, Monday Ins5 for week2, and Tuesday Ins6 for week2, insertions must revert to full rate card or be cancelled. However, the insertions in Package instance week 1 and 3 will not be affected; and
      iv. Package instance week 1 and 3 would remain in tact, but any remaining insertions for week 2 would be shown as an individual product and not as a package.

| Package B | Mon | Tues | Wed | Thur | Fri | Sat |
|---|---|---|---|---|---|---|
| Single title | | | Ins 1 | Ins 2 | Ins 3 | Ins 4 |
| | | | wk 1 | wk 1 | wk 1 | wk 1 |
| | | | Paid for | Paid for | Paid for | Paid for |
| | Ins 5 | Ins 6 | Ins 1 | Ins 2 | Ins 3 | Ins 4 |
| | wk 1 | wk 1 | wk 2 | wk 2 | wk 2 | wk 2 |
| | FREE | FREE | Paid for | Paid for | Paid for | Paid for |
| | Ins 5 | Ins 6 | Ins 1 | Ins 2 | Ins 3 | Ins 4 |
| | wk 2 | wk 2 | wk 3 | wk 3 | wk 3 | wk 3 |
| | FREE | FREE | Paid for | Paid for | Paid for | Paid for |
| | Ins 5 | Ins 6 | | | | |
| | wk 3 | wk 3 | | | | |
| | FREE | FREE | | | | |

### 2.8 Package Pricing

1. Package discounts are reliant on the integrity of the package, therefore, if any insertion within the package is cancelled and that cancellation breaks the package rule, then all remaining insertions must either be cancelled or have full rate card applied;
2. If a user cancels any paid-for insertion within a package, any remaining paid-for or free insertions will be charged at full rate card. All prior insertions that are billed or closed must remain at the price originally quoted, i.e., “locked;”
3. Series discounts can be based on a number of publications configured as a package. The discount can be applied to any or all insertions within the package, and also at any time within the run. Therefore, insertion-based packages are required;
4. Fixed price packages are defined as a series of insertions where the total charge is attached to the first insertion, and the remaining insertions within the package instance are all discounted at 100%;
   a. These are typically used in Private bookings were no discount is offered after the first insertion;
   b. Fix price example:
      i. The objective is to collect the full charge for the booking even if the order is cancelled midrun. Therefore, the total revenue will be collected on the first insertion so that any subsequent insertions can be cancelled without affecting the charge for the package, i.e. 100% revenue collected on the first insertion (even if multi-titles) and all subsequent insertions/titles are FREE and reported as volume with no revenue attachment; and

| | | | | | | |
|---|---|---|---|---|---|---|
| Package C | Mon | Tues | Wed | Thur | Fri | Sat |

| | | | |
|---|---|---|---|
| One title | Ins 1 | Ins 2 | Ins 3 |
| 1 + 2 FREE | Paid for | Free | Free |
| | £30 | | |

5. Packages should default to a ‘price protected’ status, but it must be possible to configure the package to enable a manual price override.

### 2.9 Additional Package Examples

Each package has its own rule set. When a package is edited in a way that breaks the rule set, then the pricing discount will no longer apply. However, some packages can be edited in ways that do not break the rule set. The following are examples:
1) Package rule requires all publications;
   a. Package 1 requires publications A through F to be receive package discount. If within the calendar tool, the user deselects all of the dates for one or more publications so that the publication is no longer part of the run schedule, then the package will be broken and regular pricing rules will apply. Order information and calendar tool will no longer show the deselected publication(s);
2) Package rule requires x number of insertions across a range of publications;
   a. Package 2 requires 10 insertions across 2 publications. In this scenario, the user can edit the dates per publication, but must have 10 insertions in some combination across 2 publications. The user can have 9 insertions for pub A and 1 for pub B. If the user breaks the rule so he does not include both publication and/or 10 insertions, then the package rule is broken and regular pricing applies;
3) Package rules requires x number of insertions per package instance;
   a. Package 3 requires 7 insertions per week. The user repeats package for 10 weeks, but then cancels the Wednesday insertion of week 10. The package rules will apply to the first 9 instances of the package, but instance 10 has broken the package rule so regular pricing will apply to week 10 only;
4) Package has primary product;
   a. Package 4 has products A-E, with product A being the primary product. Product A will always be the first product to run. If the user removes all dates of the primary product through the calendar tool, then the package will be broken and regular pricing will apply to the remaining products and dates; and
5) Package has fixed start date;
   a. Package 5 has a fixed start day of Monday. The start date will always default to the defined start day of the week, based on deadline. When the user changes the start date, he can only choose a Monday date. If the user chooses a different day of the week, he will receive an error message that “Chosen start date is not available for that package.” The user can adjust the dates within the calendar tool, but the start date will always populate with the first highlighted Monday.

### Use Case 026—Salesforce Integration

### 1. Basic Information

| Use Case ID | 0026 |
|---|---|
| Description | This Use Case describes how data can be passed between |
| | Salesforce and the sales component of MS Sales, |
| | and how data will be synchronized. |
| Primary | Salesforce user |
| Actor(s) | MS Sales user |
| Successful | Appropriate data is sent from Salesforce to MS Sales. |
| Post | Appropriate data is sent from MS Sales to Salesforce. |
| Conditions | MS Sales and Salesforce data is synched. |
| Performance | Each click should take less than a few seconds to respond, |
| | depending on the complexity of the click. |

### 2. Flow of Execution—URL

Integration - Salesforce Originated Ad Booking Process Specifications

| Process Step | Source | Target | Comments |
|---|---|---|---|
| 1 - New Booking or | Salesforce | MS Sales | When a Salesforce user clicks the “Make Booking” button on an |
| Proposal Notification | | | opportunity record, a URL will be provided containing the Salesforce |
| | | | parameters, including: |
| | | | Salesforce Opportunity ID; and |
| | | | Salesforce Customer Account ID. |
| | | | MS Sales booking page will open in a separate browser tab or window. |
| | | | Salesforce will remain open in a separate browser tab or window. |
| 2 - Match Account | Salesforce | MS Sales | MS Sales logic will match the account linked to the Salesforce |
| | | | opportunity utilizing the account ID. After a match is found, MS Sales |
| | | | will open a new booking record containing the Account Information |
| | | | within the Order Information Section. |
| 3 - Save MS Sales | MS Sales | MS Sales | The user enters booking information and saves it in MS Sales as a |
| Proposal or Booking | | | booking or proposal. |
| 4 - Link from MS | MS Sales | Salesforce | While on a customer account record within MS Sales, the user will see a |
| Sales to Salesforce | | | “Salesforce Record” button. When selected, Salesforce will open in a new |
| | | | window or browser tab and take the user to the specified account. |

### 2.1 Flow of Execution—Webservices Synchronization

Integration - Salesforce Originated Ad Booking Process Specifications

| Process Step | Source | Target | Comments |
|---|---|---|---|
| 1 - Send New Proposal | MS Sales | Salesforce | When a new booking is saved (as proposal or order), MS Sales pushes the |
| or Booking to | | | new data to Salesforce via SOAP call. The data includes: |
| Salesforce | | | Account details (Salesforce Account IDs of the agency, client |
| | | | account, and invoice account linked to the opportunity); |
| | | | Salesforce opportunity ID; |
| | | | MS Sales Order ID; |
| | | | Booking details; and |
| | | | Insert details. |
| | | | Exact fields within details will be defined in future state |
| 2 - Send Edited | MS Sales | Salesforce | When an existing booking is edited and saved (as proposal or order), MS |
| Proposal or Booking to | | | Sales pushes the edited data to Salesforce via SOAP call. The data |
| Salesforce | | | includes: |
| | | | Account details (Salesforce Account IDs of the agency, client |
| | | | account, and invoice account linked to the opportunity); |
| | | | Salesforce opportunity ID; |
| | | | MS Sales Order ID; |
| | | | Booking Details; and |
| | | | Insert Details. |
| | | | Salesforce logic will determine which fields have been edited and |
| | | | update those fields within Salesforce. |
| 3 - Synchronize | Webservices | Salesforce, | Salesforce will fully synchronize customers and contacts (not leads), as |
| customers and contacts | Technology | MS Sales | well as customer relationships, with MS Sales via web services (SOAP) |
| | | | → push from Salesforce. |
| | | | Mediaspectrum ®-brand Sales will push back edited/updated Customer |
| | | | or Contact data via webservices (SOAP) → push from MS Sales. |
| | | | Synchronization will occur real time, when a user creates/edits an |
| | | | account and selects ‘save.’ |
| 4 - Sync account IDs | | | MS Sales Account records will be identified by using the |
| | | | Salesforce Account ID. |
| | | | The same MS Sales Account and Salesforce Account should |
| | | | always be synched so they have the same account ID. |

### 3.1 Additional Information

1. The Salesforce Customer Account ID (i.e., the custom object that is a child of account) is the identifier that is passed to and from MS Sales and used to key data between systems;
2. MS Sales and Salesforce customer/agency accounts will always be in synch, except in the rare case that Salesforce is inaccessible. In this situation, MS Sales will create its own, temporary ID. Once Salesforce and MS Sales are synched, Salesforce will send MS Sales the replacement account ID for MS Sales to update the record;
3. MS Sales should be launched in a new window or browser tab, separate from Salesforce;
4. Users will never enter or store leads in MS Sales;
5. Lapsed/loss/live customer status will be maintained through Salesforce only, and not MS Sales for at least the initial phase; and
6. The opportunity ID that is sent from Salesforce to MS Sales will be stored in MS Sales. This opportunity ID will be associated to the order/proposal, but is not displayed in the MS Sales UI. Salesforce users will run reports to determine which opportunities led to orders/proposals within MS Sales.

### 4.1 Parameter List

The table below lists example parameter field names and descriptions, and corresponding field options that display in sales component/MS Sales.

Parameter List

| | | |
|---|---|---|
| Field Name | Description | Corresponding field in MS Sales |

Opportunity

| | | |
|---|---|---|
| Opportunity ID | Auto number - not SFDC primary key | Opportunity ID (does not display in UI, |
| | | behind the scenes in MS SALES) |
| ABS Order ID | | Order Number |
| Create/Amend Flag | Set by webservices technology | No corresponding field for amend. MS |
| | Amend/Update | SALES will send flag per file to ID if it is a |
| | | new opportunity or amended. |
| ABS ID | | MS Sales ID (created and in synch with |
| | | SalesForce) |
| ABS User ID | | MS Sales User ID that saved the opportunity |
| | | (ID is behind the scenes) |
| Opportunity Owner (ABS User | | MS Sales User ID that saved the opportunity |
| ID) | | (ID is behind the scenes) |
| Created Date & Time | | Opportunity ID saved date and time |
| CAT Code/CAT Cluster | | Category/Subcategory can be captured at |
| | | order level and then mapped to the |
| | | opportunity ID |
| Client/Direct Account SFDC ID | | SFDC Customer account number |
| Agency SFDC ID | | SFDC Customer account number when |
| | | there is an agency type associated |
| Invoice Account SFDC ID | | SFDC Bill to ID |
| ABS Order ID | | Order number |
| Contact SFDC ID | | Contact ID |
| Brand SFDC ID | | MS Sales will not be capturing or storing |
| | | brand for the near future |
| VAT Type | 0, 1, 2 | 0 = no VAT, 1 = standard, 2 = discounted. |
| | | New field will need to be added to the |
| | | customer record to capture VAT Type. |
| | | Users with certain permissions may edit this |
| | | field |

Account (repeated for Agency, Agency Client/Direct and Invoice)

| | | |
|---|---|---|
| Account Type | Up to 3 accounts can be included in the | Account types |
| | message to webservices technology. There | |
| | can be 1 account for each of the following; | |
| | agency, client, and invoice. | |
| Account Name | | Account Name |
| Account Terms | | Credit Terms (approved for trade credit, |
| | | transient, private, etc.) |
| SFDC ABS Account ID | Taken from SalesForce Account record. | Account Number |
| ABS Account ID | Taken from SalesForce Account record. | Account Number |
| Record Type | Not sent by webservices technology, but | MS SALES will send flag to webservices |
| | updated to locked record by component | technology per file to ID if it is a new |
| | when ABS Account ID is received | booking or amended. Not stored in MS |
| | | Sales Amend or New Booking. If they have |
| | | triggered the webservices technology and |
| | | there is no order ID = new, if there is an |
| | | order ID = amend |
| Postcode | | Postal Code |
| Address 1 | | Address 1 |
| Address 2 | | Address 2 |
| Town | | City |
| County | | No corresponding field for county |
| Country | Default to UK | Country |
| Currency Code | Default GBP | Set in localization resources |
| Limited Reg (registration) | Optional | UK company number associated to the |
| | | account. Similar to a tax ID. Need new |
| | | optional field in MS Sales |
| Landline | | Home phone |
| Mobile | | Mobile Phone |
| Fax | | Fax Phone |
| Company Web site | | Website |
| Order Number Required | Default to “No” | Checkbox on customer account that flags |
| | | whether a purchase order is required. If field |
| | | is checked, then purchase order number is |
| | | required with every saved order. In MS |
| | | Sales, need to create “PO Required” field |
| | | for the customer record and move the “PO |
| | | number” from the Dashboard tab to the |
| | | order information section within the order |
| | | booking. Customer must give purchase |
| | | order number if the customer record |
| | | indicates it is required. The user cannot save |
| | | a booking without putting in a purchase |
| | | order number. |
| VAT Number | Optional | Customer's VAT registration number. Each |
| | | customer has a number that can be checked |
| | | to determine if the customer is exempt. |
| | | Field does not display unless the account |
| | | has a VAT type of zero or 2. Field will |
| | | generally be non-editable and come from |
| | | SalesForce, but users with certain |
| | | permissions may edit this field. |
| VAT Type | 0, 1, 2 | 0 = exempt, 1 = standard, 2 = discounted. |
| | | New field will need to be added to the |
| | | customer record to capture VAT Type. Field |
| | | will generally be non-editable, but users |
| | | with certain permissions may edit this field. |
| Charity Number | | Charity Number (similar to VAT number.) |
| | | Charities have a number that can be checked |
| | | to determine if the charities are exempt. |
| | | Field does not display unless the account |
| | | has a VAT type of zero or 2. Field is |
| | | generally non-editable, but users with |
| | | certain permissions may edit this field. |
| Credit Status | Red, amber, or green. Taken from ABS | Credit Status |
| | Account record. | |
| Pre Payment Only Flag | | Credit terms |
| Permission to Credit Check | | Pull from backend financial system |
| Region | System generated | Region - Region will be new field for MS |
| | | SALES customer profile. |

Account CAT Codes (repeated for each CAT code associated with an account)

| | | |
|---|---|---|
| SFDC ABS Account ID | Taken from ABS Account record. | Account Number |
| ABS Account ID | Taken from ABS Account record. | Account Number |
| CAT Code | | Category Description |
| CAT Cluster | | CAT Subcategory |

Contact

| | | |
|---|---|---|
| First Name | | Contact First Name |
| Last Name | | Contact Last Name |
| Full Name | | Merge fields of Contact First Name and |
| | | Contact Last Name |
| SFDC Contact ID | If SFDC Contact ID is not present, then | Contact ID |
| | attempt to match on full name - exact | |
| | match. If record cannot be matched, then | |
| | create a new contact. | |
| Salutation | | Salutation in drop down before first name. |
| Phone | | Primary Phone |
| Mobile Phone | | Mobile Phone |
| Email | | Primary Email |
| Email Marketing Permission | Y/N | “Do Not Email” checkmark = no. Empty |
| | | checkbox = yes. |
| Phone Marketing Permission | Y/N | “Do not Call” checkmark = no. Empty |
| | | checkbox = yes. |
| Third Party Marketing Permission | Y/N | Need to show new field in UI on customer |
| | | account. |
| Mail Marketing Permission | Y/N | Need to show new field in UI on customer |
| | | account. |

Order

| | | |
|---|---|---|
| ABS Booking ID | | Order Number |
| SF Opportunity ID | Alternate key of opportunity record in | Create new field for salesforce opportunity |
| | SFDC. This is an auto number field on the | ID - CRM system. |
| | SFDC opportunity. | |
| ABS Account ID (Invoice) | Stored flat on order record for reporting | Bill to Account ID, in most situations comes |
| | purposes. | from SalesForce. |
| SF Account ID (Invoice) | Populates SFDC lookup field. | Salesforce Bill to Account ID. Synched with |
| | | ABS Account ID. |
| ABS Account ID (Client) | Stored flat on order record for reporting | Client Account ID, in most situations comes |
| | purposes. | from SalesForce. |
| SF Account ID (Client) | Populates SFDC lookup field. | Salesforce Account ID. Synched with ABS |
| | | Account ID. |
| ABS Account ID (Agency) | Stored flat on order record for reporting | Agency Account ID, in most situations |
| | purposes. | comes from SalesForce. |
| SF Account ID (Agency) | Populates SFDC lookup field. | Salesforce Agency Account ID. Synched |
| | | with ABS Account ID. |
| Contact Name | | Contact First Name and Contact Last Name |
| Date Booked | | Order create date |
| Time Booked | | Order create time |
| Date Amended | | Last edit date |
| Time Amended | | Last edit time |
| Opportunity Owner | ABS User ID of revenue receiving owner. | User ID mapped to opportunity ID will |
| | | display in the Sales Rep. |
| Opportunity Owner Name | User name | User Name associated to the User ID which |
| | | is mapped to the opportunity, will display in |
| | | the Sales Rep field. |
| User ID Who Booked | ABS User ID | Booked by ID |
| User Name Who Booked | User name | Booked by Name |
| Revenue Source | National/Provincial/Local/Xclude (SDR) | Users will not enter this; it is system- |
| | | generated through rules. Will need to be |
| | | passed to SalesForce. Will need to be stored |
| | | in the MS Sales database. |
| AMRA as Customer | Y or N | Not required to be stored or saved in MS |
| | | Sales. |
| Revenue User Type | | Fields sales, tele sales, etc. Not required to |
| | | be stored or displayed in MS Sales. Handled |
| | | through SalesForce. |
| Revenue User Team | | Not required to be stored or displayed in MS |
| | | Sales. Handled through SalesForce. |
| First Insert Date | | Start Date |
| Last Insert Date | | End Date |
| Account Type | | Customer Account Type |
| Payment Type | | Payment Type |
| Private or Trade | | Customer Account Type |
| Region | | Sales Division |
| Operating Company | | Operating Company ID |
| ABS ID | ABD System ID | Not stored in MS Sales. |
| Digital Conversion | | Calculated by SalesForce. Not required to |
| | | be stored or displayed in MS Sales. |

Insertion

| | | |
|---|---|---|
| Insert Status | | Insertion status |
| Product Code | | Product ID |
| Product Name | | Product Name |
| Edition/Zone Code | | Zone code |
| Edition/Zone Name | | Zone Name |
| Package Code | | Package ID |
| Package Description | | Package Name |
| Insert Date | | Insert date |
| Size | | Size |
| Depth | | Depth |
| Width | | Width |
| Volume (SCCs) | | Single column centimeters. SalesForce will |
| | | calculate depth × width. |
| Factored Volume | Not provided - this will be a | Need an edition factor volume on the zone |
| | formula/calculated field in SFDC (see | code in WebAdmin. When the administrator |
| | ROF/solution design). | sets up a zone, a factor can be entered. |
| | | Calculation will be done in SalesForce. |
| Modular Size Code | | Modular size ID |
| Modular Size Description | | Modular size Description |
| Rate Card Value | | Drools price at insertion level |
| Gross Value (After Discount | | Gross Value (After Discount Before Agency |
| Before Agency Commission) | | Commission) |
| Net Value (After Discount | | Net Value (After Discount Benefit) |
| Benefit) | | |
| Agency Commission Rate | | Drools determines if it is an agent and what |
| | | type of product to determine commission |
| | | rate. |
| VAT Rate | | Setup in Drools |
| VAT Value | | VAT Amount at insertion level |
| Rate Card Value - Euro | | Needs multi-currency discussion |
| Gross Value (After Discount | | Needs multi-currency discussion |
| Before Agency Commission) - | | |
| Euro | | |
| Net Value (After Discount | | Needs multi-currency discussion |
| Benefit) - Euro | | |
| Agency Commission Rate - Euro | | Needs multi-currency discussion |
| VAT Rate - Euro | | Needs multi-currency discussion |
| VAT Value - Euro | | Needs multi-currency discussion |
| Content | | Catchline |
| Content ID | | Content ID |
| Category | | Category |
| Sub Category | | Subcategory (could be more than one) |
| Classification | | Classification |
| Classification code | | Not displayed in the UI. The classification |
| | | code associated to the classification |
| | | description. Behind each classification |
| | | description, there should be a code. |
| BPC CAT | | Not displayed or stored in MS Sales |
| Brand | | Not displayed or stored in MS Sales |
| CAT Code | | Category code associated to the category |
| | | behind the scenes (not in UI). |
| ARC Code | | Not displayed or stored in MS Sales. |
| Colour Indicator | | Color drop down |
| Guaranteed Position Code | | Guaranteed position code that is sent behind |
| | | the scenes. |
| Guaranteed Position | | Guarantee position checkbox is checked. |
| Ad Type | Sponsorship, Event, Digital | Ad type selected just above the product. |
| Classified/Display/Other | | Digital/Print/Display |
| Style Code | | Style ID |
| Style Description | | Style Name |
| Free Flag | | Order type - revenue, house, filler ? |
| Planning position notes | Notes on position that may not be | Planning Notes Rename “customer notes” to |
| | described in drop down. Example: “This | “planning notes” No need for customer |
| | ad cannot display next to another mobile | notes. |
| | phone ad.” | |

### 5.1 Additional Information

a. One opportunity ID can be associated to multiple orders, while one order may not have multiple opportunities; and
b. Customers can be created in MS Sales and not in Salesforce.

### Use Case 027—Production Method/Ad Type

### 1. Basic Information

| Use Case ID | 0027 |
|---|---|
| Description | This Use Case describes how a production method can |
| | drive all the necessary details for size and templates. |
| Primary | Booking Agent |
| Actor(s) | Sales Rep |
| Performance | Each click should take less than a few seconds to respond, |
| | depending on the complexity of the click. |

### 2. Flow of Execution

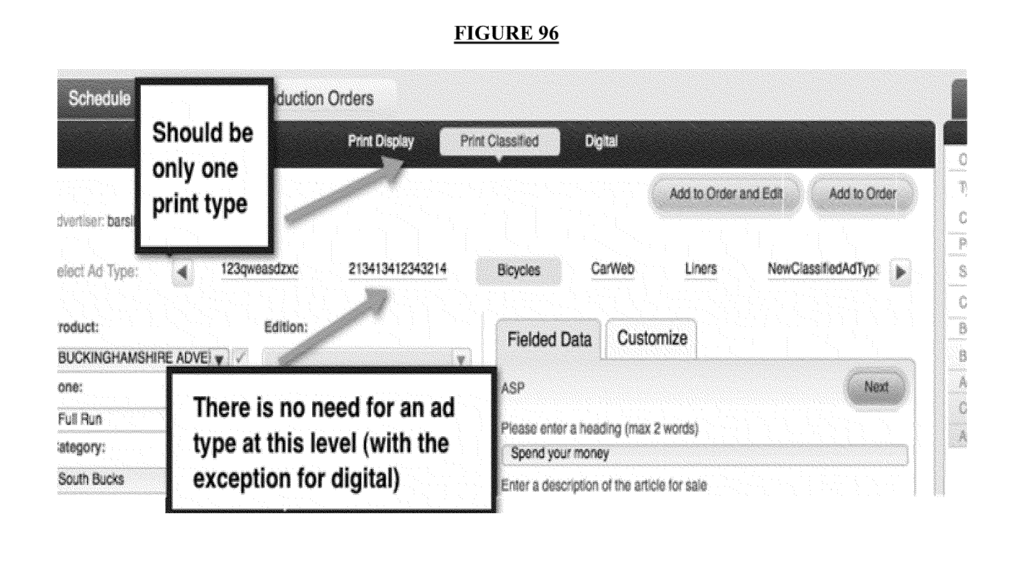

2.1 User will define production method
1) Ad Type, as illustrated in FIG. 96; and
2) Business can configure production methods and whether the method is internal or external,
   a. The following is a list of the production methods that may be listed in the production method drop down;
      i. Template—Internal;
      ii. AdwatchEx—External;
      iii. Adfeat—External;
      iv. Apollo—External;
      v. Art and Type—External;
      vi. Dass Template—External;
      vii. Dass Upload PDF—External;
      viii. Email—External;
      ix. Straight repeat—External;
      x. Studio—External; and
      xi. Text Finished—External.

### 2.2 Internal Production Method

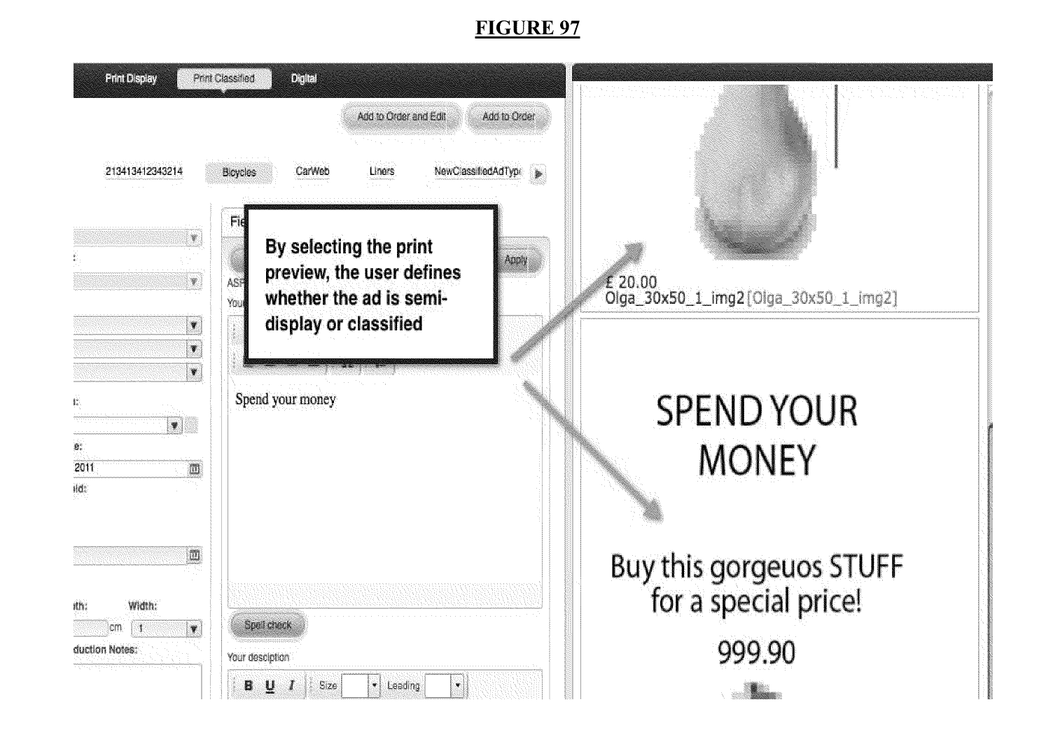

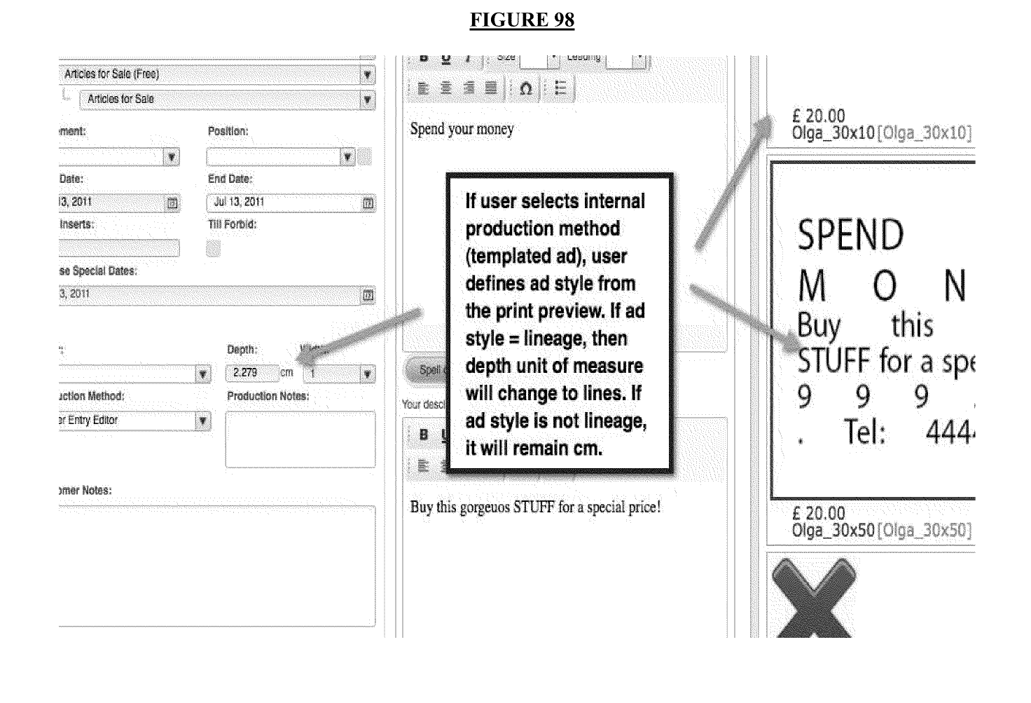

1. There will be only one internal production method
   a. Once the user selects internal production method, he will enter fielded data based on the template;
   b. The user defines whether the ad is lineage, display, or semi-display by choosing a template within the print preview section, as illustrated in FIG. 97;
      i. Although display ads are generally thought as being external production method only, there may be certain templates in the print preview that may be defined as a display;
   c. For all internal production methods, size will be generated from the template;
      i. When a user chooses a lineage ad from the print preview template, the size depth unit of measure must change from CM to lines. All other ad styles (display/semi-display) will have CM, as illustrated in FIG. 98; and
2. Rich text editor will be available for all styles, including lineage;
   a. Since not all rich text editor capabilities will be possible to print with all styles, Business must be able to limit users or user groups who have the ability to apply rich text to an order.

### 2.3 External Production Method

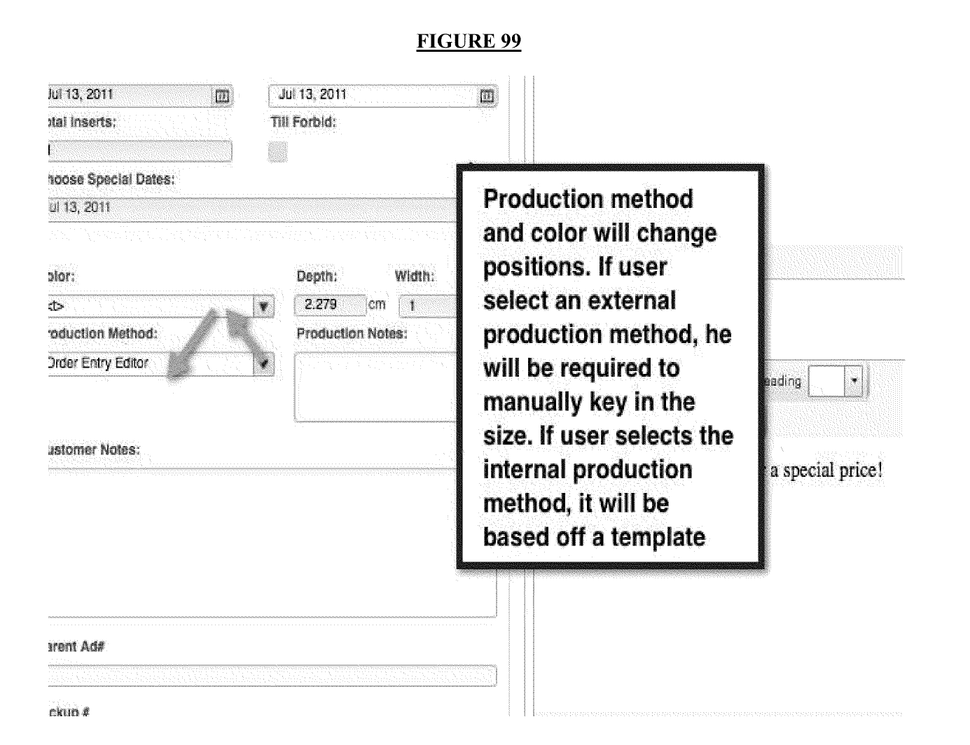

1. If the user selects an external production method, he is required to manually enter the size, as the size of an external production method would not be driven from a template;
   a. The production method should be selected earlier in the UI, as the method drives how size is entered, as illustrated in FIG. 99; and
   b. The production method selected will be sent to AdwatchTMEx. The different external production methods will NOT have separate systematic rules. The production methods are listed separately for user informational purposes only.

### 2.4 Notes

1) Ad style=display, semi-display, and lineage;
2) Display is usually an externally-produced ad, however, there are certain internal templates setup that could be defined as Display;
3) Any type of ad style can display as either Run of Paper or within the Classified Section; and
4) Display and Semi-Display use the same AdwatchEx Adtype and ClassBoxed, because they both count in CM, and that Lineage uses a different AdwatchEx AdType because it counts in Lines.

### Use Case 028—Multi-Select Zones

### 1. Basic Information

| Use Case ID | 0028 |
|---|---|
| Description | This Use Case describes how a user can multi-select |
| | multiple zones within one “add to order.” |
| Primary | Booking Agent |
| Actor(s) | Sales Rep |
| Successful | The user can multi-select zones. |
| Post | Insertions will be calculated based on the number |
| Conditions | of zones selected. |
| | Each zone will be a separate line item in the order |
| | information section/Dashboard. |
| Performance | Each click should take less than a few seconds to respond, |
| | depending on the complexity of the click. |

### 2. Flow of Execution

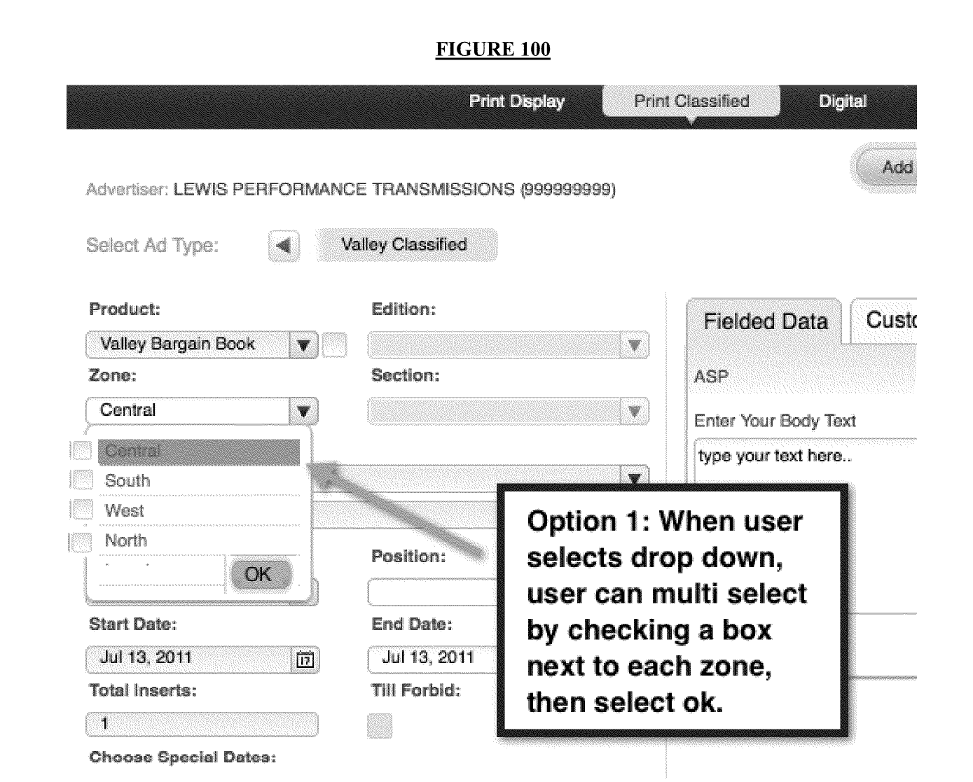

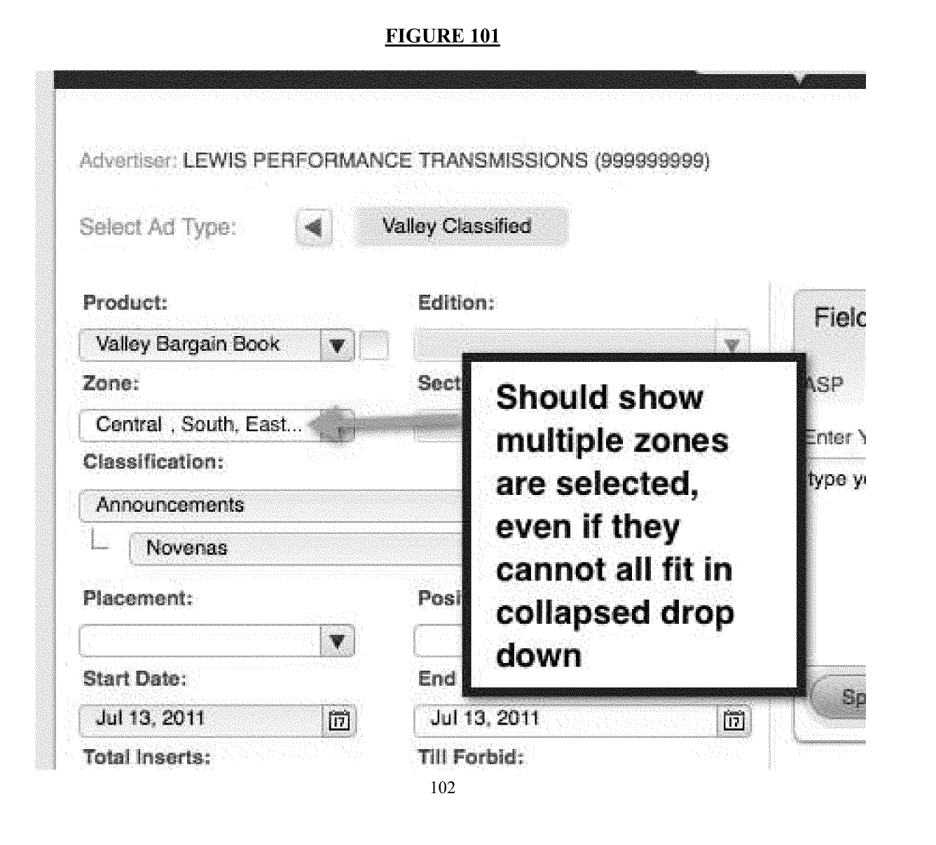

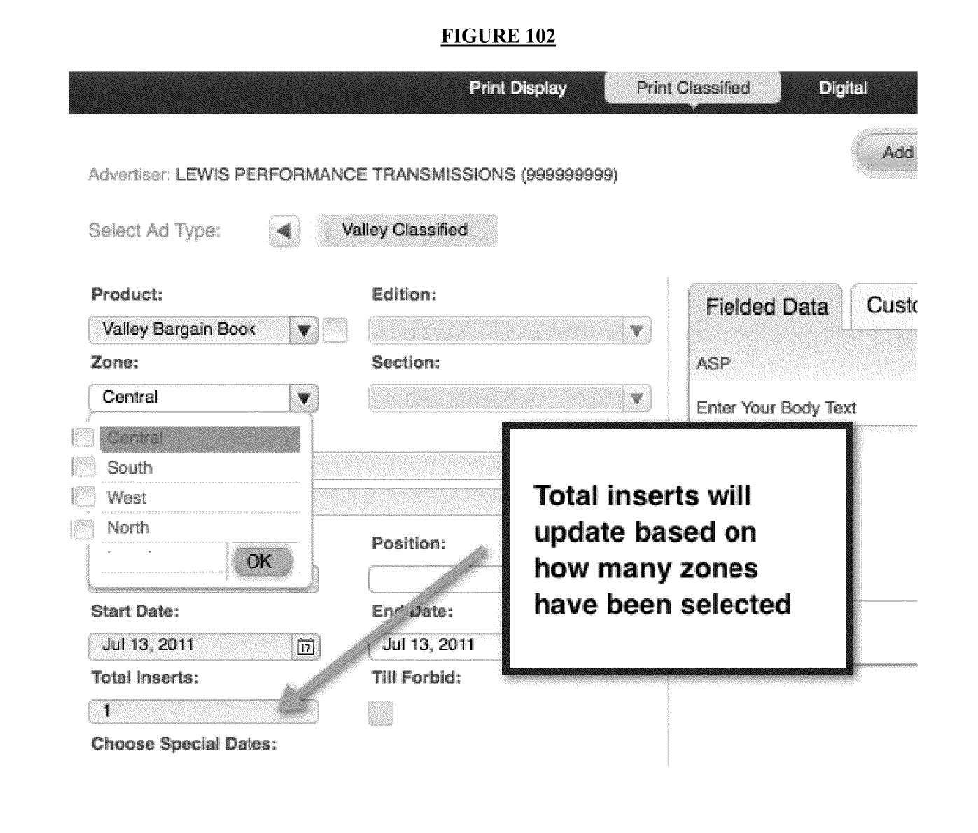

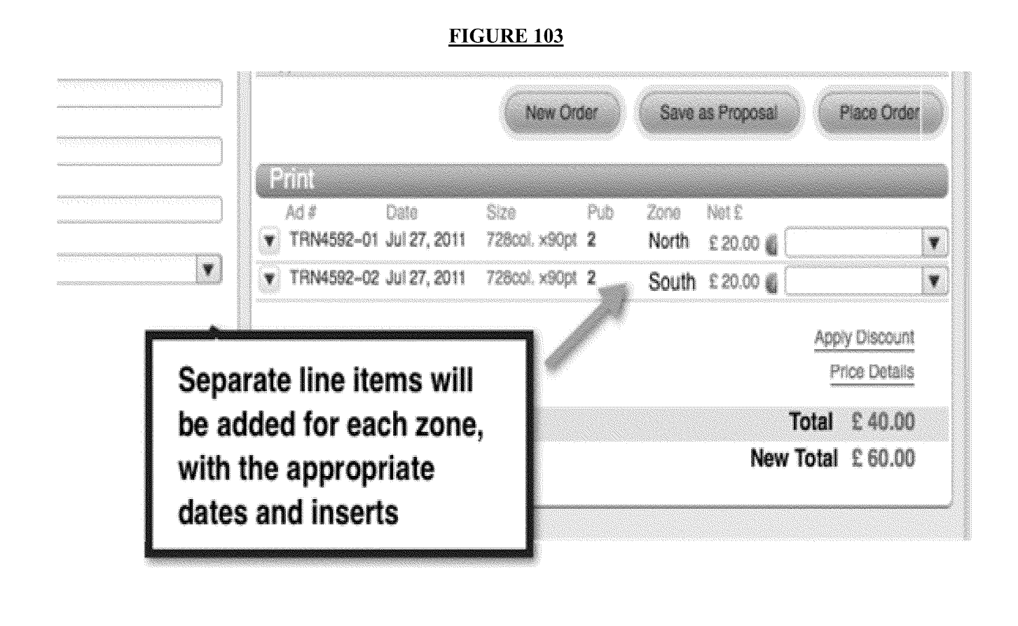

2.1 User can select multiple zones within one run schedule
1) When the user opens the zone drop down, he may select multiple zones. There are two development options to execute this selection. Multi-zones should be selected in the same manner multiple products can be selected (see Use Case 21);
   a. Option 1—Select zones using checkboxes and select “OK” when complete and the drop down will collapse, as illustrated in FIG. 100; and
   b. Option 2—Select zones by holding down the command key/shift key to highlight multiple zones without any checkboxes;
2) When multiple zones have been selected and the zone drop down is collapsed, it should indicate that multiple zones have been selected. If the user needs to view which zones are selected, he may reopen the drop down, as illustrated in FIG. 101;
3) Total Inserts will update based on the number of zones selected;
   a. Total Inserts=# of dates chosen x # of zones selected;
   b. If the user has selected 3 zones and the run schedule will run M-F (5 inserts) and repeat for 2 weeks (10 inserts), then there will be a total of 30 inserts as each insert will run once in each zone;
   c. As the user updates dates or number of zones selected, total inserts should update based on the rule that one insert will run per date per zone; and
   d. Price will update to reflect number of inserts per zone, as illustrated in FIG. 102; and
4) Order information and Dashboard will show separate line items for each zone, as illustrated in FIG. 103.

### 2.2 Assumptions

1. This Use Case 0028 is written assuming all zones within a publication selection would have the same classifications and placements.

### Use Case 031—ACM On Account/Apply Credit

### 1. Basic Information

| Use Case ID | 0031 |
|---|---|
| Description | This Use Case describes how the sales component of MS |
| | Sales can determine if an ACM order can be placed |
| | on a customer's account and how to apply unused credits. |
| Primary | Booking Agent |
| Actor(s) | Sales Rep |
| | Credit Rep |
| Successful | 1. The customer can apply an unused credit to an order. |
| Post | 2. Advertisers may place an order on account if the order |
| Conditions | is below the credit limit. |
| | 3. Advertisers must prepay any portion of an order that is |
| | above the credit limit. |
| Performance | Each click should take less than a few seconds to respond, |
| | depending on the complexity of the click. |

### 2. Flow of Execution

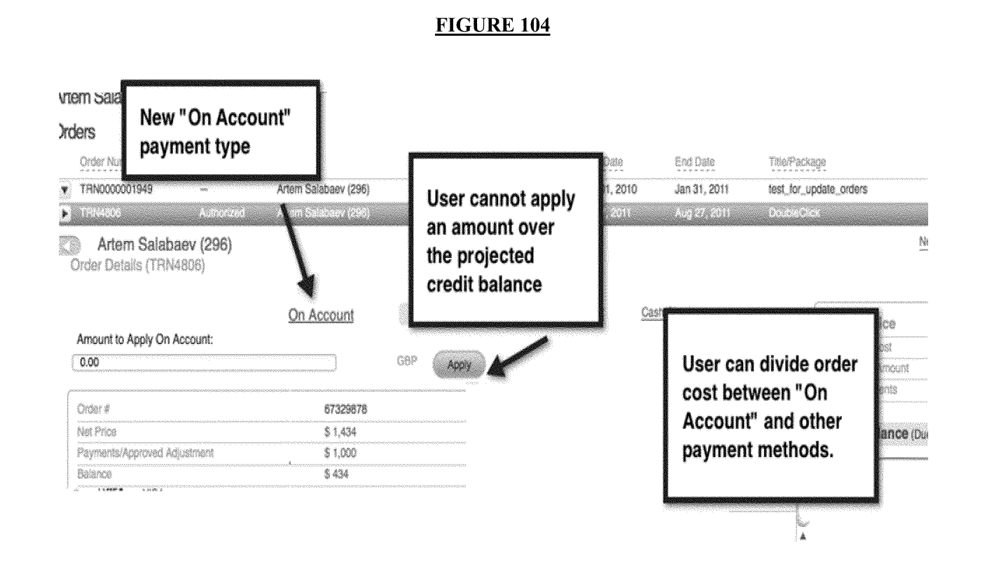

2.1 ACM User can place an order on the customer's account
1) The user completes an order and selects “Place Order;”
2) MS Sales instantly reaches out to Oracle® to determine if the customer is allowed to place orders on account (as opposed to prepay);
   a. If the customer is not allowed to place an order on account, the system will not display the “on account” button;
3) If the customer is allowed to place on account, Oracle will give MS Sales the account credit balance;
   a. If the credit balance>zero, then the “On Account” button will display (Note: this allows a user to place a portion of the order on account, even if remaining projected credit limit does not cover the entire order cost);
4) When the user selects “On Account,” he will be taken to the “On Account” payment page, which can also be accessed through the Dashboard workflow, as illustrated in FIG. 104;
5) The order balance will display in the “Amount to Apply on Account” field (current functionality);
   a. The user can choose to adjust this amount if wished to pay for a portion of the order upfront and only put the remaining portion on account;
6) If the user applies an amount that is over the account's credit balance, the user will receive an error message;
7) If the user applies an amount that is under the account's credit balance, the order will be successfully applied to the account; and
8) MS Sales will update Oracle with a new order cost so the credit balance can be updated
   a. Example:
      i. Order total=1000;
      ii. Credit amount=500;
      iii. Since credit amount>0, the on account button will display;
      iv. The user will be allowed to place $500 on account and will be instructed that the remaining balance must be prepaid; and
      v. MS Sales will update Oracle so the new credit amount will be $0.
         2.2 User can apply an unused credit to a customer's order
1) If there is an over-payment or refund, a credit will be associated to the customer's account with the date of the credit;
2) The user creates a new order for a customer with a credit;
3) When the user “places [an] order,” the system will display “Apply Unapplied Credit” button;
4) The user will select the “Apply Unapplied credit” button and be taken to a new payment page, which can also be accessed through the Dashboard;
   a. If the user wishes to pay for the order in a different form, he may switch to cash/check, credit card, etc.;
5) The user checks which credit to apply to the order and selects “Apply;”
6) Net balance will update;
   a. New net balance=net order cost−any selected unapplied credits; and Selected unapplied credit(s) will no longer display, if all unapplied credits have been used, as illustrated in FIG. 105.

While the systems, methods, and apparatuses have been described and illustrated in connection with preferred embodiments, many variations and modifications will be evident to those skilled in the art and may be made without departing from the spirit and scope of the disclosure. The disclosure is thus not to be limited to the precise details of methodology or construction set forth herein, as such variations and modification are intended to be included within the scope of the disclosure.

What is claimed is:

1. A system for media and commerce management comprising:
a user interface;
a customer overview module accessible through the user interface and configured to allow a user to manage customers;
a search module accessible through the user interface and configured to allow the user to search for one or more of orders, customers, contacts, activities, leads campaigns, and opportunities;
an activities module accessible through the user interface and configured to allow the user to manage tasks;
an opportunities module accessible through the user interface and configured to allow the user to track potential opportunities for sales;
a campaign module accessible through the user interface and configured to allow the user to create and manage plans to generate sales; and
a leads module accessible through the user interface and configured to allow the user to manage potential customers.
